(19) United States
(12) Patent Application Publication
(10) Pub. No.: US 2017/0165909 A1
(43) Pub. Date: Jun. 15, 2017

(54) THREE-DIMENSIONAL OBJECT FORMING DEVICE AND ADJUSTMENT METHOD

(71) Applicant: MIMAKI ENGINEERING CO., LTD., Nagano (JP)

(72) Inventors: Kunio Hakkaku, Nagano (JP); Kazuya Nozaki, Nagano (JP); Hirofumi Hara, Nagano (JP)

(73) Assignee: MIMAKI ENGINEERING CO., LTD., Nagano (JP)

(21) Appl. No.: 15/376,674

(22) Filed: Dec. 13, 2016

(30) Foreign Application Priority Data
Dec. 14, 2015 (JP) 2015-243310
Dec. 14, 2015 (JP) 2015-243605
Dec. 14, 2015 (JP) 2015-243606

(51) Int. Cl. B29C 67/00; B33Y 40/00; B33Y 50/02; B33Y 30/00

(52) U.S. Cl. CPC B29C 67/0059; B29C 67/0085; B29C 67/0088; B29C 67/0092; B33Y 30/00; B33Y 40/00; B33Y 50/02; B29K 2105/0058

(57) ABSTRACT

A three-dimensional forming device that forms a three-dimensional object includes a micrometer and a shaft portion that adjusts an inclination of a contacting surface of a leveling roller with respect to a trajectory of a forming table seen from the leveling roller when a forming table and the leveling roller are relatively moved in an X axis direction. The three-dimensional object forming device forms a three-dimensional object at a satisfactory precision.

### CROSS REFERENCE TO RELATED APPLICATIONS

This application claims the priority benefit of Japanese Patent Application Nos. 2015-243310, 2015-243605 and 2015-243606, filed on Dec. 14, 2015. The entirety of each of the above-mentioned patent applications is hereby incorporated by reference herein and made a part of this specification.

### TECHNICAL FIELD

The disclosure relates to a three-dimensional object forming device and a three-dimensional object fawning method for forming a three-dimensional object.

### DESCRIPTION OF THE BACKGROUND ART

A three-dimensional object forming device that forms a three-dimensional object by stacking a model material has been conventionally developed.

In recent years, a 3D printer for forming a three-dimensional object having a three-dimensional shape is being used in various applications, and for example, a method of forming a three-dimensional object by discharging a forming material, which is a material of the three-dimensional object, from an ink jet head is known for the 3D printer. In such 3D printer that discharges the forming material from the ink jet head, a desired three-dimensional object can be obtained by discharging a liquid forming material, irradiating the liquid forming material with an ultraviolet light to cure the forming material, and stacking the same to form a multilayered body. Such three-dimensional object forming device is disclosed in, for example, Japanese Unexamined Patent Publication No. 2013-67119.

Japanese Unexamined Patent Publication No. 2013-67119 discloses a three-dimensional object forming device (three-dimensional forming device) that repeats operations of discharging a model material and a support material while scanning in a horizontal direction, and curing the model material and the support material to stack layer-like slices and form a three-dimensional object. Specifically, the three-dimensional object forming device of Japanese Unexamined Patent Publication No. 2013-67119 includes a model material discharging nozzle that discharges the model material; a support material discharging nozzle that discharges the support material; and a roller portion that makes contact from upper surfaces (surfaces) of the model material and the support material to scrape off excess model material and support material. A width of the roller portion is formed to be narrower than a width in which the model material discharging nozzles are arranged and a width in which the support material discharging nozzles are arranged. As the roller portion makes contact with an adjacent cured region, the cured resin is avoided from being scraped off from the relevant region.

In order to increase the height precision of each layer configuring the multilayered body in this case, some conventional 3D printers carry out height adjustment while the forming material is in an uncured state with respect to the forming material discharged from the ink jet head. In the three-dimensional forming device described in Japanese Unexamined Patent Publication No. 2013-67119, the liquid forming material discharged from the ink jet head is pressed by a rotating roller, and the excess forming material is scraped off with the roller. Furthermore, in such three-dimensional forming device, a distal end of a blade for scraping off the forming material attached to the roller is arranged while making contact with the roller, and the forming material attached to the roller is removed with the blade at a time point the forming material is conveyed to the blade by the rotation of the roller. Furthermore, the forming material scraped off with the blade is guided to a bath for accumulating the forming material, and then suctioned and discharged with a suction pipe.

### SUMMARY

In the technique of Japanese Unexamined Patent Publication No. 2013-67119, however, at least the roller portion is manufactured such that the width of the roller portion is formed to be narrower than the width of the model material discharging nozzle and the width of the support material discharging nozzle. Therefore, a gap that cannot be leveled tends to form with the next roller portion when carrying out forming of greater than or equal to the width of the roller portion. Furthermore, although a defect in which a step difference forms in a perpendicular direction in units of width of the roller portions connected in the horizontal direction may occur, an avoiding method of when such defect occurs is not disclosed in Japanese Unexamined Patent Publication No. 2013-67119.

In other words, Japanese Unexamined Patent Publication No. 2013-67119 does not disclose at all a mechanism that, when a relative position relationship of the roller portion and a mounting table for mounting the three-dimensional object is not a normal position relationship due to manufacturing problems, for example, makes the position relationship to be a normal position relationship.

The disclosure is provided to solve the problems described above, and provides a three-dimensional object forming device capable of forming a three-dimensional object at a satisfactory precision regardless of the size of the width of the roller portion with respect to the width in which the model material discharging nozzles are arranged.

In the technique of Japanese Unexamined Patent Publication No. 2013-67119, at least the roller portion is manufactured such that the width of the roller portion is formed to be narrower than the width in which the model material discharging nozzles are arranged and the width in which the support material discharging nozzles are arranged. Therefore, Japanese Unexamined Patent Publication No. 2013-67119 does not disclose an avoiding method of when defects described below occur, when at least the roller portion is manufactured such that the width of the roller portion is greater than or equal to the width in which the model material discharging nozzles are arranged and the width in which the support material discharging nozzles are arranged.

In other words, Japanese Unexamined Patent Publication No. 2013-67119 does not disclose at all a mechanism that, when the roller portion is manufactured such that the width of the roller portion becomes greater than or equal to the width in which the discharging nozzles are arranged and when the relative position relationship of the roller portion and the mounting table for mounting the three-dimensional object is not a normal position relationship due to manufacturing problems, for example, makes the position relationship to be a normal position relationship.

The disclosure is provided to solve the problems described above, and provides a three-dimensional object forming device capable of forming a three-dimensional object at a satisfactory precision.

Furthermore, when scraping off the forming material attached to the roller with the blade, the forming material scraped off with the blade might flow not only in a direction of the bus but also to both ends of the blade if the rotation speed of the roller is fast or if the amount of forming material attached to the roller is large. In such a case, the forming material may drop off from both ends of the blade or from both end portions of the roller, and attach to the multilayered body being formed. A method of attaching a sealing member or a pad to the blade or the roller to suppress the forming material from dropping off is known, but a periodic part replacement is required, which arises a replacement work and lowers the work efficiency. Furthermore, if the forming material has high viscosity, the forming material scraped off with the distal end of the blade may attach and fix to the sealing member or the pad, and may not be removable.

The disclosure is provided to solve the problems described above, and provides a three-dimensional object forming device and a three-dimensional object forming method capable of suppressing an excess forming material from falling onto the forming object being stacked.

In order to solve the problem described above, a three-dimensional object forming device according to the disclosure includes, a forming table on which a three-dimensional object is formed by discharging a forming material; a leveling member that includes a contacting surface, extending in a first direction and being brought into contact with a surface of the forming material, and that levels the surface of the forming material; and an adjustment unit that adjusts an inclination of the contacting surface of the leveling member with respect to a trajectory of the forming table seen from the leveling member when the forming table and the leveling member are relatively moved in the first direction.

According to the configuration described above, the adjustment unit adjusts the inclination of the contacting surface of the leveling member with respect to the trajectory of the forming table seen from the leveling member when the forming table and the leveling member are relatively moved in the first direction.

When forming the three-dimensional object by scanning the leveling member not only in a second direction (main scanning direction) but also in the first direction (sub scanning direction) (i.e., scanning a mechanism for discharging the forming material also in the first direction), a step difference may form in the first direction on the surface of the forming material discharged to the forming table. Specifically, the step difference tends to form when the trajectory of the forming table is not substantially parallel to the leveling member but has a predetermined inclination in the first direction. The step difference appears in the three-dimensional object as a contour pattern not intended by the manufacturer.

In the three-dimensional object forming device, one of either the forming table or the leveling member can be moved in the first direction so that the step difference does not form to adjust the inclination of the contacting surface of the leveling member. That is, the inclination of the contacting surface is adjusted so that the trajectory of the forming table and the contacting surface of the leveling member become substantially parallel.

Thus, the three-dimensional object forming device according to the disclosure can prevent unnecessary patterns formed by the step difference from being formed in the three-dimensional object, and hence can form the three-dimensional object at a satisfactory precision.

Furthermore, in the three-dimensional object forming device according to the disclosure, the leveling member is preferably a leveling roller having a rotating shaft extending in the first direction; and the adjustment unit preferably adjusts the inclination of the contacting surface of the leveling roller by adjusting the inclination of the leveling roller with respect to a horizontal direction.

According to the configuration described above, the inclination of the contacting surface of the leveling roller can be adjusted by adjusting the inclination of the leveling roller with respect to the horizontal direction.

In the three-dimensional object forming device according to the disclosure, the adjustment unit preferably adjusts the inclination of the contacting surface of the leveling member by adjusting the inclination with respect to a horizontal plane of the trajectory of the scanning in the first direction of the forming table with respect to the leveling member.

According to the configuration described above, the inclination of the contacting surface of the leveling member can be adjusted by adjusting the inclination with respect to the horizontal direction of the trajectory for scanning the forming table.

Furthermore, in the three-dimensional object forming device according to the disclosure, the adjustment unit preferably adjusts the inclination of the contacting surface of the leveling member by having one end side of the rotating shaft of the leveling roller as a supporting point and the moving the other end side in a third direction perpendicular with respect to the first direction and a second direction, wherein the second is a direction perpendicular to the first direction and in which a discharging member that discharges the forming material is scanned.

According to the configuration described above, the leveling roller can be moved so that the inclination of the contacting surface of the leveling member can be adjusted. Thus, the inclination of the contacting surface of the leveling member can be easily adjusted while ensuring the forming precision of the three-dimensional object.

Moreover, the three-dimensional object forming device according to the disclosure includes a moving member that moves the forming table of a moving unit that relatively moves the forming table and the leveling member, the moving member holding the forming table at least at two locations, where the inclination of the contacting surface of the leveling member is preferably adjusted by having one location where the moving member holds the forming table as a supporting point and moving the other location in a third direction perpendicular to the first direction and a second direction which is a direction perpendicular to the first direction and in which a discharging member that discharges the forming material is scanned.

According to the configuration described above, the forming table can be moved by the moving member so that the inclination of the contacting surface of the leveling member can be adjusted. Thus, the inclination of the contacting surface of the leveling member can be easily adjusted while ensuring the forming precision of the three-dimensional object.

The three-dimensional object forming device according to the disclosure further preferably includes a plurality of nozzles for discharging the forming material; wherein the plurality of nozzles are preferably arranged to extend in the first direction.

According to the configuration described above, the forming material is discharged from the plurality of nozzles arranged to extend in the first direction to form a plurality of layers.

In the three-dimensional object forming device according to the disclosure, the forming table and the leveling member are relatively movable in a third direction perpendicular to the first direction and a second direction which is a direction perpendicular to the first direction and in which a discharging member that discharges the forming material is scanned; the forming table and the leveling member are relatively moved in the first direction after the forming table and the leveling member are relatively moved in the second direction; and the adjustment unit adjusts a relative movement amount in the third direction so as to adjust the inclination of the contacting surface of the leveling member with respect to the trajectory of the forming table seen from the leveling member in a relative movement with the relative movement of the forming table and the leveling member in the first direction.

Furthermore, in order to solve the problem described above, a control method of the three-dimensional object forming device according to the disclosure relates to a control method of the three-dimensional object forming device including a forming table on which a three-dimensional object is formed by discharging a forming material, and a leveling member that includes a contacting surface, extending in a first direction and being brought into contact with a surface of the forming material, and that levels the surface of the forming material, where the forming table and the leveling member are relatively movable in a third direction perpendicular to the first direction and a second direction which is a direction perpendicular to the first direction and in which a discharging member for discharging the forming material is scanned; the forming table and the leveling member are relatively moved in the first direction after the forming table and the leveling member are relatively moved in the second direction, and the method includes a movement control step of adjusting a relative movement amount in the third direction so as to adjust an inclination of the contacting surface of the leveling member with respect to a trajectory of the forming table seen from the leveling member at the time of the relative movement with the relative movement of the forming table and the leveling member in the first direction.

According to the configuration described above, the forming table and the leveling member have the relative movement amount in the third direction adjusted and are relatively moved in the third direction so that the inclination of the contacting surface of the leveling member with respect to the trajectory of the forming table is adjusted with the relative movement of the forming table and the leveling member in the first direction thereof.

Generally, when forming the three-dimensional object by scanning the leveling member not only in the second direction (main scanning direction) but also in the first direction (sub scanning direction) (i.e., scanning a mechanism for discharging the ink also in the first direction), the step difference may form in the first direction on the surface of the forming material discharged to the forming table. Specifically, the step difference tends to form when the trajectory of the forming table is not substantially parallel to the leveling member but has a predetermined inclination in the first direction. The step difference appears in the three-dimensional object as a contour pattern not intended by the manufacturer. In particular, the step difference appears as a line in a color image surface thus greatly affecting the quality in the three-dimensional object with a colored surface on which higher precision is demanded.

In the three-dimensional object forming device, the forming table and the leveling member can be relatively moved in the thirds direction so as to adjust the inclination of the contacting surface of the leveling member in cooperation with the relative movement of the forming table and the leveling member in the first direction. Thus, the three-dimensional object forming device can move one of either the forming table or the leveling member in the first direction so that the step difference is not formed.

Thus, the three-dimensional object forming device can prevent unnecessary patterns formed by the step difference from being formed in the three-dimensional object, and hence can form the three-dimensional object at a satisfactory precision.

Therefore, the three-dimensional object forming device according to the disclosure can form the three-dimensional object at a satisfactory precision through a simple method. The control method of the three-dimensional object forming device according to the disclosure has effects similar to the above.

The three-dimensional object forming device according to the disclosure further preferably includes a movement controller that adjusts the relative movement amount in the third direction.

According to the configuration described above, the three-dimensional object forming device can automatically carry out the relative movement of the forming table and the leveling member in the third direction to adjust the inclination. Therefore, the three-dimensional object forming device does not need to manually carry out the adjustment of the inclination of the contacting surface of the leveling member, thus enabling the adjustment to be more easily carried out.

In the three-dimensional object forming device according to the disclosure, the movement controller preferably relatively moves the forming table and the leveling member in the third direction by a distance corrected with a correction value for adjusting the inclination of the contacting surface of the leveling member.

According to the configuration described above, the forming table and the leveling member can be relatively moved in the third direction using the obtained correction value, so that the inclination of the contacting surface of the leveling member can be adjusted through a simple method.

Furthermore, in the three-dimensional object forming device according to the disclosure, the correction value is preferably obtained using a feeding amount of the forming table or the leveling member in the first direction, and the inclination of the contacting surface of the leveling member.

The step difference that forms when the trajectory of the forming table has the predetermined inclination with respect to the leveling member can be obtained using the feeding amount and an angle of the contacting surface with respect to the trajectory of the forming table. The angle of the contacting surface with respect to the trajectory of the forming table is a value corresponding to the inclination of the contacting surface of the leveling member. Thus, according to the configuration described above, the forming table and the leveling member can be relatively moved in the third direction accurately by the forming step difference by obtaining the correction value using the feeding amount and the inclination of the contacting surface of the leveling member.

The three-dimensional object forming device according to the disclosure may also include a correction value calculator that calculates the correction value.

According to the configuration described above, the correction value can be interiorly calculated in the three-dimensional object forming device without externally acquiring the correction value.

The three-dimensional object forming device according to the disclosure further includes a data acquiring section that acquires correction value data indicating the correction value and stores the correction value data in a storage unit; where the movement controller may relatively move the forming table and the leveling member in the third direction using the correction value data stored in the storage unit.

According to the configuration described above, the three-dimensional object forming device does not need to calculate the correction value. Therefore, the processing load of the three-dimensional object forming device can be alleviated.

In order to solve the problem described above and achieve the object of the disclosure, a three-dimensional object forming device according to the disclosure includes a mounting table on which a forming object is mounted; a discharger that discharges a forming material having fluidity for forming the forming object; a roller portion arranged in a freely rotating manner for scraping off an excess forming material in the forming material in a flowable state; and an excess forming material collecting mechanism that collects the excess forming material; where the excess forming material collecting mechanism includes a remover with a scrape-off part that scraps off the excess forming material on the surface of the roller portion arranged at one end, and a flow-down part that flows down the excess forming material scraped off by the scrape-off part; the scrape-off part is extended along an axial direction of the roller portion and arranged in contact with or in proximity with the surface of the roller portion; the flow-down part has one end connected to the scrape-off part and the other end including an inclined plane configured to be on a vertically lower side than the one end; and a fluid mover that moves the fluid so as to suppress the excess forming material at the flow-down part from flowing toward both sides in the extending direction of the remover.

In the disclosure, the fluid is moved by the fluid mover so as to suppress the excess forming material at the flow-down part from flowing toward both ends in the extending direction of the remover, so that the excess forming material at the flow-down part removed from the roller portion can be suppressed from flowing to both ends in the extending direction of the remover. Consequently, the excess forming material can be suppressed from dropping onto the forming object being stacked.

In the three-dimensional forming device described above, the fluid mover is preferably arranged in a non-contacting state with respect to at least one of the remover and the roller portion.

In the disclosure, since the fluid mover is not brought into contact with respect to the remover or the roller portion, the excess forming material can be prevented from curing at a contacted portion as in a case where a member for controlling the movement of the excess forming material is disposed in contact with the remover or the roller portion. The replacement of parts caused by the curing of the excess forming material thus becomes unnecessary. The fluid mover can also alleviate the rotation load of the roller portion as the fluid mover is not brought into contact with respect to the rotating roller portion. As a result, the maintenance property can be enhanced, and the amount of power consumption at the time of activation of the three-dimensional object forming device can be suppressed.

In the three-dimensional object forming device described above, the fluid mover preferably includes a flow tube for flowing gas or liquid; and an opening of the flow tube is preferably arranged to face the remover at least at both end positions of the remover.

In the disclosure, the opening of the flow tube is disposed to face the remover at least at the positions of both ends of the remover, so that the flow of the excess forming material flowing toward both ends of the remover can be effectively suppressed. Consequently, the excess forming material can be more reliably suppressed from dropping onto the forming object being stacked.

In the three-dimensional object forming device described above, the fluid mover preferably includes a suction generating source that suctions fluid so as to suction the excess forming material from the opening, and a waste tank that is connected to the flow tube and that stores the excess forming material suctioned from the opening.

In the disclosure, the excess forming material can be more reliably suctioned from the flow tube by arranging the suction generating source for suctioning the fluid so as to suction the excess forming material from the opening of the flow tube. Consequently, the excess forming material can be more reliably suppressed from dropping onto the forming object being stacked.

In the three-dimensional object forming device described above, the fluid mover preferably includes a storing part that is arranged on a lower side than the remover in a vertical direction and that stores the excess forming material removed from the roller portion by the remover, and a waste suction mechanism that suctions the excess forming material stored in the storing part; and the waste suction mechanism preferably suctions the excess forming material stored in the storing part with a suction force generated by the suction generating source.

In the disclosure, the waste suction mechanism suctions the excess forming material stored in the storing part with the suction force generated in the suction generating source that applies the suction force on the flow tube, whereby both the excess forming material on the remover and the excess forming material in the storing part can be suctioned with one suction generating source. Therefore, even if two systems for suctioning the excess forming material are provided, the excess forming material can be suctioned with one suction generating source without arranging the suction generating source in each system. As a result, the number of components can be suppressed and the manufacturing cost can be reduced.

In the three-dimensional object forming device described above, the fluid mover preferably includes an airflow generating source that generates an airflow for blowing gas against the excess forming material from the opening so as to suppress the excess forming material from flowing out from both sides of the remover at least at both end positions of the remover.

In the disclosure, gas is blown against the excess forming material to suppress the excess forming material from flowing out from both sides of the remover, and hence the excess forming material can be pushed back in a direction opposite to the direction the excess forming material attempts to move. As a result, the excess forming material on the remover removed from the roller portion can be suppressed from flowing to both ends of the remover, and the excess forming material can be suppressed from dropping on the forming object being stacked.

In order to solve the problem described above, an adjustment method according to the disclosure relates to an adjustment method used in a three-dimensional object forming device including.

a forming table on which a forming object is formed by discharging a forming material;
and a leveling member that includes a contacting surface, extending in a first direction and being brought into contact with a surface of the forming material, and that levels the surface of the forming material;
the adjustment method including an adjusting step of adjusting an inclination of the contacting surface of the leveling member with respect to a trajectory of the forming table seen from the leveling member when the forming table and the leveling roller are relatively moved in the first direction.

Thus, similar to the three-dimensional object forming device described above, the adjustment method according to the disclosure can prevent unnecessary patterns formed by the step differences from being formed in the three-dimensional object, and hence can form the three-dimensional object at a satisfactory precision.

The adjustment method according to the disclosure preferably further includes a measuring step of measuring a distance between the forming table and the leveling member; where in the adjusting step, the inclination of the contacting surface of the leveling member is preferably adjusted based on a measurement result measured in the measuring step.

According to the configuration described above, the inclination of the contacting surface of the leveling member is adjusted based on the measurement result measured in the measuring step, so that the inclination can be adjusted at a satisfactory precision.

Furthermore, in the control method of the three-dimensional object forming device according to the disclosure, the three-dimensional object is formed by depositing a plurality of layers formed by the forming material on the surface of the forming table;

each of the plurality of layers is formed when a plurality of discharging regions, formed by the forming material discharged to the surface of the forming table, extending in the second direction are arranged adjacent to each other; and
a width in the first direction of the contacting surface of the leveling member is preferably longer than a width in the first direction of each discharging region.

According to the configuration described above, the contacting surface of the leveling member can be brought into contact with the surface of the forming material discharged to the mounting surface of the forming table across the adjacent discharging regions. Thus, even if a slight step difference is formed between the adjacent discharging regions, such step difference can be leveled.

A three-dimensional forming method according to the disclosure relates to a three-dimensional forming method of forming a forming object by discharging and stacking a forming material having fluidity, where an excess forming material in the forming material in a flowable state is scraped off with a roller portion arranged in a freely rotating manner, the excess forming material attached to the surface of the roller portion is removed by a remover including a scrape-off part arranged in contact with or in proximity to the surface of the roller portion, and fluid is moved by a fluid mover to suppress the excess forming material at a flow-down part of the remover for flowing down the excess forming material scraped off by the scrape-off part from flowing to both ends in an extending direction of the remover.

In the disclosure, the airflow capable of suppressing the excess forming material at the flow-down part from flowing to both ends in the extending direction of the remover is generated by the fluid mover, so that the excess forming material can be suppressed from dropping on the forming object being stacked.

Furthermore, the three-dimensional object forming device according to the disclosure may be realized with a computer, in which case, a three-dimensional forming program of the three-dimensional object forming device for realizing the three-dimensional object forming device with a computer by operating the computer as each unit (software element) arranged in the three-dimensional object forming device and a computer readable recording medium in which the three-dimensional forming program is recorded are also encompassed within the scope of the disclosure.

The three-dimensional object forming device and the adjustment method according to the disclosure have an effect of being able to form the three-dimensional object at a satisfactory precision.

### BRIEF DESCRIPTION OF THE DRAWINGS

FIG. 1 is a view showing one example of a three-dimensional object forming device according to a first embodiment of the disclosure, and is a view for describing an adjustment unit arranged in the three-dimensional object forming device.

FIG. 2A is a view showing one example of a schematic configuration of the three-dimensional object forming device.

FIG. 2B is a view showing a schematic configuration of an ink jet head and a leveling roller when seen from a direction of a forming table.

FIG. 3 is a function block showing one example of a schematic configuration of a control unit arranged in the three-dimensional object forming device.

FIG. 4 is a view for describing one example of a forming method of a three-dimensional object.

FIG. 5A is a perspective view showing one example of a schematic configuration of a roller unit arranged in the three-dimensional object forming device.

FIG. 5B is a side view showing one example of a schematic configuration of the roller unit arranged in the three-dimensional object forming device.

FIG. 6A is a view for describing the leveling at the predetermined layer when the mounting surface of the forming table is inclined toward the Y axis direction or the mounting surface of the forming table has unevenness.

FIG. 6B is a view for describing the leveling at the predetermined layer when the mounting surface of the forming table is inclined toward the X axis direction or the mounting surface of the forming table has unevenness.

FIG. 7A is a view for describing the leveling in the predetermined layer when the mounting surface of the forming table is inclined toward the X axis direction or the mounting surface has unevenness, and when the trajectory formed when the forming table is moved in the X axis direction and the contacting surface of the leveling roller are not substantially parallel.

FIG. 7B is a view for describing the leveling in the predetermined layer when the mounting surface of the forming table is inclined toward the X axis direction or the mounting surface has unevenness, and when the trajectory formed when the forming table is moved in the X axis direction and the contacting surface of the leveling roller are not substantially parallel.

FIG. 8 is a view showing a state in which a predetermined layer is formed in FIG. 7A.

FIG. 9A is a view for describing one example of an adjustment method of an inclination of the leveling roller with respect to the trajectory of the forming table, and is a view showing a state of measuring a distance between the leveling roller and the forming table with a measuring instrument.

FIG. 9B is a view for describing one example of the adjustment method of the inclination of the leveling roller with respect to the trajectory of the forming table, and is a view showing state of measuring a distance between the leveling roller and the forming table with the measuring instrument.

FIG. 9C is a view for describing one example of the adjustment method of the inclination of the leveling roller with respect to the trajectory of the forming table, and is a view for describing an adjustment method of the inclination of the leveling roller.

FIG. 10 is a view showing one example of a schematic configuration of a three-dimensional object forming device according to a second embodiment of the disclosure, and is a view for describing an adjustment unit arranged in the three-dimensional object forming device.

FIG. 11 is a function block showing one example of a schematic configuration of a control unit arranged in a three-dimensional object forming device according to a third embodiment of the disclosure.

FIG. 12A is a perspective view showing one example of a schematic configuration of a roller unit arranged in the three-dimensional object forming device of the third embodiment.

FIG. 12B is a side view showing one example of a schematic configuration of the roller unit arranged in the three-dimensional object forming device of the third embodiment.

FIG. 13 is a flowchart showing one example of a flow of processes of the three-dimensional object forming device.

FIG. 14A is a view showing one example of a state in which the inclination of the leveling roller with respect to the trajectory of the forming table is adjusted.

FIG. 14B is a view showing one example of a state in which the inclination of the leveling roller with respect to the trajectory of the forming table is adjusted.

FIG. 14C is a view showing one example of a state in which the inclination of the leveling roller with respect to the trajectory of the forming table is adjusted.

FIG. 15 is a function block showing one example of a schematic configuration of a control unit arranged in a three-dimensional object forming device according to a fourth embodiment of the disclosure.

FIG. 16 is a function block showing one example of a schematic configuration of a control unit arranged in a three-dimensional object forming device according to a fifth embodiment of the disclosure.

FIG. 17 is a flowchart showing one example of a flow of processes of the three-dimensional object forming device.

FIG. 18 is a schematic view of a three-dimensional object forming device according to a sixth embodiment.

FIG. 19 is a perspective view showing one example of a forming object formed by the three-dimensional object forming device shown in FIG. 18.

FIG. 20 is an explanatory view in which the discharging unit is seen from the discharging surface side of the ink droplet.

FIG. 21 is a detailed view of the leveling roller unit shown in FIG. 18.

FIG. 22 is an explanatory view showing a configuration of the leveling roller unit and an excess forming material collecting mechanism shown in FIG. 21.

FIG. 23 is an explanatory view showing an operation of the discharging unit in a step of discharging the ink droplet and forming the layers of the forming object.

FIG. 24 is an explanatory view showing an operation of the discharging unit in a step of leveling a layer with the leveling roller unit.

FIG. 25 is a detailed view of the leveling roller unit in the three-dimensional object forming device according to the second embodiment.

FIG. 26 is an explanatory view showing a configuration of the leveling roller unit and an excess forming material collecting mechanism shown in FIG. 25.

### DETAILED DESCRIPTION OF EMBODIMENTS

Hereinafter, embodiments according to the disclosure will be described in detail based on the drawings. It should be recognized that the disclosure should not be limited by the embodiments. Configuring elements in the following embodiments include elements that are replaceable and easily replaced by those skilled in the art, or elements that are substantially the same.

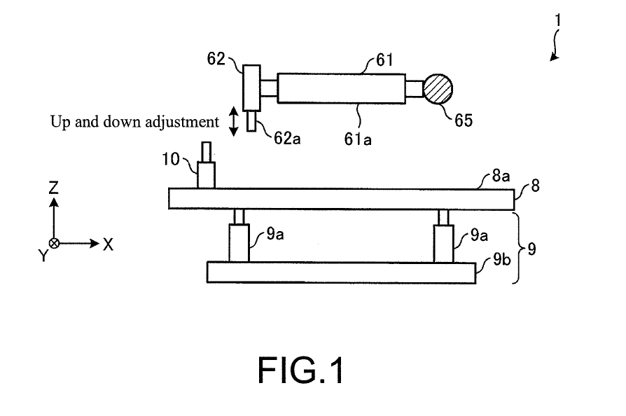

### [First Embodiment] Embodiments of the Disclosure Will be Described Below Based on FIG. 1 to FIG. 9C

<Schematic Configuration of Three-Dimensional Object Forming Device>

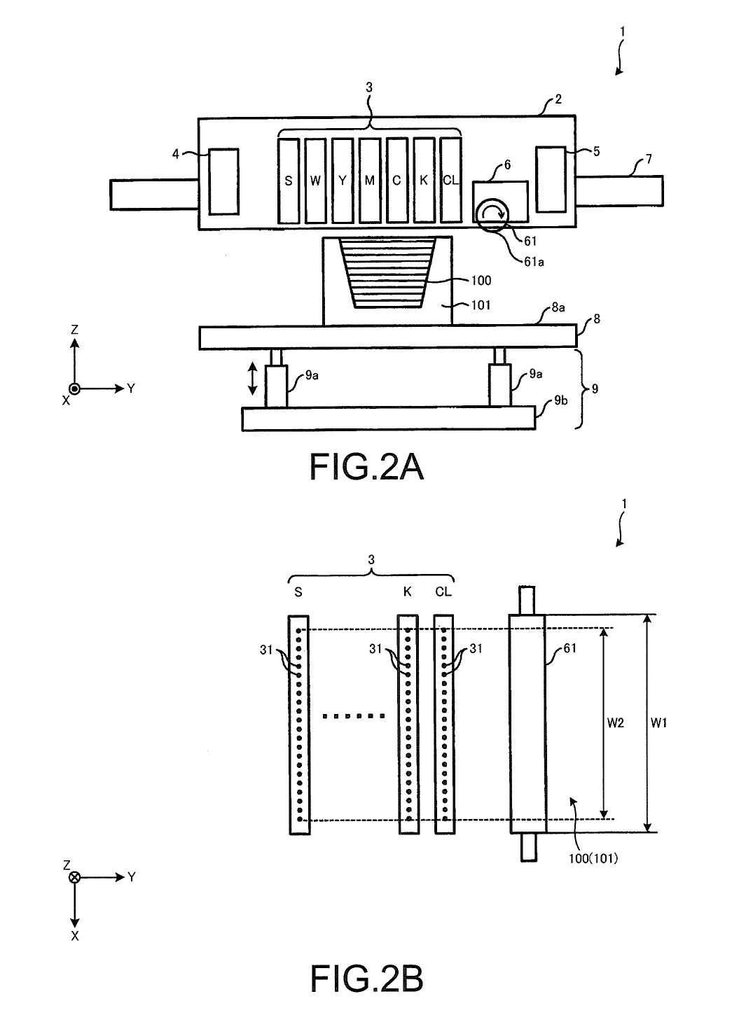

An overall schematic configuration of a three-dimensional object forming device 1 of the present embodiment will be described based on FIGS. 2A and 2B. FIG. 2A is a view showing a schematic configuration of the three-dimensional object forming device 1 of the present embodiment, and FIG. 2B is a view showing a schematic configuration of an ink jet head 3 and a leveling roller (leveling member) 61 when seen from a direction of a forming table 8.

In the present embodiment, for example, an axis substantially perpendicular to a mounting surface (surface) 8a of the forming table 8 is assumed as a Z axis, and axes substantially parallel with the mounting surface 8a and substantially perpendicular to each other are assumed as an X axis and a Y axis, as shown in FIG. 2A and FIG. 2B. The Y axis is a moving direction of a carriage 2 of when discharging of ink, irradiation of ultraviolet light, and leveling of each layer formed by the ink are carried out. The Y axis direction (second direction) is a main scanning direction, and the X axis direction (first direction) is a sub scanning direction. In other words, the Y axis direction is a direction perpendicular to the X axis direction and in which the ink jet head 3 is scanned when discharging the forming material.

The three-dimensional object forming device 1 forms a three-dimensional object (forming object) 100 through a stacking method using the ink jet method. In other words, the three-dimensional object forming device 1 forms the three-dimensional object 100 by depositing a plurality of layers formed by ink. As shown in FIG. 2A, the three-dimensional object forming device 1 mainly includes the carriage 2, a Y bar 7, the forming table 8, and a forming table moving mechanism 9.

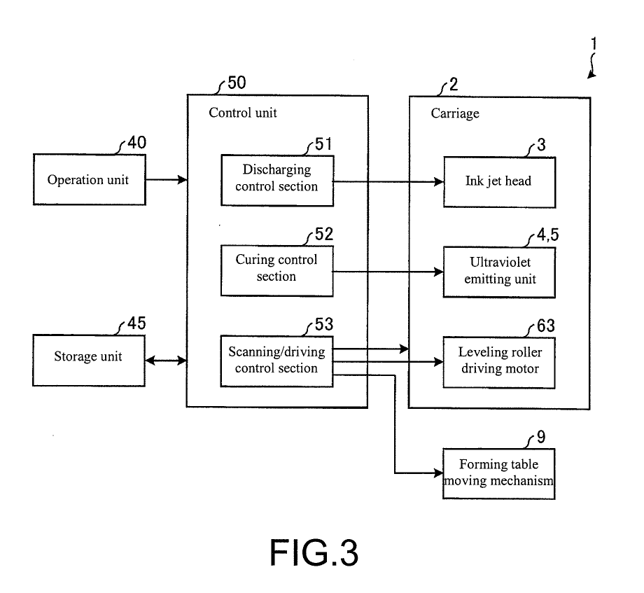

The carriage 2 is a housing including a mechanism for forming the three-dimensional object 100, and is arranged so as to face the forming table 8 and has a configuration of being able to reciprocate along the Y axis direction. The carriage 2 also includes the ink jet head 3, an ultraviolet light emitting unit (ultraviolet light sources) 4, 5, and a roller unit 6 for the above-described mechanism. The operation of each mechanism inside the carriage 2 and the movement of the carriage 2 are controlled by a control unit 50 (see FIG. 3).

The ink jet head 3 discharges various types of ink toward the forming table 8 in the scanning of the carriage 2 in the Y axis direction. In other words, the ink jet head 3 is a discharger (discharging member) that discharges a forming material for forming the three-dimensional object 100 in the scanning of the carriage 2 in the Y axis direction. The forming material is in a deformable state until cured, where ink having fluidity will be described as an example of a deformable forming material in the present embodiment, but this is not the sole case, and the forming material may be a gel substance having fluidity or a substance in a temporarily cured state.

Specifically, the ink jet head 3 includes a plurality of heads S, W, Y, M, C, K, and CL for storing various types of ink. Each head S, W, Y, M, C, K, and CL discharges each ink of support material (S), white (W), yellow (Y), magenta (M), cyan (C), black (K), and transparent ink toward the forming table 8. Among such inks, inks other than the support material function as materials that configure the three-dimensional object 100.

The support material ink is not provided to form the three-dimensional object 100, but is provided to form a three-dimensional object supporting unit 101 for supporting or holding the three-dimensional object 100 in a forming process of the three-dimensional object 100. In the present embodiment, the support material ink is discharged before forming the three-dimensional object 100, and a bottom portion (base) of the three-dimensional object supporting unit 101 having a planar shape is formed on the mounting surface 8a of the forming table 8. For example, the formed bottom portion has a thickness of about 300 μm. The three-dimensional object 100 is then formed on the bottom portion.

The ink jet head 3 includes a plurality of heads S, W, Y, M, C, K, and CL in the present embodiment, but does not necessarily need to include all the inks. For example, when forming the three-dimensional object 100 such as a diorama without an overhang directly on the forming table 8, the support material ink is unnecessary, and hence the head S for storing the support material ink may not be arranged. When coloring in full color is not carried out, not all heads W, Y, M, C, K, and CL need to be arranged, and at least one of the heads merely need to be arranged. Furthermore, heads for discharging ink of light color of Y, M, C, K, as well as, red, green, blue, silver, and the like may be arranged.

When the ink jet head 3 includes the head S for storing the support material ink, the bottom portion of the three-dimensional object supporting unit 101 can be formed before the three-dimensional object 100 is formed. Furthermore, even if the mounting surface 8a of the forming table 8 has distortion (unevenness), the bottom portion of the three-dimensional object supporting unit 101 having a plane substantially parallel to a contacting surface (lower end line) 61a of the leveling roller 61 can be formed. Thus, the three-dimensional object 100 can be formed on a plane, so that the three-dimensional object 100 intended by the manufacturer can be formed. The three-dimensional object 100 is stripped from the forming table 8 with the three-dimensional object supporting unit 101, so that damages on the three-dimensional object 100 by the stripping can be prevented.

As the ink jet head 3 includes the plurality of heads W, Y, M, C, K, and CL for forming the three-dimensional object 100, the three-dimensional object 100 of abundant color variations can be formed.

As shown in FIG. 2B, each head S, W, Y, M, C, K, and CL includes a plurality of nozzles 31 that discharge ink. The plurality of nozzles 31 are arranged to extend in the X axis direction, and form a nozzle row, which is an arrangement of the nozzles.

The nozzle row does not necessarily need to be arranged substantially parallel to the X axis, and may be arranged to form a predetermined angle with respect to the X axis (“angle formed by the nozzle row and the X axis”≠0°). In this case, a distance in the X axis direction between the two adjacent nozzles 31 becomes shorter than when arranged substantially parallel to the X axis, and hence a width (interval) of the ink discharged from each nozzle 31 can be reduced when the carriage 2 is scanned in the Y axis direction. The resolution of the three-dimensional object 100 thus can be enhanced.

The ultraviolet curable ink can be used for the above-described ink. When the ultraviolet curable ink is used, the ink can be cured in a short time and thus can be easily stacked, whereby the three-dimensional object 100 can be manufactured in a shorter time. The ultraviolet curable ink contains an ultraviolet curable compound. The ultraviolet curable compound is not limited as long as it is a compound that cures when irradiated with an ultraviolet light. The ultraviolet curable compound includes, for example, a curable monomer and a curable oligomer that polymerize when irradiated with the ultraviolet light. The curable monomer includes, for example, a low viscosity acryl monomer, a vinyl ether, an oxetane monomer, an annular aliphatic epoxy monomer, or the like. The curable oligomer includes, for example, an acryl oligomer. A water soluble material is suitable for the support material as the support material is removed after the forming.

In addition, a thermoplastic ink, for example, can be used for the above-described ink. When the thermoplastic ink is used, a discharged heating ink is cured when cooled by room temperature. In this case, a method of forcibly cooling the ink may be used to cure the ink in a shorter time. The support material having a low melting point can be removed by heating and melting.

The ultraviolet light emitting units 4, 5 emit the ultraviolet light toward the forming table 8. Specifically, the ultraviolet light emitting units 4, 5 irradiate each of the plurality of layers formed on the forming table 8 with the ultraviolet light. An ultraviolet LED, a halogen lamp, and a xenon lamp are suitable for a light emitting light source. Each of the plurality of layers formed by discharging the ink on the forming table 8 thus can be cured in a short time.

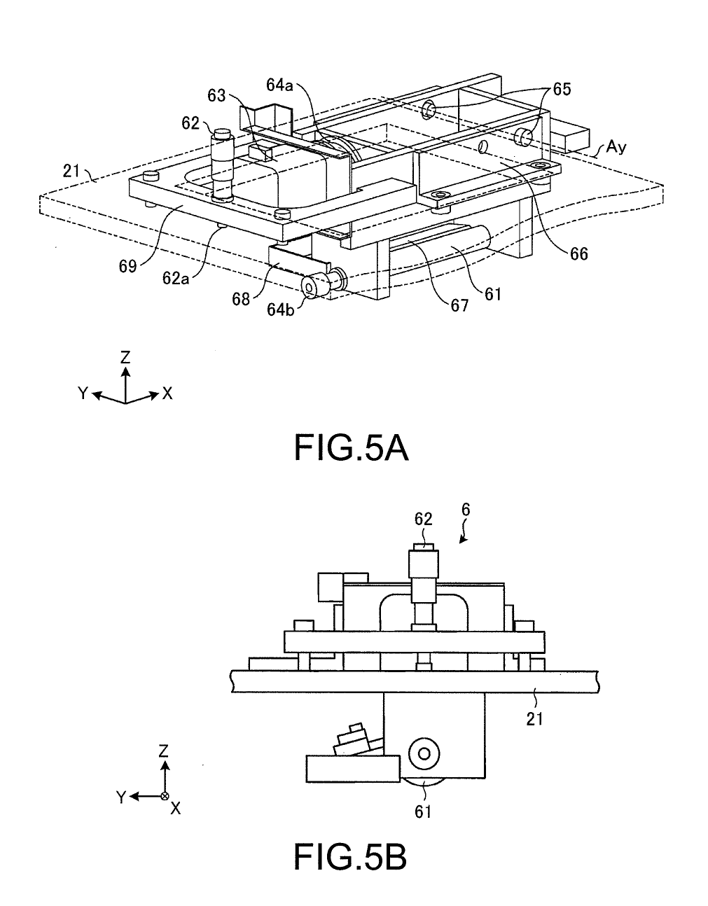

The roller unit 6 includes a mechanism for leveling each of the plurality of layers at a time of scanning of the carriage 2 in the Y axis direction, and for example, includes the leveling roller 61. A capacity variation of an ink droplet discharged from each of the plurality of nozzles 31 of the ink jet head 3 is about ±10%, and thus the leveling roller 61 is required to even the unevenness of the plurality of layers. Members other than the leveling roller 61 arranged in the roller unit 6 will be described later using FIG. 5A and FIG. 5B.

The leveling roller 61 is a member that includes a rotating shaft extending in the X axis direction and that is arranged to freely rotate with the rotating shaft as a center, where the leveling roller 61 is rotated at the time of the scanning of the carriage 2 in the Y axis direction to level each layer formed by the ink discharged from the ink jet head 3. In other words, the leveling roller 61 is a leveling means (roller portion) for leveling the surface of the ink in a deformable state before being cured by the ultraviolet light emitting units 4, 5. The leveling roller 61 also includes a contacting surface 61a extending in the X axis direction that makes contact with the surface of the ink discharged to the forming table 8. That is, the rotating shaft extends in the X axis direction parallel to the contacting surface 61a.

Specifically, the leveling roller 61 is pressed against a surface facing the leveling roller 61 of a layer formed on the forming table 8 by the movement of the forming table 8 in a Z axis direction (third direction). The leveling roller 61 is then scanned in the Y axis direction while being spun with a predetermined distance maintained with respect to the surface to level the surface.

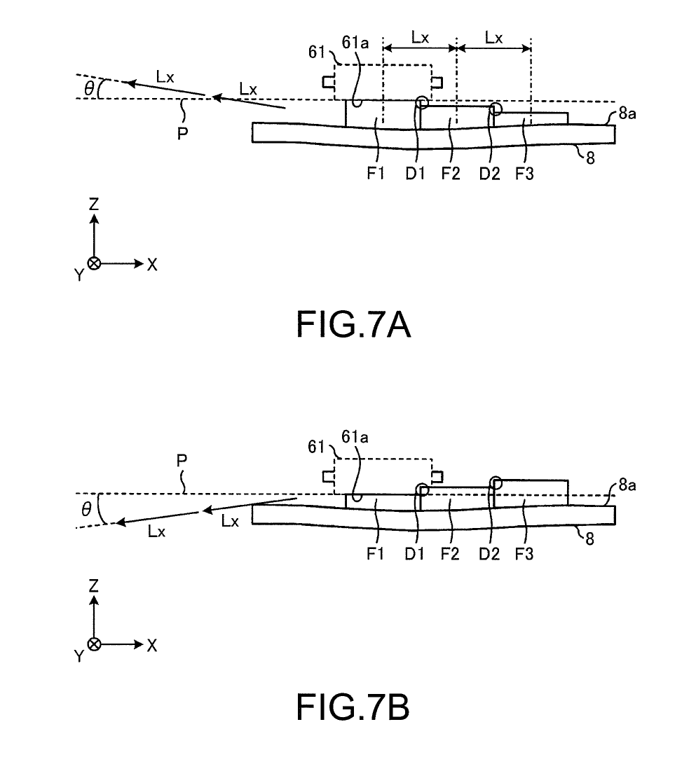

As shown in FIG. 2B, a width W1 in the X axis direction of the contacting surface 61a of the leveling roller 61 is longer than a width (trajectory width) W2 in the X axis direction of each of a plurality of discharging regions formed by the ink discharged onto the mounting surface 8a of the forming table 8 extending in the Y axis direction. The discharging region is a region formed by the ink discharged onto the forming table 8 when the carriage 2 is moved in the Y axis direction without changing a relative position in the X axis direction of the forming table 8 and the leveling roller 61. In other words, a plurality of discharging regions (rows) extending in the Y axis direction is formed by changing the relative position of the forming table 8 and the leveling roller 61 in the X axis direction. For example, partial layers F1, F2, and F3 shown in FIG. 7A and FIG. 7B form three discharging regions. The contacting surface 61a of the leveling roller 61 thus can be brought into contact with the surface of the ink formed on the mounting surface 8a of the forming table 8 across the adjacent discharging regions. Thus, even if a slight step difference is formed between the adjacent discharging regions, such step difference can be leveled. Such step difference thus can be reduced more accurately and efficiently.

The Y bar 7 is a rod-shaped member extending along the Y axis direction to define the moving direction of the carriage 2. That is, the carriage 2 is attached to the Y bar 7, and is moved along the extending direction (i.e., Y axis direction) of the Y bar 7.

The forming table 8 is a plate-shaped member on which the plurality of layers are deposited to form the three-dimensional object 100, and can be reciprocated in the X axis direction and the Z axis direction. In other words, the forming table 8 is a mounting table for mounting the three-dimensional object 100. The forming table 8 includes the mounting surface 8a where the three-dimensional object 100 is mounted, and an installing surface (installing surface facing the mounting surface 8a), which is a surface on an opposite side of the mounting surface 8a in the vertical direction.

The forming table moving mechanism 9 holds the installing surface of the forming table 8 at two locations, and moves the forming table 8 in the X axis direction and the Z axis direction upon receiving a control of the control unit 50. In other words, the forming table moving mechanism 9 is an installing mechanism connected to the installing surface of the forming table 8, and is a moving unit (moving means) for relatively moving the forming table 8 and the leveling roller 61. Specifically, the forming table moving mechanism 9 includes a perpendicular moving mechanism 9a and a horizontal moving mechanism 9b.

The perpendicular moving mechanism 9a holds the forming table 8 at one end side, and, for example, moves the forming table 8 in the Z axis direction with a ball screw and a linear guide having a pulse motor as a drive source upon receiving the control of the control unit 50.

The horizontal moving mechanism 9b is connected to the other end side of the perpendicular moving mechanism 9a, and moves the forming table 8 in the X axis direction. For example, two parallel rails (not shown) extending in the X axis direction are arranged to face the horizontal moving mechanism 9b, so that the horizontal moving mechanism 9b slides on the rails in the X axis direction by the ball screw having the pulse motor as a drive source upon receiving the control of the control unit 50. The forming table 8 is thereby moved in the X axis direction.

Accordingly, the three-dimensional object forming device 1 is a so-called serial type three-dimensional object forming device that scans the forming table 8 at least in the X axis direction, and scans the leveling roller 61 in the Y axis direction to form the three-dimensional object 100. Specifically, the forming table 8 and the leveling roller 61 are relatively moved in the X axis direction and the Y axis direction by the forming table moving mechanism 9 and a leveling roller driving motor 63 (see FIG. 3), to be described later.

In other words, the three-dimensional object forming device 1 forms the three-dimensional object 100 by moving the leveling roller 61 not only in the Y axis direction, but also in the X axis direction. In contrast, the three-dimensional object forming device 1 is not a so-called line head type three-dimensional object forming device that forms the three-dimensional object 100 without scanning the forming table 8 in the X axis direction, where the plurality of nozzles 31 have a length of greater than or equal to a width in the X axis direction of the three-dimensional object 100 to form. Thus, the three-dimensional object forming device 1 can form the three-dimensional object 100 greater than the width of the leveling roller 61 in the X axis direction (or width of the ink jet head 3 in the X axis direction).

In the present embodiment, the ultraviolet light emitting unit 4, the ink jet head 3, the roller unit 6, and the ultraviolet light emitting unit 5 are arranged in the carriage 2 in such order along the +Y axis direction, but the arrangement order is not limited thereto. In other words, the members may be arranged at any positions in the carriage 2 as long as the ink discharged from the ink jet head 3 can be leveled before being cured with the ultraviolet light, that is, the discharged ink can be cured after being leveled.

Furthermore, at least one of each of the ink jet head 3, the ultraviolet light emitting unit 4, 5, and the roller unit 6 merely needs to be arranged in the carriage 2. The ultraviolet light emitting units 4, 5, the roller unit 6, the ink jet head 3, the ink jet head 3, the roller unit 6, and the ultraviolet light emitting units 4, 5 may be arranged in the carriage 2 in such order in the +Y axis direction. That is, assuming the ink jet head 3, the ultraviolet light emitting units 4, 5, and the roller unit 6 form one set, a plurality of sets may be symmetrically arranged in the carriage 2.

As shown in FIG. 3, the three-dimensional object forming device 1 includes an operation unit 40, a storage unit 45, and the control unit 50, in addition to the above-described configuration. FIG. 3 is a function block showing one example of a schematic configuration of the control unit 50.

The operation unit 40 accepts various types of user operations such as an instruction to start or stop the forming of the three-dimensional object 100, an input of shape data indicating a shape of the three-dimensional object 100 to form, measurement value data indicating a measurement value measured by a user, or the like.

The storage unit 45 stores various types of control programs, and the like to be executed by the control unit 50, and is configured by, for example, a nonvolatile storage device such as a hard disc, a flash memory, and the like.

The control unit 50 executes the control program, for example, according to the user operation accepted by the operation unit 40 to control each member configuring the three-dimensional object forming device 1. The control unit 50, for example, reads out the program stored in the storage unit 45 to a temporary storage unit (not shown) configured by a RAM (Random Access Memory), and the like, and executes the program to carry out various types of processes such as a discharging control of the ink jet head 3, a driving control of the leveling roller driving motor 63, a movement control of the carriage 2 and the forming table 8, and the like.

The control unit 50 mainly includes a discharging control section 51, a curing control section 52, and a scanning/driving control section 53.

The discharging control section 51 controls the discharging of ink in each head S, W, Y, M, C, K, and CL arranged in the ink jet head 3.

The curing control section 52 controls the emission of ultraviolet light in the ultraviolet light emitting units 4, 5.

The scanning/driving control section 53 carries out the scanning of the carriage 2 in the Y axis direction, the scanning of the forming table 8 in the X axis direction and the Z axis direction, and the driving control of the leveling roller driving motor 63.

For example, the carriage 2 is attached to a belt (not shown) extending in the Y axis direction, which belt is wound around two pulleys (not shown) arranged adjacent to the Y bar 7 on both ends of the Y bar 7. Rotating shafts of the two pulleys are extended in the Z axis direction. A motor (not shown) for controlling the rotation of one pulley is attached to the rotating shaft of the relevant pulley. The scanning/driving control section 53 controls the movement of the carriage 2 in the Y axis direction by controlling the drive of the motor.

Furthermore, the leveling roller 61 is rotated through the belt (not shown) wound around pulleys 64a, 64b (see FIG. 5A) by carrying out the driving control of the leveling roller driving motor 63. The scanning/driving control section 53 controls the direction of rotation of the leveling roller 61 to a clockwise direction when the moving direction of the carriage 2 is leftward (−Y axis direction) in FIG. 2A.

In the present embodiment, the description is made assuming the forming table 8 moves in the X axis direction, but this is not the sole case, and a configuration in which the carriage 2 moves in the X axis direction with the Y bar 7 as a whole upon receiving the control of the control unit 50 (scanning/driving control section 53 to be described later) may be adopted. In other words, the leveling roller 61 and the forming table 8 merely need to have a configuration of relatively moving in the X axis direction.

<Forming Method of Three-Dimensional Object 100>

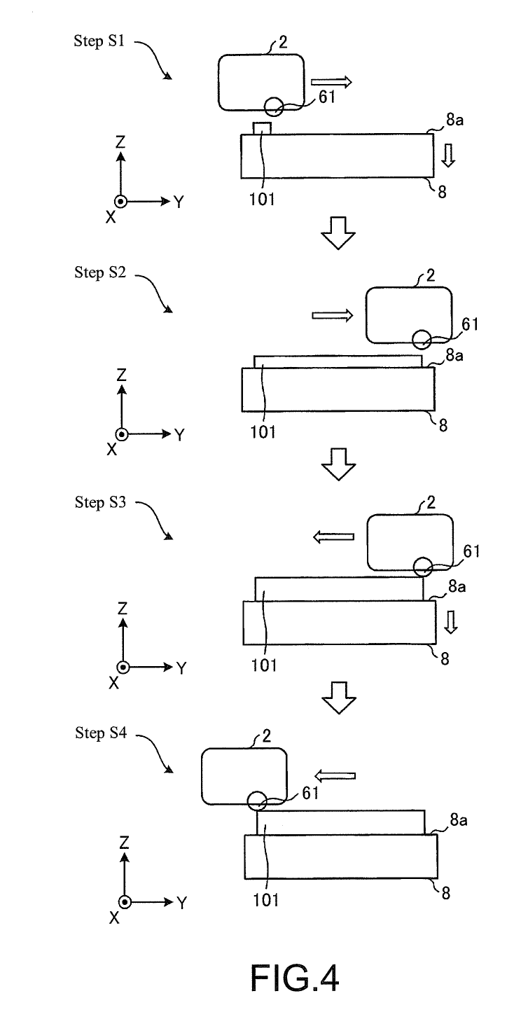

Next, one example of a forming method of the three-dimensional object 100 will be described using FIG. 4. FIG. 4 is a view for describing a forming method of the three-dimensional object 100.

In step S1 of FIG. 4, while the scanning/driving control section 53 is scanning the carriage 2 in the +Y axis (right in the figure) direction, the ink jet head 3 starts the discharge of ink for configuring a first layer of the bottom portion of the three-dimensional supporting unit 101 upon receiving the control of the discharging control section 51. The scanning and the discharging are terminated in step S2 of FIG. 4. Although the leveling roller 61 is rotated in the clockwise direction (direction of arrow in FIG. 2A) during this time, the mounting surface 8a does not make contact with the contacting surface 61a of the leveling roller 61 as it is located below the contacting surface 61a as in step S1 of FIG. 4 by the Z axis drive. The gap between the contacting surface 61a of the leveling roller 61 and the mounting surface for avoiding the contact is, for example, 300 μm. Thus, the forward scanning in the +Y axis direction is started in step S1, and the forward scanning is terminated in step S2. In other words, the forward scanning of a first pass in the first layer is carried out in step S1 and step S2.

Next, the discharging of ink for configuring a second pass in the first layer of the bottom portion of the three-dimensional object supporting unit 101 is carried out while performing backward scanning of scanning the carriage 2 in the −Y axis direction, that is, in the leftward direction from the position of step S2 of FIG. 4. The forward/backward passes are repeated for a predetermined number to form the first layer. For example, when forming one layer with eight passes, four forward/backward rounds are carried out, and when forming one layer with two passes, one forward/backward round is carried out.

The selection on the number of passes to form one layer and the selection on whether forward/backward bi-directional discharge or only unidirectional discharge are known techniques in a two-dimensional ink jet planar printing technique. In this step, the discharging of ink for configuring the three-dimensional object supporting unit 101 is carried out and high resolution is not required, whereby, for example, a bi-directional discharge in two passes of forming the layer in a shorter time is preferred. Moreover, high precision forming can be realized when the unidirectional discharge in eight passes is carried out in the forming of the three-dimensional object 100, to be described later.

The second and subsequent layers are similarly formed, and the formation of layers is repeated until before the formed height reaches 300 μm, that is, until close to when the initial gap 300 μm of the contacting surface 61a of the leveling roller 61 and the mounting surface is eliminated. For example, when the thickness obtained by the discharge of one layer is 25 μm, the formation of layers is repeated until 11 layers are formed. The Z axis drive of the forming table 8 is not carried out up to this point. As a result, computationally, the thickness of 275 μm is stacked, and the gap of the contacting surface 61a and the forming upper surface becomes 25 μm.

Then, the leveling roller 61 is driven, and the Z axis drive of the forming table 8 is carried out to lower the thickness 20 μm at a time for every layer. Therefore, since the thickness obtained by the discharge of one layer is 25 μm, the gap of the contacting surface 61a and the forming upper surface becomes narrower by a difference, 5 μm, for every layer. Therefore, computationally, the gap is narrowed by 25 μm when five layers are formed, and the gap becomes zero.

In step S3 of FIG. 4, a state after a time point at which the upper surface of the three-dimensional object supporting unit 101 is brought into contact with the contacting surface 61a of the leveling roller 61 is shown. In other words, the gap is zero. When the scanning/driving control section 53 scans the carriage 2 in the −Y axis direction, the surface of the ink is brought into contact and scraped by 5 μm (=25 μm−20 μm) at a time in calculation, thus being leveled. At this time, the ultraviolet light emitting units 4, 5 irradiate the surface of the ink with the ultraviolet light to cure the leveled surface upon receiving the control of the curing control section 52. The leveling process and the curing process are terminated in step S4 of FIG. 4. According to such leveling, unevenness and inclination of the mounting surface 8a of the forming table 8 are corrected, and the three-dimensional object supporting unit 101 having a leveled upper surface is formed.

Thereafter, the processes of step S1 to step S4 are repeated to form the first layer of the three-dimensional object 100 on the three-dimensional object supporting unit 101 having the leveled upper surface.

A plurality of layers of the three-dimensional object 100 are formed by repeatedly carrying out the process of forming one layer. In such manner, the three-dimensional object supporting unit 101 including a portion greater than the width of the ink jet head 3 in the X axis direction, and then the three-dimensional object 100 is formed on the mounting surface 8a.

In the present embodiment, the width of the ink jet head 3 in the X axis direction is about 65 mm, and the width of the contacting surface 61a of the leveling roller 61 in the X axis direction is about 100 mm, but the two widths and the relative size are not limited thereto. Furthermore, the thickness of the layer before being leveled by the leveling roller 61 is about 20 μm to 30 μm, and the thickness of the layer after being leveled by the leveling roller 61 is about 15 μm to 20 μm. In other words, the leveled layer is formed on the forming table 8 by removing the ink of the layer before being leveled by the leveling roller 61 by about 5 μm to 10 μm. Thus, in order to form the three-dimensional object 100 at a satisfactory precision, the thickness of each layer needs to be controlled at a satisfactory precision in units of a few μm particularly so that unevenness or step difference does not form on the surface of each layer.

The forming method of the three-dimensional object 100 and the three-dimensional object supporting unit 101 are not limited to the above. For example, a part of the first layer may be formed with two passes, or the leveling by the leveling roller 61 may be carried out on a plurality of layers as a whole. Hereinafter, a case where two layers are leveled as a whole will be described.

In this case, while the scanning/driving control section 53 is moving the carriage 2 in the +Y axis direction, the ink jet head 3 discharges the ink, and the ultraviolet light emitting unit 4 irradiates the layer formed by the discharged ink with the ultraviolet light to cure the layer.

Thereafter, the scanning/driving control section 53 moves the forming table 8 up to a position where the leveling roller 61 makes contact with the upper surface of a new layer formed next. Then, while the scanning/driving control section 53 is moving the carriage 2 in the −Y axis direction, the ink jet head 3 discharges ink to form a new layer, and the leveling roller 61 levels the new layer. In this case, the ultraviolet light emitting unit 5 irradiates the new layer with the ultraviolet light to cure the new layer.

<Measuring Instrument 10 and Adjustment Unit>

Next, an adjustment process carried out before the forming of the three-dimensional object 100 (three-dimensional object supporting unit 101) will be described using FIG. 1. FIG. 1 is a view showing a schematic configuration of the three-dimensional object forming device 1, and is a view for mainly describing a measuring instrument 10, a micrometer 62, and a shaft portion 65.

As shown in FIG. 1, the three-dimensional object forming device 1 includes the leveling roller 61, the micrometer 62, the shaft portion 65, the forming table 8, and the forming table moving mechanism 9. FIG. 1 also shows a state in which the measuring instrument 10 used in the adjustment by the micrometer 62 and the shaft portion 65 is arranged on the mounting surface 8a of the forming table 8.

The measuring instrument 10 measures a distance between the leveling roller 61 and the forming table 8 in the X axis direction, and is configured by, for example, a micrometer (micro-gauge). The measuring instrument 10 has a detachable configuration with respect to the forming table 8. In other words, the measuring instrument 10 merely needs to be arranged on the forming table 8 only at the time of measuring the distance. Furthermore, the measuring instrument 10 merely needs to be arranged at a position facing the leveling roller 61 on the forming table 8 when the forming table 8 is moved in the X axis direction. That is, the measuring instrument 10 merely needs to be arranged at a position facing the leveling roller 61 on the forming table 8 when the forming table 8 is scanned in the X axis direction to measure the distance.

The measuring instrument 10 may be arranged in advance at a position facing the leveling roller 61 on the forming table 8, the position being a position where the three-dimensional object 100 or the three-dimensional object supporting unit 101 is not formed, when the forming table 8 is moved in the X axis direction.

When the measuring instrument 10 is installed in advance on the forming table 8, and when installed only at the time of measurement as well, the measuring instrument is arranged at a position where distance measurement for at least two times can be carried out when the forming table 8 is moved in the X axis direction.

The measuring instrument 10 does not necessarily need to be a micrometer, and may be configured as, for example, a distance measuring sensor as long as the distance can be measured.

In the three-dimensional object forming device 1, the micrometer 62 and the shaft portion 65 are an adjustment unit that adjusts the inclination of the contacting surface 61a of the leveling roller 61 with respect to a trajectory of the forming table 8 (hereinafter simply referred to as “inclination of the leveling roller 61 with respect to the trajectory of the forming table 8”) seen from the leveling roller 61 when the leveling roller 61 and the forming table 8 are relatively moved in the X axis direction based on the measurement result of the measuring instrument 10. In other words, the adjustment unit is a mechanism that allows an angle formed by the contacting surfaces 61a and the forming table 8 to be adjusted. An adjustment method of the inclination by the adjustment unit will be described later, where the adjustment unit adjusts the inclination of the leveling roller 61 with respect to the horizontal direction to adjust the inclination of the contacting surface of the leveling roller 61 with respect to the movement trajectory of the forming table 8.

The shaft portion 65 is arranged on one end side of the leveling roller 61 to enable movement of the leveling roller 61 in the Z axis direction. Thus, with one end side of the rotating shaft of the leveling roller 61 as a supporting point (i.e., with one end side fixed), the other end side can be moved in the Z axis direction.

The micrometer 62 is disposed on the other end side of the leveling roller 61 movable in the Z axis direction, and is provided to adjust the inclination of the leveling roller 61 with respect to the trajectory of the forming table 8 based on the measurement result of the measuring instrument 10. A distal end portion 62a of the micrometer 62 is manually extended/contracted in a longitudinal direction thereof. When the distal end portion 62a is extended/contracted while making contact with a carriage substrate 21 (see FIG. 5A and FIG. 5B), the other end side of the rotating shaft of the leveling roller 61 can be moved in the Z axis direction based on the above-described measurement result.

In other words, when the three-dimensional object forming device 1 is mounted on a horizontal plane, the adjustment unit including the micrometer 62 and the shaft portion 65 adjusts the inclination of the leveling roller 61 with respect to the horizontal direction to adjust the inclination of the leveling roller 61 with respect to the trajectory of the forming table 8.

<Configuration of Roller Unit 6>

Next, a schematic configuration of the roller unit 6 will be described using FIGS. 5A and 5B. FIGS. 5A and 5B are views showing one example of the schematic configuration of the roller unit 6. As shown in FIG. 5A, the roller unit 6 includes the leveling roller 61, the micrometer 62, the leveling roller driving motor 63, the pulleys 64a, 64b, the shaft portion 65, a bracket 66, a doctor blade 67, an ink receiving plate 68, and a motor supporting portion 69.

As shown in FIGS. 5A and 5B, the roller unit 6 is arranged on the carriage substrate 21 with the ink jet head 3 and the ultraviolet light emitting units 4, 5. The carriage substrate 21 is a plate-like member on which such members are arranged.

The leveling roller 61 is connected to the pulley 64b at the other end side of the rotating shaft thereof. The belt (not shown) is provided on the pulleys 64a, 64b, where the shaft portion of the pulley 64a and the shaft portion of the leveling roller driving motor 63 are connected. The leveling roller driving motor 63 is supported by the motor supporting portion 69, and is provided to rotate the pulley 64a. The leveling roller 61 can be rotated about the rotating shaft by way of the pulley 64a, the belt, and the pulley 64b by driving the leveling roller driving motor 63.

The micrometer 62 is disposed on the other end side (side on which the pulley 64b is connected) of the leveling roller 61, that is, the motor supporting portion 69. On the other hand, the shaft portion 65 is arranged on one end side (side on which the pulley 64b is not connected) of the leveling roller 61, that is, the bracket 66 for fixing the roller unit 6 to the carriage substrate 21. The shaft portion 65 has a rotation axis Ay in the Y axis direction.

The micrometer 62 and the shaft portion 65 are respectively arranged at the ends of the roller unit 6 in the X axis direction. The movable range in the Z axis direction of the other end side of the leveling roller 61 can be increased the greater the distance between the micrometer 62 and the shaft portion 65. In this case, the inclination of the leveling roller 61 with respect to the trajectory of the forming table 8 can be more flexibly adjusted.

The micrometer 62 may be arranged in plurals on the other end side of the leveling roller 61.

The doctor blade 67 eliminates the ink attached to the leveling roller 61 when the leveling roller 61 levels a predetermined layer, and is extended in the longitudinal direction (X axis direction) of the leveling roller 61 and arranged so that the blade edge makes contact with the surface of the leveling roller 61 at a predetermined pressure.

The ink receiving plate 68 stores the ink eliminated from the leveling roller 61 by the doctor blade 67.

<Problems at Time of Leveling>

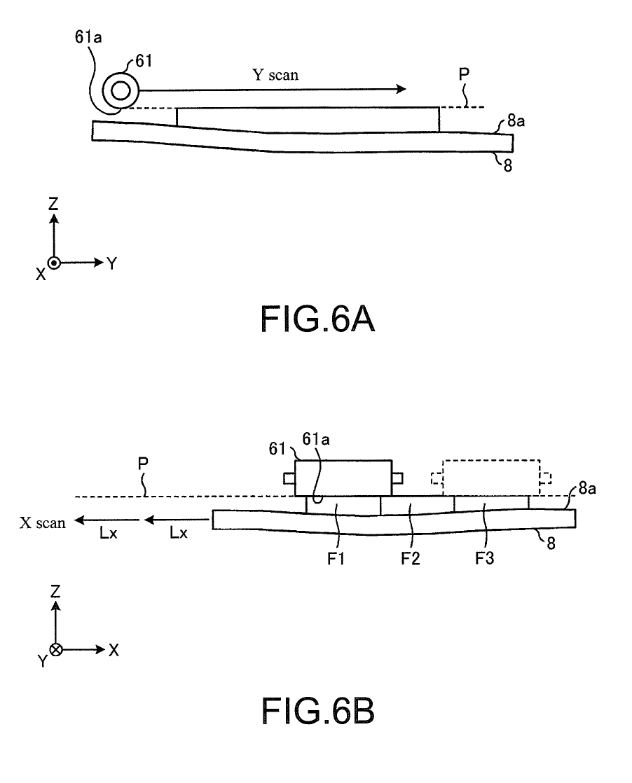

Next, an adjustment method of adjusting the relative position relationship of the leveling roller 61 and the forming table 8 using the measuring instrument 10 and the adjustment unit will be described using FIGS. 6A to 9C. First, problems in leveling a predetermined layer forming the three-dimensional object 100 or the three-dimensional object supporting unit 101 will be described using FIG. 6 to FIG. 7B.

FIG. 6A is a view for describing the leveling at the predetermined layer when the mounting surface 8a of the forming table 8 is inclined toward the Y axis direction or the mounting surface 8a has unevenness. FIG. 6B is a view for describing the leveling at the predetermined layer when the mounting surface 8a of the forming table 8 is inclined toward the X axis direction or the mounting surface 8a has unevenness.

The leveling roller 61 is assumed to be scanned substantially parallel to the surface of the predetermined layer at the time of scanning in the Y axis direction. The oscillation (includes oscillation by rotation) of the leveling roller 61 is assumed to be sufficiently small. Lx shown in FIGS. 6A, 6B, 7A, and 7B indicates a scanning distance (feeding amount) of the forming table 8 (or the leveling roller 61) in the X axis direction for one time when the scanning of the carriage 2 in the Y axis direction is completed, from the completed scanning location to a next scanning location (location (discharging region) adjacent to the scanning completed location (discharging region).

As shown in FIG. 6A, when the mounting surface 8a is inclined toward the Y axis direction or the mounting surface 8a has unevenness, a surface of a predetermined layer is leveled by the leveling roller 61 so that such surface forms a leveled surface P substantially parallel to the rotating shaft of the leveling roller 61. That is, the rotating shaft of the leveling roller 61 (i.e., contacting surface 61a, which is a portion facing the forming table 8 in the leveling roller 61) and the leveled surface P are substantially parallel. In this case, the inclination of the leveling roller 61 with respect to the trajectory of the forming table 8 is substantially zero. Thus, the three-dimensional object 100 or the three-dimensional object supporting unit 101 can be accurately formed, whereby the mounting surface 8a is not required to be a plane.

As shown in FIG. 6B, even if the mounting surface 8a is inclined toward the X axis direction or the mounting surface 8a has unevenness, the leveled surface P parallel to the rotating shaft of the leveling roller 61 is formed in a predetermined layer, similar to FIG. 6A, when the trajectory formed when the forming table 8 is moved in the X axis direction and the rotating shaft (i.e., contacting surface 61a) of the leveling roller 61 are parallel. In other words, the contacting surface 61a of the leveling roller 61 and the leveled surface P become parallel. In this case, the inclination of the leveling roller 61 with respect to the trajectory of the forming table 8 is substantially zero.

Thus, if the scanning direction (direction of arrow shown in FIG. 6B) of the forming table 8 and the X axis direction coincide, the scanning direction and the contacting surface 61a of the leveling roller 61 become parallel, and hence the leveled surface P is formed. Thus, the mounting surface 8a is not required to be a plane in this case as well.

FIGS. 7A and 7B show a case where the mounting surface 8a, on which the three-dimensional object 100 to be formed is mounted, is inclined toward the X axis direction or has unevenness. Furthermore, FIGS. 7A and 7B show a case where the trajectory formed when the forming table 8 is moved in the X axis direction and the contacting surface 61a of the leveling roller 61 are not substantially parallel. In other words, a case where the scanning direction of the forming table 8 has a predetermined angle θ(≠0°) with respect to the X axis direction is shown.

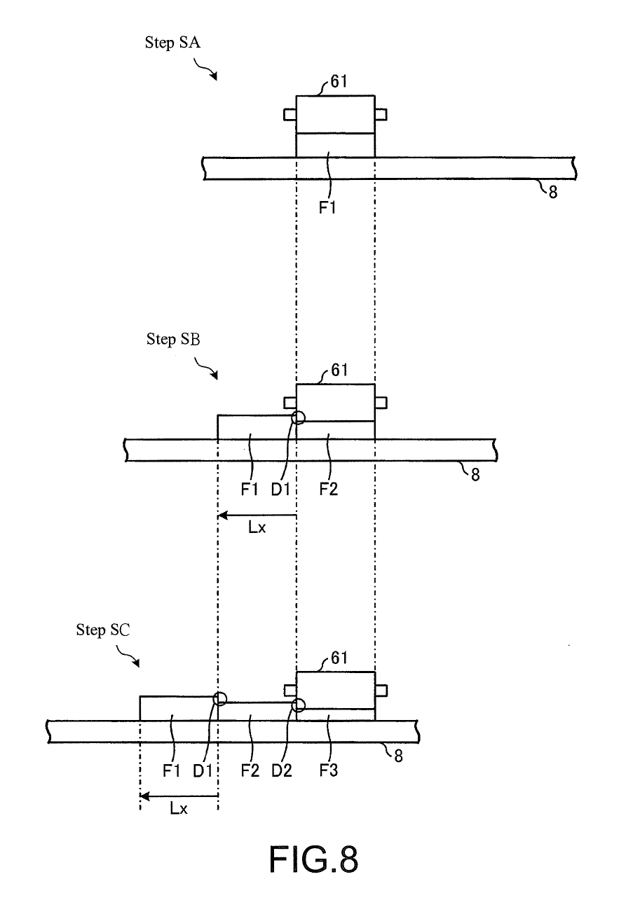

In FIG. 7A, the forming table 8 is scanned in a direction inclined by the predetermined angle θ with respect to a plane including the contacting surface 61a of the leveling roller 61. In this case, the inclination of the leveling roller 61 with respect to the trajectory of the forming table 8 becomes an inclination corresponding to the predetermined angle θ(≠0). Thus, the step differences D1, D2 form in the predetermined layer each time the forming table 8 is scanned. The reason the step difference forms will be further described in detail using FIG. 8.

FIG. 8 is a view showing a state in which a predetermined layer is formed in FIG. 7A. In FIG. 8, a state in which the forming table 8 is scanned twice in the direction inclined by the predetermined angle θ is shown.

As shown in step SA of FIG. 8, the ink discharged onto the forming table 8 is leveled by the leveling roller 61, whereby the partial layer F1 extending in the Y axis direction is completed. Next, the forming table 8 is moved by Lx toward the −X axis direction to form the partial layer F2 having substantially the same thickness as the partial layer F1 at a location adjacent to the partial layer F1.

In this case, as shown in FIG. 7A, the inclination of the leveling roller 61 with respect to the trajectory of the forming table 8 is an inclination corresponding to the predetermined angle θ. In other words, the predetermined angle θ is formed between the scanning direction of the forming table 8 and the leveled surface P. The forming table 8 thus moves in the +Z axis direction (so as to rise).

According to such movement, the step difference D1 having a height worth the predetermined angle θ forms between the partial layer F1 and the partial layer F2, as shown in step SB of FIG. 8. When leveling the partial layer F2 with the leveling roller 61, the end of the leveling roller 61 on the partial layer F1 side makes contact with the partial layer F1 due to the step difference D1, and thus the surface of the partial layer F2 cannot be sufficiently leveled.

Similar problem arises even when the forming table 8 is further moved by Lx. In other words, as shown in step SC of FIG. 8, the step difference D2 having a height worth the predetermined angle θ forms between the partial layer F2 and the partial layer F3, and the end of the leveling roller 61 on the partial layer F2 side makes contact with the partial layer F2, and thus the surface of the partial layer F3 cannot be sufficiently leveled.

When such step differences D1, D2 are formed, the step differences D1, D2 appear as seams of the partial layers F1 to F3 in the completed three-dimensional object 100. In other words, contour-like patterns unintended by the manufacturer tend to form in the three-dimensional object 100, thus affecting the quality of the three-dimensional object 100.

As described above, in the present embodiment, the thickness of each layer is controlled to about 15 to 25 μm. Thus, the height of the step differences D1, D2 of, for example, 10 μm may affect the quality of the three-dimensional object 100. That is, the thickness of each layer needs to be strictly controlled. In order to control the height of the step differences D1, D2 to smaller than 10 μm (e.g., 5 μm), control needs to be made to an inclination (angle θ) of about 5 μm for the scanning distance 60 mm per one time. The height of the step differences D1, D2 is expressed as “scanning distance (corresponds to a length of the nozzle row formed by the plurality of nozzles 31)×sin θ”. In other words, the height is obtained using the feeding amount in the X axis direction of the forming table 8 or the leveling roller 61, and the inclination of the leveling roller 61 with respect to the trajectory of the forming table 8. The height may be expressed as “scanning distance×tan θ”.

In the case of FIG. 7B as well, the forming table 8 is scanned in a direction inclined by the predetermined angle θ with respect to a plane including the contacting surface 61a of the leveling roller 61, similar to the case of FIG. 7A. In other words, the trajectory of the forming table 8 seen from the leveling roller 61 when the leveling roller 61 and the forming table 8 are relatively moved in the X axis direction is formed in a direction inclined by the predetermined angle θ with respect to the contacting surface 61a of the leveling roller 61. Thus, the step differences D1, D2 form in the predetermined layer each time the forming table 8 is scanned.

A state in which the trajectory of the forming table 8 and the contacting surface 61a of the leveling roller 61 are not substantially parallel is a problem that may occur at the time of manufacturing of the three-dimensional object forming device 1, aging deterioration, or the like. In other words, it is a problem that may occur unless alignment of a first unit including the carriage 2 and the Y bar 7, and a second unit including the forming table 8 and the forming table moving mechanism 9 is carried out at a satisfactory precision, and such state is maintained.

<Adjustment Method>

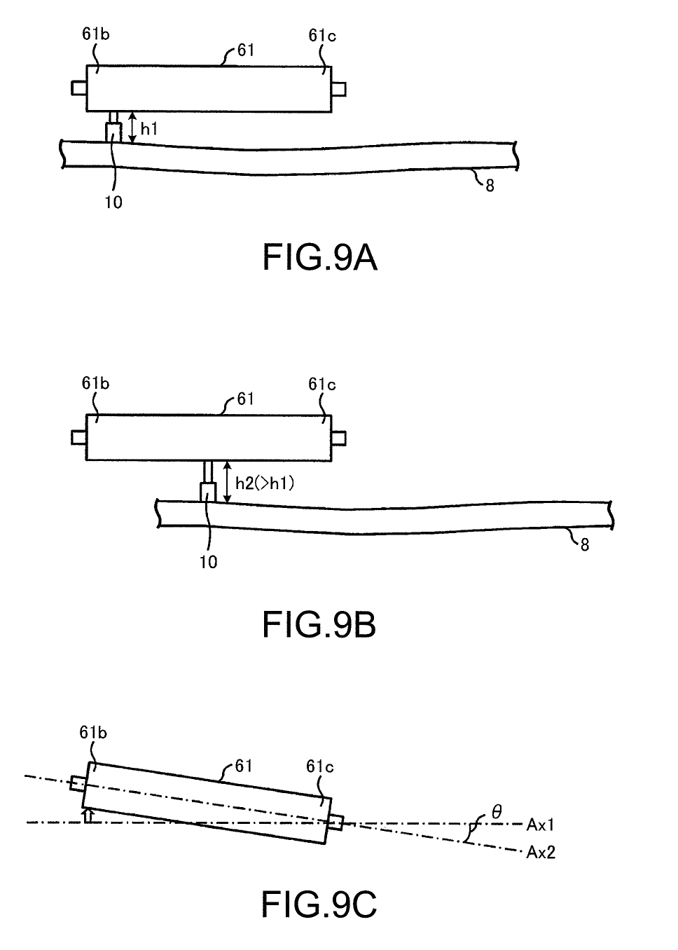

In order to solve the problem described above, the three-dimensional forming device 1 of the present embodiment includes the adjustment unit. The adjustment method of the inclination of the leveling roller 61 with respect to the trajectory of the forming table 8 using the measuring instrument 10 and the adjustment unit (i.e., adjustment method used in the three-dimensional object forming device 1) will be described using FIGS. 9A to 9C. FIGS. 9A to 9C are views for describing one example of the adjustment method of the inclination. In FIGS. 9A to 9C, the description is made assuming the measuring instrument 10 is a micrometer.

In the manufacturing of the three-dimensional object forming device 1, in the installation of the three-dimensional object forming device 1, or in the maintenance of the three-dimensional object forming device 1 carried out periodically, the inclination of the leveling roller 61 with respect to the trajectory of the forming table 8 is adjusted by adjusting the relative position relationship of the leveling roller 61 and the forming table 8.

First, an adjusting operator adjusting the inclination of the leveling roller 61 with respect to the trajectory of the forming table 8 disposes the measuring instrument 10 at a predetermined position of the forming table 8. In this case, the forming table 8 is located at a position where the installed measuring instrument 10 does not make contact with the leveling roller 61.

Next, the positions of the forming table 8 and the leveling roller 61 are respectively defined such that the distal end portion of the measuring instrument 10 makes contact with the contacting surface 61a (FIG. 1) of the leveling roller 61 at an end (end 61b of the leveling roller 61 in FIG. 9A) of the leveling roller 61 to become a starting point of scanning of the forming table 8 in the X axis direction.

Thereafter, the forming table moving mechanism 9 scans the forming table 8 in the +Z axis direction (direction of end 61c) to a position set in advance, as shown in FIG. 9A, upon receiving a control of the scanning/driving control section 53 according to the user operation made by the adjusting operator. The forming table moving mechanism 9 stops the scanning of the forming table 8 in the +Z axis direction at a time point the forming table 8 is moved to a predetermined position.

After the forming table 8 is stopped, the measuring instrument 10 measures a distance h1 of the leveling roller 61 and the forming table 8 (measuring step). The distance h1 becomes a reference value of the distances of the leveling roller 61 and the forming table 8 measured by the subsequent scanning of the forming table 8 in the X axis direction. After the distance h1 is measured, the forming table moving mechanism 9 scans the forming table 8 in the −Z axis direction upon receiving the control of the scanning/driving control section 53. The forming table 8 (i.e., measuring instrument 10) thus can be separated from the leveling roller 61, and scanned in the X axis direction.

Thereafter, as shown in FIG. 9B, the forming table moving mechanism 9 scans the forming table 8 in the X axis direction so that the measuring instrument 10 can be brought into contact at a position different from the position of the leveling roller 61 where the measuring instrument 10 was brought into contact in the case of FIG. 9A, and then stops the forming table 8 at the relevant position. The moving distance of the forming table 8 in the X axis direction may be determined in advance, or may be determined for each measurement by the adjusting operator. The measuring instrument 10 then measures a distance h2 of the leveling roller 61 and the forming table 8 in this case at the above-described position (measuring step).

The adjusting operator obtains a difference of the distances h1, h2, which are the two measurement results, and adjusts the micrometer 62 based on such difference to adjust the inclination of the leveling roller 61 with respect to the trajectory of the forming table 8. In other words, the adjustment unit uses the difference to adjust the inclination of the leveling roller 61 with respect to the trajectory of the forming table 8 (adjusting step). That is, the inclination of the leveling roller 61 with respect to the horizontal plane of the trajectory seen from the forming table 8 for scanning the forming table 8 is adjusted.

In the cases of FIGS. 9A and 9B, the forming table 8 forms the trajectory so as to separate away from the leveling roller 61 as the forming table 8 is scanned in the X axis direction. In other words, the trajectory of the forming table 8 produces the inclination of “(h1−h2)/moving distance in the X axis direction of the leveling roller 61 at the time of measurement” with respect to the rotating shaft direction of the leveling roller 61.

As described above, the inclination of the leveling roller 61 with respect to the trajectory of the forming table 8 needs to be adjusted to an inclination of forming sin θ smaller than or equal to about 5 μm with respect to the scanning distance 60 mm per one time of the forming table 8 (sin θ of range not exceeding 10 μm for at least 60 mm) to prevent the step differences D1, D2 from forming.

Here, the forming table 8 is moved by Lx, that is, the feeding amount (e.g., length of the nozzle row, 60 mm) for one scanning in the X axis direction. Thus, in order to carry out the control described above, for example, a value to be adjusted is obtained by multiplying the difference (h1−h2) by (scanning distance (feeding amount) Lx/moving distance in the X axis direction of the leveling roller 61 at the time of measurement).

The predetermined angle θ is obtained from the difference (h1−h2) and the moving distance of the leveling roller 61 in the X axis direction at the time of measurement. The value to be adjusted may be obtained by multiplying the scanning distance Lx by sin θ calculated from the obtained predetermined angle θ.

For example, in the case of FIG. 9B, the end 61b of the leveling roller 61 is moved in the +Z axis direction by the length obtained as above. In other words, as shown in FIG. 9C, the end 61b side of the leveling roller 61 is moved by the above-described length with the end 61c side (shaft portion 65 (see FIG. 1)) as the rotating shaft so that the rotating shaft of the leveling roller 61 changes from a state of axis A×1 to a state of A×2 by extending the distal end portion 62a of the micrometer 62. The state in which the rotating shaft is A×1 is a state at a position of the leveling roller 61 before the adjustment, and in which the rotating shaft of the leveling roller 61 and the leveled surface P are parallel.

The trajectory of the forming table 8 and the rotating shaft of the leveling roller 61 can be made parallel by such movement control. In other words, similar to FIG. 6B, the three-dimensional object forming device 1 can make the inclination of the leveling roller 61 with respect to the trajectory of the forming table 8 substantially zero, and can scan the forming table 8 in the X axis direction so that the leveled surface P and the contacting surface 61a of the leveling roller 61 become parallel. After obtaining the parallel state by adjusting with the distal end portion 62a of the micrometer 62, at least the rotating shaft of the leveling roller 61 is desirably fixed with a fixing mechanism (not shown).

The distance h1 measured first does not necessarily need to be measured through the above steps. In other words, the length of the distal end portion of the measuring instrument 10 may be adjusted to a predetermined position, and the measurement value at this time may be assumed as the distance h1. In this case, the forming table moving mechanism 9 moves the forming table 8 until the distal end portion of the measuring instrument 10 makes contact with the leveling roller 61. Thereafter, the adjusting operator contracts the distal end portion to a position the distal end portion of the measuring instrument 10 separates away from the leveling roller 61, and then the forming table moving mechanism 9 scans the forming table 8 in the X axis direction up to the next measurement position.

In this case, it is not known whether the distance between the leveling roller 61 and the forming table 8 becomes small or large when the forming table 8 is scanned in the X axis direction. Thus, the predetermined position is preferably set to a position where the distance can be measured in either case during the scanning of the forming table 8 in the X axis direction.

<Main Effects of Three-Dimensional Object Forming Device 1>

In the present embodiment, the three-dimensional object forming device 1 includes the adjustment unit including the shaft portion 65 and the micrometer 62, and has a configuration in which one end side of the leveling roller 61 is a supporting point and the other end side is movable in the Z axis direction. The three-dimensional object forming device 1 adjusts the inclination of the leveling roller 61 with respect to the trajectory of the forming table 8 based on the measurement result of the measuring instrument 10.

The three-dimensional object forming device 1 forms the three-dimensional object 100 greater than the width of the ink jet head 3 in the X axis direction (width of the leveling roller 61 in the X axis direction). Thus, when the inclination of the leveling roller 61 with respect to the trajectory of the forming table 8 becomes an inclination in which sin θ exceeds the above-described range, in particular, the step differences D1, D2 form in the X axis direction in each layer forming the three-dimensional object 100. The step differences D1, D2 appear in the three-dimensional object as a contour pattern not intended by the manufacturer.

However, in the three-dimensional object forming device 1 and the adjustment method, the inclination can be adjusted so that sin θ is within the relevant range even if the inclination of the leveling roller 61 with respect to the trajectory of the forming table 8 becomes an inclination in which sin θ exceeds the range. The three-dimensional object forming device 1 and the adjustment method thus can scan the forming table 8 in the X axis direction so as not to form the step differences D1, D2, and hence can manufacture the three-dimensional object 100 at a satisfactory precision.

### Second Embodiment

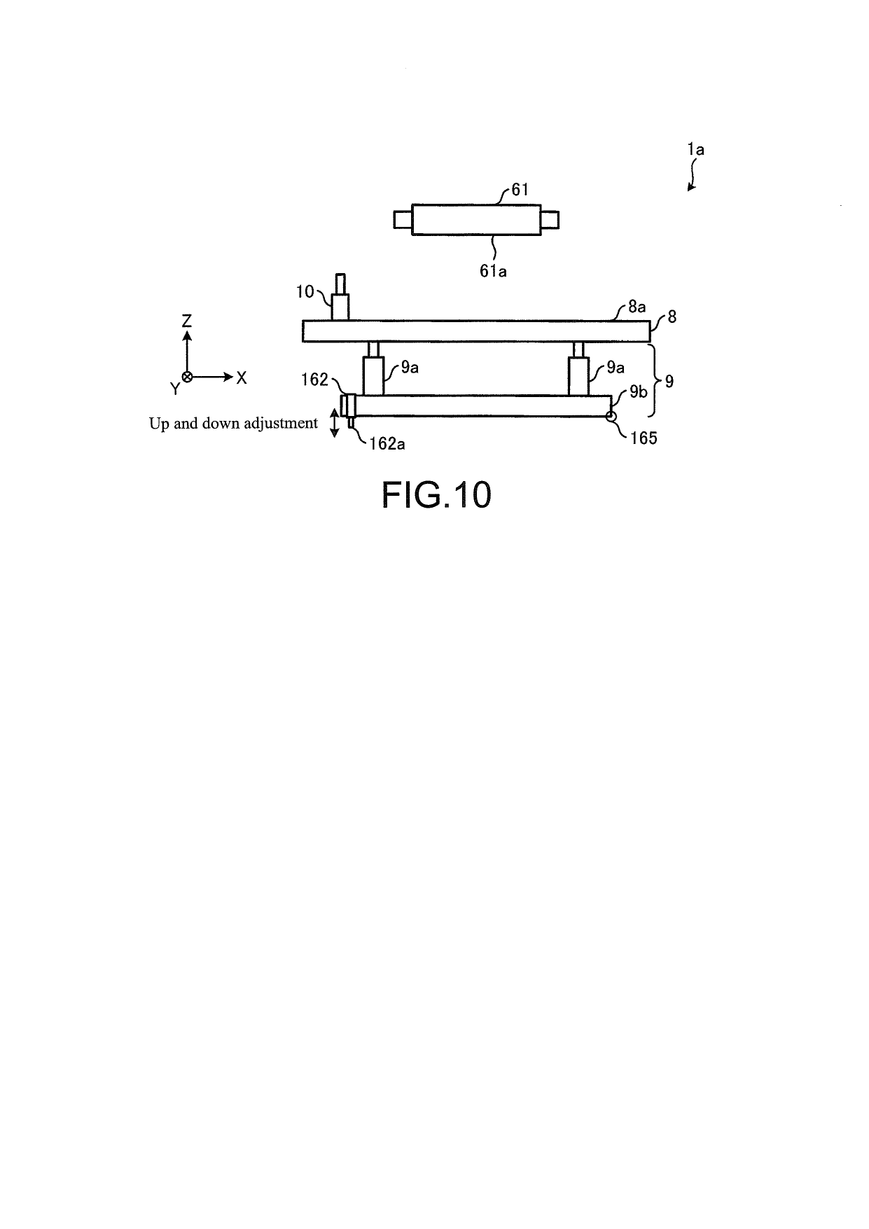

Another embodiment of the disclosure will be described below based on FIG. 10. For the sake of convenience of explanation, the same reference numerals are denoted on members having the same function as the members described in the above embodiment, and the description thereof will be omitted.

The three-dimensional object forming device 1 of the first embodiment has a configuration in which the micrometer 62 and the shaft portion 65 serving as the adjustment unit are provided in the roller unit 6. The three-dimensional object forming device 1 moves the other end side of the leveling roller 61 in the Z axis direction with the shaft portion 65 as the rotating shaft to adjust the inclination of the leveling roller 61 with respect to the trajectory of the forming table 8.

A three-dimensional object forming device 1a of a second embodiment, on the other hand, differs from the three-dimensional object forming device 1a of the first embodiment in that the inclination of the leveling roller 61 with respect to the trajectory of the forming table 8 is adjusted by moving not the leveling roller 61 but the forming table 8 in the Z axis direction.

<Configuration of Three-Dimensional Object Forming Device 1a>

A schematic configuration of the three-dimensional object forming device 1a will be described using FIG. 10. FIG. 10 is a view showing one example of a schematic configuration of the three-dimensional object forming device 1a, and is a view for mainly describing a screw portion 162 and a shaft portion 165.

As shown in FIG. 10, the three-dimensional object forming device 1a includes the forming table 8, the forming table moving mechanism 9, the leveling roller 61, the screw portion 162, and the shaft portion 65. In FIG. 10, one part of the schematic configuration of the three-dimensional object forming device 1a is merely illustrated, where the three-dimensional object forming device 1a has a configuration similar to the three-dimensional object forming device 1 of the first embodiment (see FIGS. 2A, 2B, 3, 5A, 5B, etc.) for configurations other than the micrometer 62 and the shaft portion 65.

The screw portion 162 and the shaft portion 165 are an adjustment unit that adjusts the inclination of the leveling roller 61 with respect to the trajectory of the forming table 8 by moving the forming table 8 based on the measurement result of the measuring instrument 10. In other words, when the three-dimensional object forming device 1a is mounted on a horizontal plane, the adjustment unit including the screw portion 162 and the shaft portion 165 adjusts the inclination with respect to the horizontal direction of the forming table 8 to adjust the inclination of the leveling roller 61 with respect to the trajectory of the forming table 8.

The shaft portion 165 is disposed on one end side of the forming table 8 to enable the movement of the forming table 8 in the Z axis direction irrespective of the scanning of the forming table 8 in the Z axis direction by the forming table moving mechanism 9. Thus, with one end side of the forming table 8 as a supporting point (i.e., with one end side fixed), the other end side can be moved in the Z axis direction irrespective of the scanning of the forming table 8 in the Z axis direction by the forming table moving mechanism 9.

In the present embodiment, the shaft portion 165 is one end of the horizontal moving mechanism 9b in the X direction of the forming table moving mechanism 9. The shaft portion 165 may include a fixing member (not shown) that fixes the one end and causes the relevant one end to function as a rotating shaft extending in the Y axis direction.

The screw portion 162 is disposed on the other end side of the horizontal moving mechanism 9b, and is provided to adjust the inclination of the trajectory of the forming table 8 with respect to an axial direction of the leveling roller 61 based on the measurement result of the measuring instrument 10.

Specifically, the screw portion 162 is disposed at an end of an X direction moving guide rail (not shown), and a distal end portion 162a thereof is adjustable with respect to a device main body frame. If two X direction moving guide rails are arranged in parallel in the Y direction of FIG. 10, the screw portion 162 is also arranged on each and adjusted.

In the present embodiment, the screw portion 162 is provided at the other end side of the horizontal moving mechanism 9b of the forming table moving mechanism 9 so as to pass through a side wall of the horizontal moving mechanism 9b or the interior thereof. The screw portion 162 may be provided in plurals at the other end side of the horizontal moving mechanism 9b.

The screw portion 162 has a function similar to the micrometer 62, but may be the micrometer 62. However, the screw portion 162 does not necessarily need to be able to carry out position adjustment in units of μm such as with the micrometer 62.

In the present embodiment, a width of the leveling roller 61 in the X axis direction is about 100 mm, whereas a width of the forming table 8 in the X axis direction is about 500 mm. In other words, the width of the forming table 8 in the X axis direction is greater than the width of the leveling roller 61 in the X axis direction by about a few times. The precision of the inclination adjustment by the adjustment unit (precision of height adjustment on the other end side of the leveling roller 61 or the forming table 8) is proportional to such width to a certain degree. Thus, the precision of the position adjustment of the same extent as the micrometer 62 is not demanded on the screw portion 162 during the inclination adjustment.

The forming table 8 is connected to the forming table moving mechanism 9, and thus moves in cooperation with the forming table moving mechanism 9 in accordance with the extension/contraction of the screw portion 162 in the Z axis direction when the control by the scanning/driving control section 53 is not being carried out.

<Main Effects of Three-Dimensional Object Forming Device 1a>

In the present embodiment, the three-dimensional object forming device 1a includes the adjustment unit including the shaft portion 165 and the screw portion 162, and has a configuration in which one end side of the forming table 8 is a supporting point and the other end side is movable in the Z axis direction. The three-dimensional object forming device 1a adjusts the inclination of the leveling roller 61 with respect to the trajectory of the forming table 8 based on the measurement result of the measuring instrument 10.

The three-dimensional object forming device 1a thus can carry out the inclination adjustment by the movement control of the forming table 8, and hence can manufacture the three-dimensional object 100 at a satisfactory precision, similar to the first embodiment.

### Third Embodiment

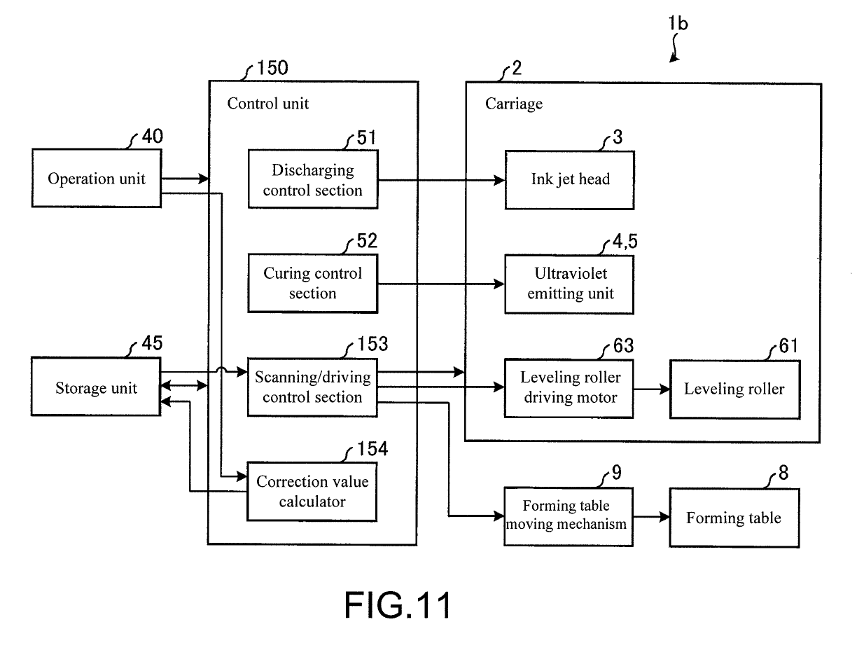

Another embodiment of the disclosure will be described below based on FIGS. 11 to 14C. For the sake of convenience of explanation, the same reference numerals are denoted on members having the same function as the members described in the above embodiment, and the description thereof will be omitted.

<Schematic Configuration of Three-Dimensional Object Forming Device 1b>

An overall schematic configuration of a three-dimensional object forming device 1b of the present embodiment will be described. The three-dimensional object forming device 1b basically has a configuration similar to the three-dimensional object forming device 1 other than the structure of a roller unit 6a and a control unit 150.

As shown in FIG. 11, the three-dimensional object forming device 1b includes the operation unit 40, the storage unit 45, and the control unit 150, in addition to the above-described configuration. FIG. 11 is a function block showing one example of a schematic configuration of the control unit 150.

The control unit 150 executes the control program, for example, according to the user operation accepted by the operation unit 40 to control each member configuring the three-dimensional object forming device 1b. The control unit 150, for example, reads out the program stored in the storage unit 45 to a temporary storage unit (not shown) configured by a RAM (Random Access Memory), and the like, and executes the program to carry out various types of processes such as a discharging control of the ink jet head 3, a driving control of the leveling roller driving motor 63, a movement control of the carriage 2 and the forming table 8, and the like. The detailed configuration of the control unit 150 will be described later.

<Configuration of Roller Unit 6a>

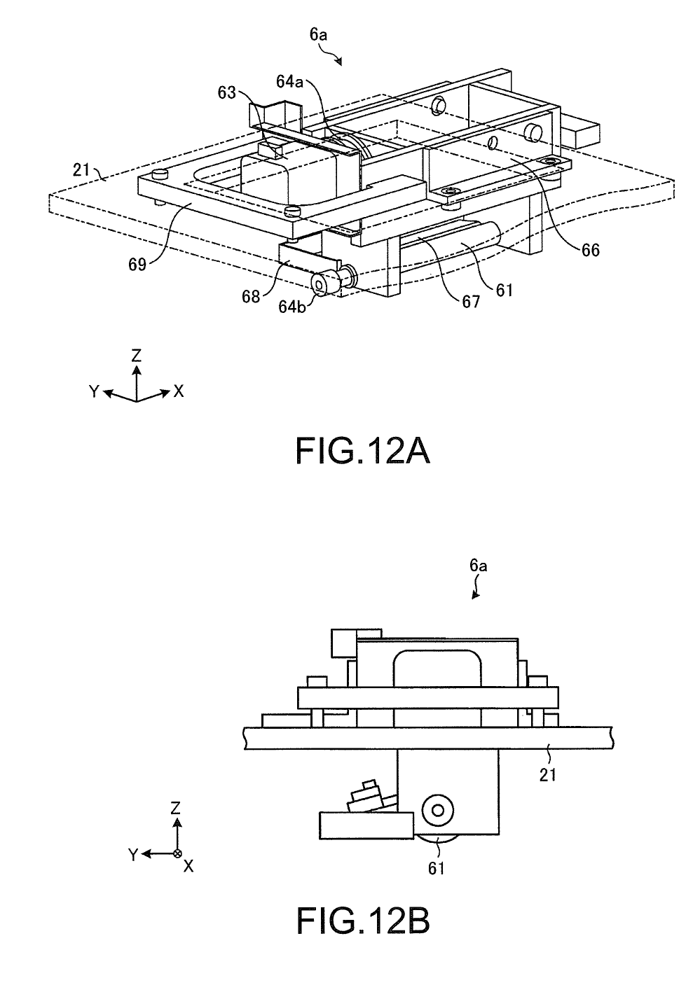

Next, a schematic configuration of the roller unit 6a will be described using FIGS. 12A and 12B. FIGS. 12A and 12B are views showing one example of the schematic configuration of the roller unit 6a. As shown in FIG. 12A, the roller unit 6a includes the leveling roller 61, the leveling roller driving motor 63, the pulleys 64a, 64b, the bracket 66, the doctor blade 67, the ink receiving plate 68, and the motor supporting portion 69. That is, the roller unit 6a does not include the micrometer 62 arranged in the roller unit 6.

The bracket 66 is a member for fixing the roller unit 6a to the carriage substrate 21.

<Configuration of Control Unit 150>

Next, a configuration of the control unit 150 arranged in the three-dimensional object forming device 1b of the present embodiment will be described using FIG. 11. FIG. 11 is a function block showing one example of a schematic configuration of the control unit 150.

The control unit 150 mainly includes the discharging control section 51, the curing control section 52, the scanning/driving control section 153, and a correction value calculator 154.

The scanning/driving control section (movement controller) 153 carries out the scanning of the carriage 2 in the Y axis direction, the scanning of the forming table 8 in the X axis direction and the Z axis direction, and the driving control of the leveling roller driving motor 63.

For example, the carriage 2 is attached to a belt (not shown) extending in the Y axis direction, which belt is wound around two pulleys (not shown) arranged adjacent to the Y bar 7 on both ends of the Y bar 7. A motor (not shown) for controlling the rotation of one pulley is attached to the rotating shaft of the relevant pulley. The scanning/driving control section 153 controls the movement of the carriage 2 in the Y axis direction by controlling the drive of the motor.

Furthermore, the leveling roller 61 is rotated through the belt wound around pulleys 64a, 64b (see FIG. 12A) by carrying out the driving control of the leveling roller driving motor 63. The scanning/driving control section 153 controls the direction and the rotation speed of the rotation of the leveling roller 61 so as to become substantially the same as the moving direction and the speed of the carriage 2. The direction of rotation is a clockwise direction in FIG. 12B, and the contacting surface 61a is also rotated in the left direction when the moving direction of the carriage 2 is the left direction (−Y axis direction). The rotation may be performed on a steady basis during the forming, or may be performed only at the time of the leveling operation. The rotation speed is such that a satisfactory leveling property is obtained in a range the circumferential speed at the contacting surface 61a is two to five times the moving speed of the carriage 2.

In the present embodiment, the description is made assuming the forming table 8 moves in the X axis direction, but this is not the sole case, and a configuration in which the carriage 2 moves in the X axis direction with the Y bar 7 as a whole upon receiving the control of the scanning/driving control section 153 may be adopted. In other words, the leveling roller 61 and the forming table 8 merely need to have a configuration of relatively moving in the X axis direction.

In the three-dimensional object forming device 1b of the present embodiment, the adjustment unit adjusts the inclination of the contacting surface of the leveling roller 61 with respect to the movement trajectory of the forming table 8 by adjusting the inclination of the leveling roller 61 with respect to the horizontal direction.

The scanning/driving control section 153 serving as the adjustment unit carries out a control for adjusting the inclination of the contacting surface 61a of the leveling roller 61 with respect to the trajectory of the forming table 8 (hereinafter simply referred to as “inclination of the leveling roller 61 with respect to the trajectory of the forming table 8”) seen from the leveling roller 61 when the leveling roller 61 and the forming table 8 are relatively moved in the X axis direction during the forming of the three-dimensional object 100 or the three-dimensional object supporting unit 101.

Specifically, the scanning/driving control section 153 (adjustment unit) adjusts the relative movement amount in the Z axis direction, and relatively moves the forming table 8 and the leveling roller 61 in the Z axis direction so as to carry out the above-described adjustment with the relative movement of the leveling roller 61 and the forming table 8 in the X axis direction. In the present embodiment, the scanning/driving control section 153 moves the forming table 8 in the Z axis direction. The scanning/driving control section 153 carries out the above-described adjustment by moving the forming table 8 in the Z axis direction by a distance indicated by a correction value calculated by the correction value calculator 154. More specifically, at the time of scanning of the forming table 8 in the X axis direction, the scanning/driving control section 153 reads out correction value data indicating the correction value calculated by the correction value calculator 154 from the storage unit 45 to move the forming table 8 in the Z axis direction by the corrected distance.

The correction value calculator 154 calculates the correction value for adjusting the inclination of the leveling roller 61 with respect to the trajectory of the forming table 8 based on the measurement value data indicating the measurement result of the distance measured by the user using the measuring instrument 10 and input from the operation unit 40. The correction value calculator 154 then stores the calculated correction value in the storage unit 45 as the correction value data. The calculating method of the correction value will be described later.

The scanning/driving control section 153 moves the forming table 8 in the Z axis direction as well based on the correction value at the time of the movement of the forming table 8 in the X axis direction while the forming process is repeated.

<Adjustment Method>

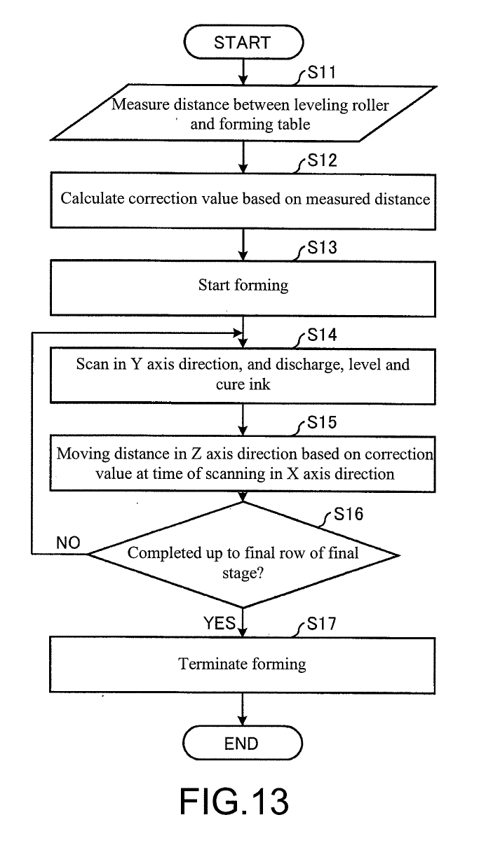

In order to solve the problem at the time of leveling, the three-dimensional object forming device 1b relatively moves the forming table 8 and the leveling roller 61 in the Z axis direction based on the correction value during the relative movement of the forming table 8 and the leveling roller 61 in the X axis direction. The adjustment method of the inclination of the leveling roller 61 with respect to the trajectory of the forming table 8 (i.e., adjustment method used in the three-dimensional object forming device 1b) will be described using FIG. 13 and FIGS. 9A to 9C described above. FIG. 13 is a flowchart showing one example of a flow of processes of the three-dimensional object forming device 1b.

As shown in FIG. 13, the user measures a distance between the leveling roller 61 and the forming table 8 (S11; measuring step). The user is not limited to a person who forms the three-dimensional object 100 using the three-dimensional object forming device 1b, and for example, may be an adjusting operator who adjusts the inclination of the leveling roller 61 with respect to the trajectory of the forming table 8.

Specifically, the user first disposes the measuring instrument 10 at a predetermined position on the forming table 8. In this case, the forming table 8 is located at a position where the installed measuring instrument 10 does not make contact with the leveling roller 61.

Next, the positions of the forming table 8 and the leveling roller 61 are respectively defined such that the distal end portion of the measuring instrument 10 makes contact with the contacting surface 61a (FIG. 11) of the leveling roller 61 at the end (FIG. 9A) of the leveling roller 61 to become a starting point of scanning of the forming table 8 in the X axis direction.

Thereafter, the forming table moving mechanism 9 scans the forming table 8 in the +Z axis direction to a position set in advance, as shown in FIG. 9A, upon receiving a control of the scanning/driving control section 153 according to the user operation made by the user. The forming table moving mechanism 9 stops the scanning of the forming table 8 in the +Z axis direction at a time point the forming table 8 is moved to a predetermined position.

After the forming table 8 is stopped, the measuring instrument 10 measures the distance h1 of the leveling roller 61 and the forming table 8. The distance h1 becomes a reference value of the distances of the leveling roller 61 and the forming table 8 measured by the subsequent scanning of the forming table 8 in the X axis direction. After the distance h1 is measured, the forming table moving mechanism 9 scans the forming table 8 in the −Z axis direction upon receiving the control of the scanning/driving control section 153. The forming table 8 (i.e., measuring instrument 10) thus can be separated from the leveling roller 61, and scanned in the X axis direction.

Thereafter, as shown in FIG. 9B, the forming table moving mechanism 9 scans the forming table 8 in the X axis direction (direction of the end 61c) so that the measuring instrument 10 can be brought into contact at a position different from the position of the leveling roller 61 where the measuring instrument 10 was brought into contact in the case of FIG. 9A, and then stops the forming table 8 at the relevant position. The moving distance of the forming table 8 in the X axis direction may be determined in advance, or may be determined for each measurement by the user. The measuring instrument 10 then measures the distance h2 of the leveling roller 61 and the forming table 8 in this case at the above-described position.

Next, the operation unit 40 accepts a measurement values indicating the distances h1, h2 measured by the user, and transmits the measurement values to the correction value calculator 154 as measurement value data. The correction value calculator 154 calculates the correction value based on the distances h1, h2 (S2: correction value calculating step). The correction value calculator 154 then stores the calculated correction value in the storage unit 45 as the correction value data.

In the cases of FIGS. 9A and 9B, the forming table 8 forms the trajectory so as to separate away from the leveling roller 61 as the forming table 8 is scanned in the X axis direction. In other words, the trajectory of the forming table 8 produces the inclination of “(h1−h2)/moving distance in the X axis direction of the leveling roller 61 at the time of measurement” with respect to the rotating shaft direction of the leveling roller 61.

As described above, the inclination of the leveling roller 61 with respect to the trajectory of the forming table 8 needs to be adjusted to an inclination of forming sin θ smaller than or equal to about 5 μm with respect to the scanning distance 60 mm per one time of the forming table 8 (sin θ of range not exceeding 10 μm for at least 60 mm) to prevent the step differences D1, D2 from forming.

Here, the forming table 8 is moved by Lx, that is, the feeding amount (e.g., length of the nozzle row, 60 mm) for one scanning in the X axis direction. Thus, in order to carry out the control described above, for example, the correction value calculator 154 calculates a value obtained by multiplying the difference (h1−h2) by (scanning distance (feeding amount) Lx/moving distance in the X axis direction of the leveling roller 61 at the time of measurement) as the correction value. The correction value calculator 154 obtains the predetermined angle θ from the difference (h1−h2) and the moving distance of the leveling roller 61 in the X axis direction at the time of measurement. A value obtained by multiplying the scanning distance Lx by sin θ calculated from the obtained predetermined angle θ may be calculated as the correction value. Furthermore, the scanning distance Lx may be multiplied by tan θ instead of sin θ. In other words, the correction value calculator 154 obtains the correction value using the feeding amount and the inclination of the leveling roller 61 with respect to the trajectory of the forming table 8.

When the operation unit 40 accepts a user operation indicating the start of forming after the correction value data is stored in the storage unit 45 by the correction value calculator 154, the control unit 150 starts the forming of the three-dimensional object 100 (S13; forming start step). The three-dimensional object 100 is formed as described using FIG. 4. In other words, the discharging control section 51 discharges the ink from the ink jet head 3 to each row (each discharging region) extending in the Y axis direction forming each layer while the scanning/driving control section 153 scans the forming table 8 in the Y axis direction. Furthermore, when the scanning/driving control section 153 moves the forming table 8 in the Z axis direction and drives the leveling roller driving motor 63, the leveling roller 61 levels the discharged ink. At this time, the curing control section 52 cures the ink (S14; Y axis scanning process step).

Thereafter, the scanning/driving control section 153 moves the forming table 8 in the X axis direction by the scanning distance Lx to form a new discharging region adjacent to the completed discharging region. In this case, the scanning/driving control section 153 reads out the correction value data from the storage unit 45, and moves the forming table 8 in the Z axis direction based on the correction value indicated by the correction value data (S15; movement control step). In other words, in this step, the scanning/driving control section 153 relatively moves the forming table 8 and the leveling roller 61 in the Z axis direction so as to adjust the inclination of the leveling roller 61 with respect to the trajectory of the forming table 8 with the relative movement of the forming table 8 and the leveling roller 61 in the X axis direction.

A height of the differences D1, D2 is obtained using the feeding amount and the inclination of the leveling member with respect to the trajectory of the forming table 8. In other words, when the correction value calculator 154 obtains the correction value in the above manner, the three-dimensional object forming device 1b can use the actual step differences D1, D2 that form when the inclination of the leveling roller 61 with respect to the trajectory of the forming table 8 is not adjusted as the correction value, and carry out the adjustment of the inclination. Thus, the three-dimensional object forming device 1b can prevent the formation of the step differences D1, D2 at a satisfactory precision. The correction value can also be considered as a step difference value corresponding to the step differences D1, D2 that may form when leveling of a predetermined layer is carried out while the forming table 8 and the leveling roller 61 are relatively moved in the Y axis direction, and thereafter, the forming table 8 and the leveling roller 61 are relatively moved in the X axis direction, and the leveling is again carried out.

The control unit 150 determines whether or not the stacking of ink is completed up to the final row in the layer of the final stage (S16; forming complete determining step). When determining as not completed (NO in S16), the control unit 150 repeatedly carries out the processes of S14 and S15 until determining as completed. When determining as completed (YES in S16), the control unit terminates the forming process of the three-dimensional object 100 (S17; forming terminating step).

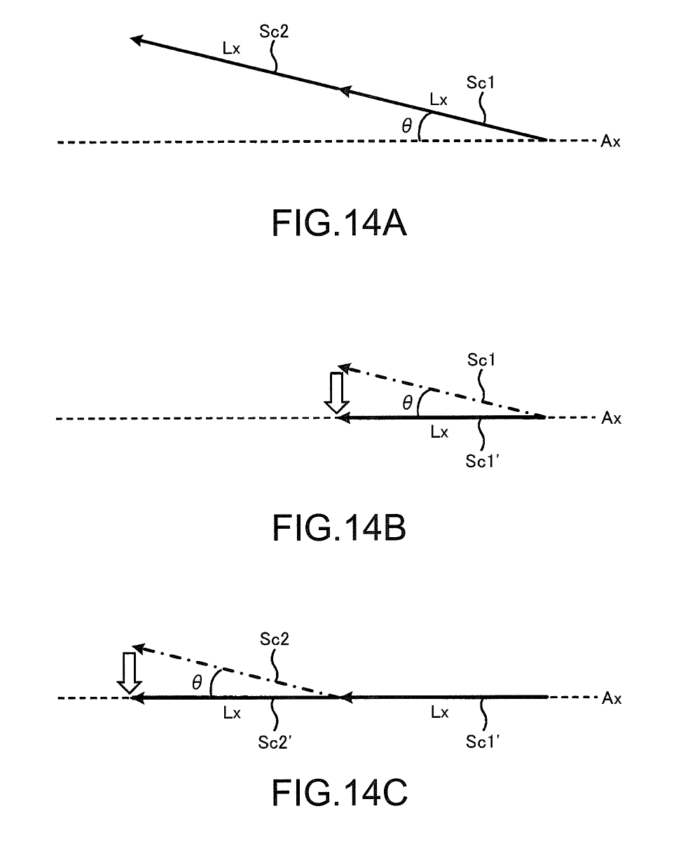

For example, in the case of the measurement result (h2>h1) shown in FIGS. 9A to 9C, the correction is carried out as shown in FIGS. 14A to 14C. FIGS. 14A to 14C are views showing one example of a state in which the inclination of the leveling roller 61 with respect to the trajectory of the forming table 8 is adjusted. An axis Ax is a virtual axis of the trajectory of the forming table 8 when the forming table 8 is moved in a direction substantially parallel to the contacting surface 61a of the leveling roller 61. In other words, when the forming table 8 is moved along the virtual axis Ax, the step differences D1, D2 can be suppressed from being formed.

When the movement control of the forming table 8 in the Z axis direction based on the correction value is not carried out at the time of the movement in the X axis direction as in FIG. 14A, the forming table 8 is moved away from the virtual line Ax by the predetermined angle θ. In other words, when advanced by the scanning distance Lx by the first scanning, the forming table 8 is moved so as to separate away from the virtual axis Ax by Lx sin θ in the +Z axis direction thus forming a trajectory Sc1. Similarly, when advanced by the scanning distance Lx by the second scanning, the forming table 8 is moved so as to further separate away from the virtual axis Ax by Lx sin θ in the +Z axis direction thus forming a trajectory Sc2. Thus, after the second scanning is terminated, the forming table 8 is separated from the virtual line Ax by 2Lx sin θ in the +Z axis direction.

In the three-dimensional object forming device 1b, the scanning/driving control section 153 moves the forming table 8 in the −Z axis direction at the time of the movement in the X axis direction based on the correction value calculated by the correction value calculator 154. Specifically, the scanning/driving control section 153 moves the forming table 8 in the −Z axis direction by a distance (i.e., Lx sin θ) indicated by the correction value calculated by the correction value calculator 154 at the time of the movement in the X axis direction. Thus, as shown in FIG. 14B, the forming table 8 forms a trajectory Sc1′ that substantially coincides with the virtual line Ax when advanced by the scanning distance Lx by the first scanning. Similarly in the case of FIG. 14C, the forming table 8 forms a trajectory Sc2′ that substantially coincides with the virtual line Ax when advanced by the scanning distance Lx by the second scanning.

The trajectory of the forming table 8 and the rotating shaft of the leveling roller 61 can be made substantially parallel by such movement control. In other words, similar to FIG. 6B described above, the three-dimensional object forming device 1b can make the inclination of the leveling roller 61 with respect to the trajectory of the forming table 8 substantially zero, and can scan the forming table 8 in the X axis direction so that the leveled surface P and the contacting surface 61a of the leveling roller 61 become substantially parallel.

<Main Effects of Three-Dimensional Object Forming Device 1b>

In the present embodiment, the scanning/driving control section 153 of the three-dimensional object forming device 1b relatively moves the forming table 8 and the leveling roller 61 in the Z axis direction so as to adjust the inclination of the leveling roller 61 with respect to the trajectory of the forming table 8 with the relative movement of the forming table 8 and the leveling roller 61 in the X axis direction. Specifically, the scanning/driving control section 153 moves the forming table 8 in the Z axis direction by a distance indicated by the correction value calculated by the correction value calculator 154 using the feeding amount and the inclination at the time of the movement of the forming table 8 in the X axis direction.

The three-dimensional object forming device 1b forms the three-dimensional object 100 greater than the width of the ink jet head 3 in the X axis direction (width of the leveling roller 61 in the X axis direction). Thus, when the inclination of the leveling roller 61 with respect to the trajectory of the forming table 8 becomes an inclination in which sin θ exceeds the above-described range, in particular, the step differences D1, D2 form in the X axis direction in each layer forming the three-dimensional object 100. The step differences D1, D2 appear in the three-dimensional object as a contour pattern not intended by the manufacturer. In particular, the step differences D1, D2 appear as a line in a color image surface thus greatly affecting the quality in the three-dimensional object with a colored surface on which higher precision is demanded. Such problem is not reviewed in Japanese Unexamined Patent Publication No. 2013-67119, and an idea that contributes to a solution is not disclosed.

However, in the three-dimensional object forming device 1b and the control method thereof, the inclination can be adjusted so that sin θ is within the relevant range even when the inclination of the leveling roller 61 with respect to the trajectory of the forming table 8 becomes an inclination in which sin θ exceeds the range. Specifically, the scanning/driving control section 153 can automatically move the forming table 8 in the Z axis direction at the time of the movement of the forming table 8 in the X axis direction so that the step differences D1, D2 are not formed. Thus, the three-dimensional object forming device 1c and the controlling method thereof can manufacture the three-dimensional object 100 at a satisfactory precision through a simple method. Therefore, even the three-dimensional object with a colored surface on which higher precision is demanded can be manufactured at high precision.

Furthermore, the three-dimensional forming device 1 includes the correction value calculator 154. In other words, the three-dimensional forming device 1 can interiorly calculate the correction value. Furthermore, since the user does not need to obtain the correction value, a user friendly three-dimensional forming device can be provided.

### Fourth Embodiment

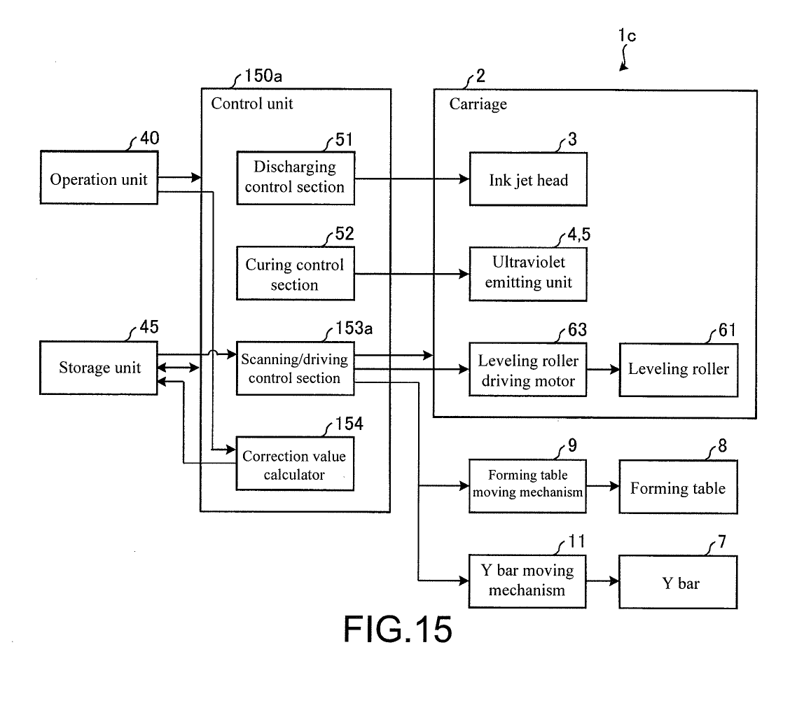

Another embodiment of the disclosure will be described below based on FIG. 15. For the sake of convenience of explanation, the same reference numerals are denoted on members having the same function as the members described in the above embodiment, and the description thereof will be omitted.

In the three-dimensional object forming device 1 of the third embodiment, the scanning/driving control section 153 moves the forming table 8 in the Z axis direction using the correction value calculated by the correction value calculator 154. A three-dimensional forming device 1c of the present embodiment differs from the three-dimensional forming device 1 in that the Y bar 7 is moved in the Z axis direction using the correction value.

<Schematic Configuration of Three-Dimensional Object Forming Device 1c>

As shown in FIG. 15, the three-dimensional forming device 1c has a configuration in which the control unit 150 of the three-dimensional forming device 1 is replaced with a control unit 150a, and a Y bar moving mechanism 11 is further arranged in the three-dimensional forming device 1. The control unit 150a has a function similar to the control unit 150, and includes the discharging control section 51, the curing control section 52, a scanning/driving control section 153a, and a correction value calculator 154a.

The Y bar moving mechanism 11 moves the Y bar 7 in the Z axis direction upon receiving the control of the scanning/driving control section 153a. For example, a supporting column (not shown) that supports the Y bar 7 functions as a perpendicular moving mechanism (not shown) for moving the Y bar 7 in the Z axis direction, similar to the perpendicular moving mechanism 9a. The perpendicular moving mechanism moves the Y bar 7 in the Z axis direction by, for example, extending/contracting in the Z axis direction upon receiving the control of the scanning/driving control section 153a.

The scanning/driving control section 153a carries out the scanning of the carriage 2 in the Y axis direction, the scanning of the forming table 8 in the X axis direction and the Z axis direction, and the driving control of the leveling roller driving motor 63, similar to the scanning/driving control section 153.

Furthermore, the scanning/driving control section 153a adjusts the relative movement amount in the Z axis direction, and relatively moves the forming table 8 and the leveling roller 61 in the Z axis direction so as to adjust the inclination of the leveling roller 61 with respect to the trajectory of the forming table 8 with the relative movement of the leveling roller 61 and the forming table 8 in the X axis direction during the forming of the three-dimensional object 100 or the three-dimensional supporting unit 101. Specifically, the scanning/driving control section 153 controls the Y bar moving mechanism 11 to move the Y bar 7 in the Z axis direction by a distance (Lx sin θ) indicated by the correction value calculated by the correction value calculator 154, similar to the third embodiment. In other words, in the present embodiment, the scanning/driving control section 153a moves the leveling roller 61 in the Z axis direction by moving the Y bar 7 in the Z axis direction instead of moving the forming table 8 in the Z axis direction based on the correction value.

In the present embodiment, the forming table 8 is not moved in the Z axis direction using the correction value at the time of the movement in the X axis direction, and is moved in the Z axis direction only for stacking a plurality of layers. This is not the sole case, and the scanning/driving control section 153a may move the Y bar 7 in the Z axis direction in place of the forming table 8 to stack the plurality of layers.

Furthermore, the scanning/driving control section 153a may move the Y bar 7 in the X axis direction in place of the forming table 8. For example, a supporting column (not shown) that supports the Y bar 7 functions as a horizontal moving mechanism (not shown) for moving the Y bar 7 in the X axis direction, similar to the horizontal moving mechanism 9b. Specifically, a rail (not shown) extending in the X axis direction is arranged to face the horizontal moving mechanism, so that the horizontal moving mechanism slides on the rail in the X axis direction upon receiving the control of the scanning/driving control section 153a. The Y bar 7 is thereby moved in the X axis direction.

In other words, the three-dimensional forming device 1c merely needs to have a configuration capable of relatively moving the forming table 8 and the leveling roller 61 in the X axis direction, the Y axis direction, and the Z axis direction. The movement control of the forming table 8 and the leveling roller 61 in the Z axis direction may be carried out based on the correction value in both the forming table moving mechanism 9 and the Y bar moving mechanism 11.

<Main Effects of Three-Dimensional Object Forming Device 1c>

In the present embodiment, the scanning/driving control section 153a of the three-dimensional object forming device 1c relatively moves the forming table 8 and the leveling roller 61 in the Z axis direction so as to adjust the inclination of the leveling roller 61 with respect to the trajectory of the forming table 8 with the relative movement of the forming table 8 and the leveling roller 61 in the X axis direction, similar to the scanning/driving control section 153. Specifically, the scanning/driving control section 153a moves the Y bar 7 in the Z axis direction by a distance indicated by the correction value calculated by the correction value calculator 154 using the feeding amount and the inclination at the time of the movement of the forming table 8 in the X axis direction.

Thus, similar to the third embodiment, the scanning/driving control section 153a can automatically move the leveling roller 61 in the Z axis direction at the time of the movement of the forming table 8 in the X axis direction so that the step differences D1, D2 are not formed. Thus, the three-dimensional object forming device 1c and the controlling method thereof can manufacture the three-dimensional object 100 at a satisfactory precision through a simple method.

### Fifth Embodiment

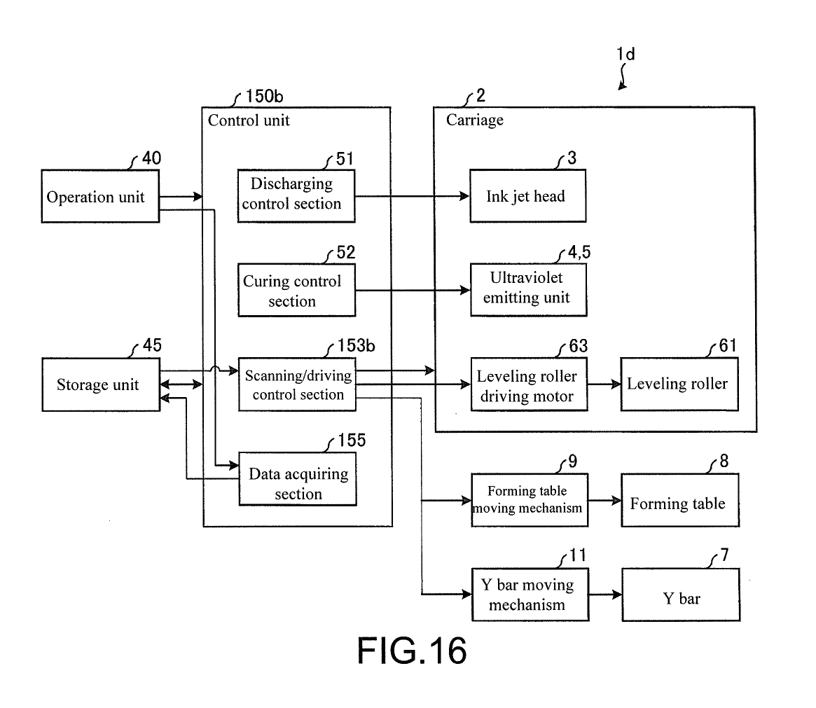

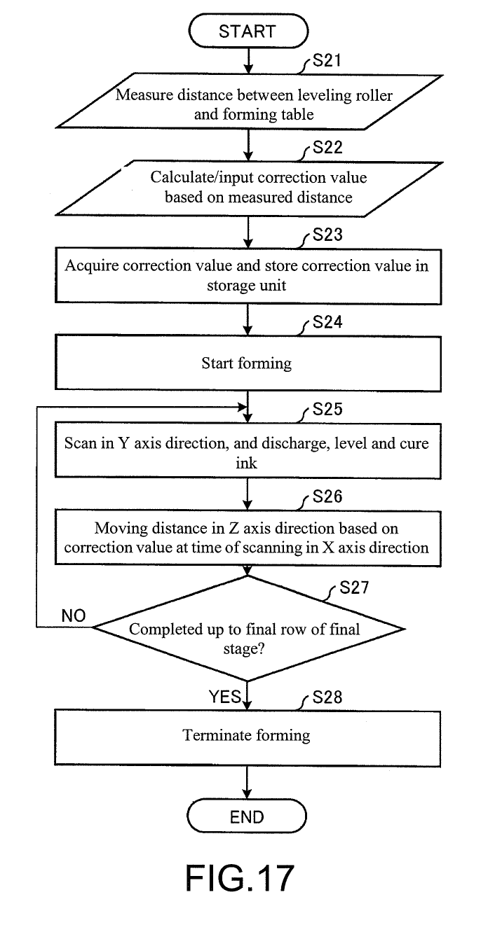

Another embodiment of the disclosure will be described below based on FIGS. 16 and 17. For the sake of convenience of explanation, the same reference numerals are denoted on members having the same function as the members described in the above embodiment, and the description thereof will be omitted.

In the three-dimensional object forming device 1 of the third embodiment, the scanning/driving control section 153 moves the forming table 8 in the Z axis direction using the correction value calculated by the correction value calculator 154. In the three-dimensional object forming device 1c of the fourth embodiment, the scanning/driving control section 153a moves the Y bar 7 in the Z axis direction using the correction value calculated by the correction value calculator 154. A three-dimensional object forming device 1d of the present embodiment differs from the three-dimensional object forming devices 1, 1a in that at least one of the forming table 8 and the Y bar 7 is moved in the Z axis direction using the correction value calculated exterior to the three-dimensional object forming device 1d instead of by the correction value calculator 154.

<Schematic Configuration of Three-Dimensional Object Forming Device 1d>

As shown in FIG. 16, the three-dimensional forming device 1d has a configuration in which the control unit 150 of the three-dimensional forming device 1 is replaced with a control unit 150b, and the Y bar moving mechanism 11 is further arranged in the three-dimensional forming device 1. The control unit 150b has a function similar to the control unit 150 or 50a, and includes the discharging control section 51, the curing control section 52, a scanning/driving control section 153b, and a data acquiring section 55. In addition to the user operation described in the third embodiment, the operation unit 40 accepts the input of the correction value data indicating the correction value calculated by the user.

The scanning/driving control section 153b carries out the scanning of the carriage 2 in the Y axis direction, the scanning of the forming table 8 or the Y bar 7 in the X axis direction and the Z axis direction, and the driving control of the leveling roller driving motor 63, similar to the scanning/driving control section 153 or 53a.

Furthermore, the scanning/driving control section 153b adjusts the relative movement amount in the Z axis direction and relatively moves the forming table 8 and the leveling roller 61 in the Z axis direction so as to adjust the inclination of the leveling roller 61 with respect to the trajectory of the forming table 8 with the relative movement of the leveling roller 61 and the forming table 8 in the X axis direction during the forming of the three-dimensional object 100 or the three-dimensional supporting unit 101. Specifically, the scanning/driving control section 153b controls the forming table moving mechanism 9 or the Y bar moving mechanism 11 to move the forming table 8 and/or the Y bar 7 in the Z axis direction by a distance (Lx sin θ) indicated by the correction value, similar to the scanning/driving control section 153 or 53a.

The data acquiring section 55 acquires the correction value data indicating the correction value obtained exterior to the three-dimensional object forming device 1d. Specifically, when the operation unit 40 accepts the input of the correction value obtained by the user, the data acquiring section 55 acquires correction value data indicating the input correction value. The correction value may be manually obtained by the user, or may be obtained by an external device connected to the three-dimensional object forming device 1d and to which the distances h1, h2 (see FIGS. 9A and 9B) measured by the user can be input.

The data acquiring section 55 stores the acquired correction value data in the storage unit 45. The scanning/driving control section 153b uses the correction value data acquired by the data acquiring section 55 and stored in the storage unit 45 to relatively move the forming table 8 and the leveling roller 61.

Thus, in the three-dimensional object forming device 1d of the present embodiment, the correction value calculator 154 is not arranged, but instead, the forming table 8 or the Y bar 7 is relatively moved in the Z axis direction using the correction value obtained exterior to the three-dimensional object forming device 1d.

<Adjustment Method>

An adjustment method of the inclination of the leveling roller 61 with respect to the trajectory of the forming table 8 (i.e., adjustment method used in the three-dimensional object forming device 1d) will be described using FIG. 17. FIG. 17 is a flowchart showing one example of a flow of processes of the three-dimensional object forming device 1d.

As shown in FIG. 17, the user measures the distances h1, h2 between the leveling roller 61 and the forming table 8 (S21; measuring step). The measuring process is a process similar to S11 shown in FIG. 13. The user calculates the correction value through the method described above in the third embodiment based on the measured distances h1, h2. The user then inputs the obtained correction value to the three-dimensional object forming device 1d through the operation unit 40 (S22; correction value calculating/inputting step). In other words, the operation unit 40 accepts the input of the correction value obtained by the user.

The data acquiring section 55 acquires the correction value data indicating the correction value through the operation unit 40, and then stores the same in the storage unit 45 (correction value acquiring/storing step). When the operation unit 40 accepts a user operation indicating the start of forming after the correction value data acquired from the exterior of the three-dimensional object forming device 1d is stored in the storage unit 45, the control unit 150 starts the forming of the three-dimensional object 100 (S24; forming start step).

Thereafter, similar to S14 shown in FIG. 13, the control unit 150b carries out each process of discharging, leveling and curing of ink while relatively moving the forming table 8 and the leveling roller 61 in the Y axis direction (S25; Y axis scanning process step). Thereafter, similar to S15 shown in FIG. 13, the scanning/driving control section 153b moves the forming table 8 or the leveling roller 61 in the X axis direction by the scanning distance Lx to form a new discharging region adjacent to the completed discharging region. In this case, the scanning/driving control section 153b reads out the correction value data from the storage unit 45, and moves the forming table 8 or the leveling roller 61 in the Z axis direction based on the correction value indicated by the correction value data (S26; movement control step).

The processes of S27 and S28 are similar to S16 (forming complete determining step) and S17 (forming terminating step) shown in FIG. 13.

<Main Effects of Three-Dimensional Object Forming Device 1d>

Similar to the three-dimensional object forming device 1, 1a, the scanning/driving control section 153b of the three-dimensional object forming device 1d relatively moves the forming table 8 and the leveling roller 61 in the Z axis direction so as to adjust the inclination of the leveling roller 61 with respect to the trajectory of the forming table 8 with the relative movement of the forming table 8 and the leveling roller 61 in the X axis direction. Thus, the three-dimensional object forming device 1c and the controlling method thereof can manufacture the three-dimensional object 100 at a satisfactory precision through a simple method.

Furthermore, in the present embodiment, the three-dimensional object forming device 1d does not need to calculate the correction value since the correction value is obtained exterior to the three-dimensional object forming device 1d. Therefore, the processing load of the three-dimensional object forming device 1d can be alleviated compared to the three-dimensional object forming devices 1, 1a.

### Sixth Embodiment

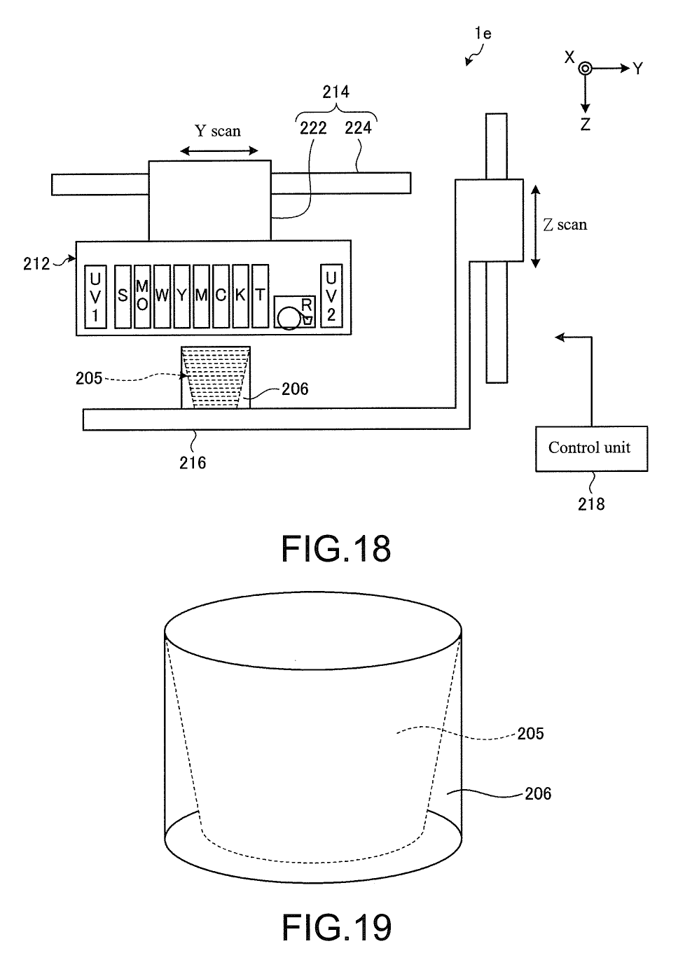

FIG. 18 is a schematic view of a three-dimensional object forming device according to a sixth embodiment. FIG. 19 is a perspective view showing one example of a forming object formed by the three-dimensional object forming device shown in FIG. 18. A three-dimensional object forming device 1e shown in FIG. 18 is a device that forms a three-dimensional forming object 205 through a stacking forming method. In this case, the stacking forming method is, for example, a method of forming the forming object 205 by stacking a plurality of layers. The forming object 205 is, for example, a three-dimensional structural object. The three-dimensional object forming method executed in the three-dimensional object forming device 1e may be, for example, a color forming method of forming the three-dimensional structural object from shape information and color image information of the three-dimensional structural object.

Other than the aspect described below, the three-dimensional object forming device 1e may have a configuration same as or similar to the known three-dimensional object forming device. The three-dimensional object forming device 1e may be, for example, a device in which a part of the configuration of the ink jet printer, which is a known planar printing device, is changed. For example, the three-dimensional object forming device 1e may be a device in which a part of the ink jet printer using the ultraviolet curable ink (UV ink) is changed.

The three-dimensional object forming device 1e according to the sixth embodiment includes a discharging unit 212, a main scanning driving unit 214, a forming table 216 or a mounting table on which the forming object 205 is mounted, and a control unit 218. The discharging unit 212 is a portion that discharges liquid droplet to become the material of the forming object 205, and discharges and cures the liquid droplet of curable resin, which is a resin that is cured according to a predetermined condition, and the like to form each layer configuring the forming object 205. More specifically, the discharging unit 212, for example discharges the liquid droplet according to an instruction of the control unit 218 to repeatedly carry out, over plural times, a layer forming operation of forming a layer of curable resin, and a curing operation of curing the layer of curable resin formed in the layer forming operation. The discharging unit 212 repeatedly carries out such operations to form a plurality of cured curable resin layers in a stacked manner.

For example, an ultraviolet curable resin cured by the irradiation of ultraviolet light is used as the curable resin discharged from the discharging unit 212. In this case, the discharging unit 212 discharges, for example, the ink droplet of ultraviolet curable ink as a liquid droplet to become the material of the forming object 205. In the curing operation, the layer of curable resin is cured by being irradiated with the ultraviolet light from the ultraviolet light source. In this case, the layer of curable resin is an ultraviolet curable ink.

In the three-dimensional object forming device 1e according to the sixth embodiment, the discharging unit 212 discharges the ink droplet of a colored ultraviolet curable ink to color the surface or the interior of the forming object 205, and form the colored forming object 205. The discharging unit 212 forms a support 6 at the periphery of the forming object 205, as shown in FIG. 19, at the time of forming of the forming object 205. The support 6 is a stacked structural object (support layer) for supporting the forming object 205 being formed, and is dissolved and removed by water, and the like after the forming of the forming object 205 is completed. More specific configuration and operation of the discharging unit 212 will be described later in further detail.

The main scanning driving unit 214 is a driving unit for causing the discharging unit 212 to carry out the main scanning operation. When causing the discharging unit 212 to carry out the main scanning operation in the sixth embodiment, this means, for example, causing the ink jet head of the discharging unit 212 to carry out the main scanning operation. The main scanning operation is, for example, an operation of discharging the ink droplet while moving in the main scanning operation (Y direction in the figure) set in advance.

The main scanning driving unit 214 includes a carriage 222 and a guide rail 224. The carriage 222 is a holding portion that holds the discharging unit 212 while facing the forming table 216. In other words, the carriage 222 is moved along the guide rail 224 while holding the discharging unit 212, during the main scanning operation, in which the carriage 222 holds the discharging unit 212, so that the discharging direction of the ink droplet discharged from the discharging unit 212 becomes the direction toward the forming table 216. The guide rail 224 is a rail member for guiding the movement of the carriage 222, and moves the carriage 222 in response to an instruction of the control unit 218 at the time of the main scanning operation.

The movement of the discharging unit 212 at the time of the main scanning operation may be a relative movement with respect to the forming object 205. Thus, in a variant of the configuration of the three-dimensional object forming device 1e, for example, the position of the discharging unit 212 may be fixed, and the forming object 205 side may be moved by moving the forming table 216.

The forming table 216 is a mounting table on which upper surface the forming object 205 being formed is mounted. The forming table 216 has a function of moving the upper surface in an up and down direction (Z direction in the figure), and moves the upper surface in coordination with the advancement in the forming of the forming object 205 in response to the instruction of the control unit 218. A distance (gap) between a surface to be formed in the forming object 205 in the middle of being formed, and the discharging unit 212 thus can be appropriately adjusted. The surface to be formed of the forming object 205 in this case is a surface where the next layer is to be formed by the discharging unit 212. The scanning in the Z direction of moving the forming table 216 up and down with respect to the discharging unit 212 may be carried out by moving the discharging unit 212 side in the Z direction.

The control unit 218 is a device that controls each unit of the three-dimensional object forming device 1e, and includes a CPU (Central Processing Unit) serving as a controller for executing various types of processes, a RAM (Random Access Memory) serving as a memory for storing various types of information, a ROM (Read Only Memory), and the like. The control unit 218 controls the operation for forming the forming object 205 by controlling each unit of the three-dimensional object forming device 1e based on the shape information, the color image information, and the like of the forming object 205 to be formed.

The three-dimensional object forming device 1e may further include various types of configurations necessary for forming, coloring, and the like of the forming object 205. For example, the three-dimensional object forming device 1e may include a sub scan driving unit for causing the discharging unit 212 to carry out the sub scanning operation, and the like. In this case, the sub scanning operation is, for example, an operation of relatively moving the ink jet head in the discharging unit 212 in the sub scanning direction (X direction in the figure) orthogonal to the main scanning direction with respect to the forming object 205 being formed. The sub scan driving unit, for example, causes the discharging unit 212 to carry out the sub scanning operation as necessary such as when forming the forming object 205, in which a length in the sub scanning operation is longer than the forming width of the ink jet head in the discharging unit 212, and the like. More specifically, the sub scan driving unit may be a driving unit for moving the forming table 216 in the sub scanning direction, or may be a driving unit for moving the guide rail 224 in the sub scanning direction with the carriage 222 holding the discharging unit 212.

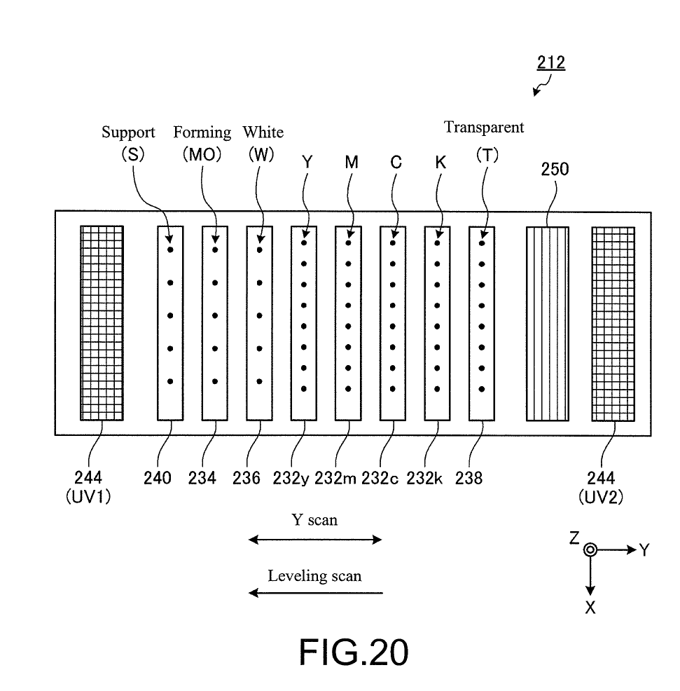

FIG. 20 is an explanatory view in which the discharging unit is seen from the discharging surface side of the ink droplet. The discharging unit 212 includes a plurality of colored ink heads 232y, 32m, 32c, 32k (hereinafter described as plurality of colored ink heads 232y to k), a white ink head 236, a clear ink head 238, a forming material head 234, a support material head 240, a plurality of ultraviolet light sources 244, and a leveling roller unit 250.

The colored ink heads 232y to k, the white ink head 236, the clear ink head 238, and the forming material head 234 are discharging heads, which are discharger that discharge the curable resin liquid droplets in the ink jet method. The colored ink heads 232y to k, the white ink head 236, the clear ink head 238, and the forming material head 234 are ink jet heads that discharge the ink droplets of the ultraviolet curable ink, and are arranged in a line in the main scanning direction (Y direction) with the positions in the sub scanning direction (X direction) aligned.

The colored ink heads 232y to k are ink jet heads each discharging the ink droplet of a colored ink of a color different from each other. The colored ink heads 232y to k can discharge the ink droplet of the ultraviolet curable ink of each color of yellow (Y), magenta (M), cyan (C), and black (K). The white ink head 236 is an ink jet head that discharges the ink droplet of white (W) ultraviolet curable ink.

The clear ink head 238 is an ink jet head that discharges the ink droplet of an ultraviolet curable clear ink. The clear ink is an ink of clear color, which is a transparent color (T), and is a clear and colorless ink. The clear ink is an ink that contains the ultraviolet curable resin and that does not contain a colorant.

The forming material head 234 is an ink jet head that discharges the ink droplet of the ultraviolet curable ink used as the forming material having fluidity for forming the forming object 205. The forming material head 234 can discharge the ink droplet of the forming ink (MO) of a predetermined color. For example, white ink, clear ink, or the like may be used for the forming ink.

The support material head 240 is an ink jet head that discharges the ink droplet including a material (S) of the support 6 (see FIG. 19). A water soluble material that can be dissolved in water after the forming of the forming object 205 is preferably used for the material of the support 6 in this case. The known material for the support 6 may be appropriately used for the material of the support 6. The support material head 240 is arranged lined in the main scanning direction with the positions in the sub scanning direction aligned with respect to the colored ink heads 232y to k, the white ink head 236, the clear ink head 238, and the forming material head 234.

For example, a known ink jet head can be suitably used for the colored ink heads 232y to k, the white ink head 236, the clear ink head 238, and the forming material head 234, and the support material head 240. Such ink jet heads include a nozzle row, in which a plurality of nozzles are arranged in the sub scanning direction, on a surface facing the forming table 216 (see FIG. 18). In this case, the arrangement direction of the nozzle row in the respective ink jet head is the same, and the nozzle rows are parallel to each other. At the time of the main scanning operation, the ink droplet is discharged in the Z direction while moving in the main scanning direction orthogonal to the direction in which the nozzles are arranged.

The plurality of ultraviolet light sources 244 are light sources of the ultraviolet lights that cure the ultraviolet curable ink, where an ultraviolet LED (Light Emitting Diode), a metal halide lamp, a mercury lamp, and the like can be used. Each of the plurality of ultraviolet light sources 244 is arranged on one end side and the other end side in the main scanning direction in the discharging unit 212 so as to have the colored ink heads 232y to k, the white ink head 236, the clear ink head 238, and the forming material head 234, and the support material head 240 in between. In the three-dimensional object forming device 1e according to the sixth embodiment, UV1 and UV2 are provided as the ultraviolet light sources 244, where the UV1 is arranged on one end side of the discharging unit 212 in the main scanning direction (Y direction), and the UV2 is arranged on the other end side of the discharging unit 212 in the main scanning direction (Y direction).

The leveling roller unit 250 has a configuration for leveling the layer of ultraviolet curable ink formed during the forming of the forming object 205. The leveling roller unit 250 is arranged between the arrangement of the colored ink heads 232y to k, the white ink head 236, the clear ink head 238, the forming material head 234, and the support material head 240, and the UV2, which is the ultraviolet light source 244 arranged on the other end side of the discharging unit 212. The leveling roller units 250 are arranged lined in the main scanning direction with the positions in the sub scanning direction aligned with respect to the arrangement of the colored ink heads 232y to k, the white ink head 236, the clear ink head 238, the forming material head 234, and the support material head 240. The leveling roller unit 250 is arranged in the discharging unit so as to be movable in the up and down direction with respect to the discharging unit 212.

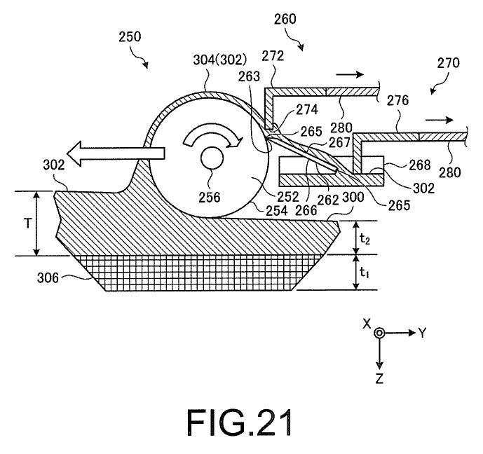

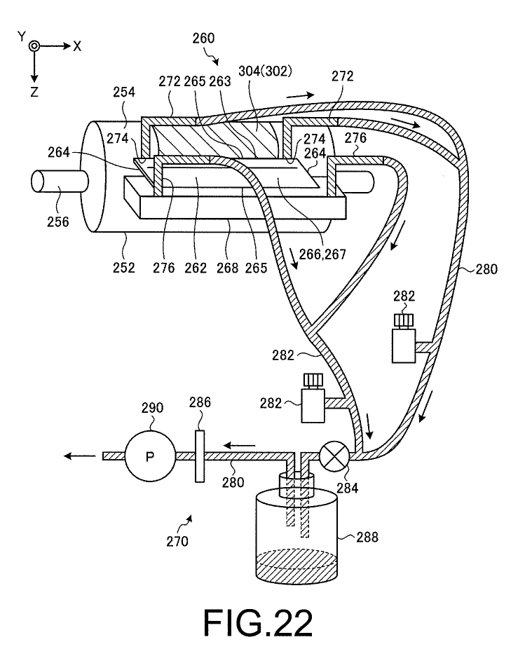

FIG. 21 is a detailed view of the leveling roller unit shown in FIG. 18. FIG. 22 is an explanatory view showing a configuration of the leveling roller unit and an excess forming material collecting mechanism shown in FIG. 21. The leveling roller unit 250 includes a roller portion 252 arranged in a freely rotating manner for scraping off an excess forming material 302 in a forming material 300 in a flowable state, a rotating shaft 56 for supporting the roller portion 252 in a freely rotating manner, and an excess forming material collecting mechanism 260 for collecting the excess forming material 302. The roller portion 252 is formed to a circular column shape, where an axial direction is arranged in a direction extending in the sub scanning direction (X direction). The functions demanded on the surface of the roller portion 252 include wetting property with respect to the excess forming material 302, rotation precision, and lifespan, and thus a metal roller with an abrasion resistant coating such as chromium plating performed on the surface 254 is preferred. The rotating shaft 56 supports the roller portion 252 in a freely rotating manner with a center axis of the circular column, which is the shape of the roller portion 252, as the center, and thus the rotating shaft 56 supports the roller portion 252 in a direction extending in the sub scanning direction.

The excess forming material collecting mechanism 260 includes a blade 262 and a suction device 270. The blade 262 includes a scrape-off part 263 arranged at one end 65 of the ends 65 on both sides of the blade 262 in the main scanning direction to scrape off the excess forming material 302 on the surface 254 of the roller portion 252, and a flow-down part 266 that flows down the excess forming material 302 scraped off by the scrape-off part 263, and is provided as a remover for removing an attached forming material 304, which is the excess forming material 302, attached to the surface 254 of the roller portion 252, from the roller portion 252. The scrape-off part 263 of the blade 262 is extended along the axial direction of the roller portion 252, and is arranged in contact with or in proximity to the surface 254 of the roller portion 252. The flow-down part 266 has one end in the main scanning direction connected to the scrape-off part 263, and the other end including an inclined plane 67 configured so as to be on a vertically lower side than the one end. The blade 262 has the ends 264 on both sides of the blade 262 in the sub scanning direction formed as open ends, and removes the attached forming material 304 from the roller portion 252 by moving the attached forming material 304 toward the end 65 on the side opposite to the end 65, on which side the scrape-off part 263 is located, along the inclined plane 67 of the flow-down part 266 with the surface 254 of the roller portion 252 and the scrape-off part 263 brought into contact or in proximity with each other along the surface in the axial direction of the roller portion 252.

The blade 262 is formed to a rectangular plate shape in which the width in the axial direction of the roller portion 252 is shorter than the length of the roller portion 252, where the end 65 located on the roller portion 252 side is arranged in contact with or in proximity to the surface 254 of the roller portion 252 so that the end 65 is arranged as the scrape-off part 263. Specifically, the blade 262 has one side (end 65) of the rectangle, which is the shape of the blade 262, arranged in a direction along the axial direction of the roller portion 252, which side (blade edge) is brought into contact with the surface 254 of the roller portion 252. An abrasion resistant steel material, as well as resin such as high molecular polyethylene, polyacetal, and the like that is less likely to get wet in the forming material are suited for the material of the blade 262. Even when the surface 254 of the roller portion 252 and the scrape-off part 263 are not brought into contact, the surface 254 of the roller portion 252 and the scrape-off part 263 are to be brought in proximity to each other to an extent the excess forming material 302 on the surface 254 of the roller portion 252 can be scraped off if, for example, the viscosity of the excess forming material 302 is high.

The width in the axial direction of the roller portion 252 of the roller portion 252 and the blade 262 is greater than the width in the same direction of a region where the attached forming material 304 attaches to the surface 254 of the roller portion 252. Thus, the width of the blade 262 in the axial direction of the roller portion 252 is greater than the width of the region where the attached forming material 304 attaches to the surface 254 of the roller portion 252, and smaller than the width of the roller portion 252 in the same direction.

The position in the axial direction of the roller portion 252 of the blade 262 that makes contact with the surface 254 of the roller portion 252 is such that the center in the axial direction of the roller portion 252 and the center of the side to be brought into contact with the blade 262 are substantially the same. The scrape-off part 263 of the blade 262 is located on the upper half side of the roller portion 252 when the roller portion 252 is seen in the axial direction. The flow-down part 266 of the blade 262 is arranged with the inclined plane 67 inclined in a downward direction as the flow-down part 266 separates from the scrape-off part 263. With the blade 262 configured in the above manner, the attached forming material 304 is removed from the roller portion 252 by being moved vertically downward.

The suction device 270 is arranged as a fluid mover for moving the fluid so as to suppress the excess forming material 302 at the flow-down part 266 scraped off by the scrape-off part 263 of the blade 262 from flowing toward both sides in the extending direction of the blade 262. Specifically, the suction device 270 is configured to be able to suppress the excess forming material 302 from flowing beyond the positions of the ends 264 on both sides in the extending direction of the blade 262 by suctioning the excess forming material 302, which is a part of the forming material 300 in a fluid state before being cured, and the air.

The suction device 270 includes a storing part 268 for storing the excess forming material 302 removed from the roller portion 252 by the blade 262, and a waste nozzle 276, which is a waste suction mechanism, for suctioning the excess forming material 302 stored in the storing part 268. The storing part 268 is arranged on the side facing the side configuring the scrape-off part 263 in the blade 262. In other words, the storing part 268 is arranged on the lower end side in the blade 262 arranged inclined in the up and down direction. Thus, the storing part 268 arranged on the lower end side of the blade 262 is formed to a container shape, in which the liquid can be stored inside, and is arranged so that an opening side of the container is directed upward. The storing part 268 has the width in the sub scanning direction (X direction) formed greater than the width of the blade 262 in the same direction, where the lower end side of the blade 262 is entered into the interior of the storing part 268 from the upper side with respect to the opening of the storing part 268.

The waste nozzle 276 is formed to a tubular shape, so that the excess forming material 302 can pass therein. Two waste nozzles 276 are arranged near both ends of the storing part 268 in the sub scanning direction (X direction), which two waste nozzles 276 are both arranged such that suction ports are entered into the storing part 268. The waste nozzle 276 thus can suction the excess forming material 302 stored in the storing part 268.

The suction device 270 includes a suction nozzle 272, which is a flow tube, for flowing gas or liquid. The suction nozzle 272 is formed to a tubular shape, so that gas and liquid can pass therethrough. Two suction nozzles 272 formed in such manner are arranged near both ends 264 of the blade 262 in the sub scanning direction (X direction), which two suction nozzles 272 are both arranged in a non-contacting state (see FIG. 21) with respect to the blade 262 and the roller portion 252 on the upper surface side of the blade 262. The two suction nozzles 272 arranged in such manner are both arranged such that the opening 274 located on one end side faces the blade 262 at the positions of the ends 264 of the blade 262. Specifically, the two suction nozzles 272 are arranged with the opening 274 facing the blade 262 at a position near the position where the scrape-off part 263 of the blade 262 is located.

Thus, the suction device 270 including the suction nozzle 272 includes a pump 290, which is a suction generating source, for suctioning fluid so as to suction the excess forming material 302 from the opening 274. A known pump such as a diaphragm pump, a tube pump, and the like, for example, is used for the pump 290. A hose-like fluid flow path 280, inside of which the fluid can flow through, is connected to an end on the opening 274 side of the suction nozzle 272, and the pump 290 is also connected to the fluid flow path 280. Thus, the suction nozzle 272 can suction the excess forming material 302 from the opening 274 when a negative pressure generated by the pump 290 is transmitted to the suction nozzle 272 through the fluid flow path 280.

More specifically describing the fluid flow path 280, the fluid flow path 280 is connected to each of the two suction nozzles 272, where the two fluid flow paths 280 connected to the two suction nozzles 272 are assembled to one flow path. Thus, at a portion where the fluid flow paths 280 connected to the two suction nozzles 272 are assembled to one flow path, a speed controller 82, which is a pressure adjusting means, for adjusting the pressure in the fluid flow path 280 is arranged. The speed controller 82 can adjust the pressure in the fluid flow path 280 by adjusting the flow amount of air on the inner side and the outer side of the fluid flow path 280.

The fluid flow path 280 is also connected to each of the two waste nozzles 276, where the two fluid flow paths 280 connected to the two waste nozzles 276 are also assembled to one flow path. Thus, at a portion where the fluid flow paths 280 connected to the two waste nozzles 276 are assembled to one flow path, the speed controller 82 for adjusting the pressure in the fluid flow paths 280 is arranged.

Furthermore, the fluid flow paths 280 on the suction nozzles 272 side and the fluid flow paths 280 on the waste nozzles 276 side are further assembled to one, at which portion, an electromagnetic valve 84, which is an opening/closing means, for carrying out opening/closing of the fluid flow paths 280 is arranged. The electromagnetic valve 84 carries out the opening/closing of the fluid flow path 280 to enable the fluid to flow through the fluid flow path 280 or to shield the flow of fluid.

Thus, a waste bottle 288, which is a waste tank, for storing the excess forming material 302 suctioned from the opening 274 of the suction nozzle 272 is connected to a portion where the fluid flow paths 280 on the suction nozzles 272 side and the fluid flow paths 280 on the waste nozzles 276 side are assembled to one and the electromagnetic valve 84 is arranged thereat. In other words, the waste bottle 288 is connected to the suction nozzles 272 and the waste nozzles 276 by way of the fluid flow paths 280.

The fluid flow path 280 connected to the pump 290 is also connected to the waste bottle 288. The pump 290 is able to suction and discharge air, where the suctioning side of the pump 290 is connected to the waste bottle 288 by way of the fluid flow path 280. At the time of suctioning, the pump 290 can suction the air of after the excess forming material 302 and the air are separated in the waste bottle 288 from the waste bottle 288. An air filter 86 for removing impurities in the air is arranged on the fluid flow path 280 for flowing the air in the waste bottle 288 to the pump 290.

The pump 290 is thus connected to the waste bottle 288, to which the fluid flow paths 280 on the suction nozzles 272 side and the fluid flow paths 280 on the waste nozzles 276 side are connected, whereby the suction force generated in the pump 290 can be transmitted not only to the suction nozzles 272 but also to the waste nozzles 276 by way of the fluid flow paths 280. The waste nozzle 276 thus can suction the excess forming material 302 stored in the storing part 268 with the suction force generated in the pump 290.

The three-dimensional object forming device 1e according to the sixth embodiment has the configuration described above, and now, the operations thereof will be described below. When forming the forming object 205 with the three-dimensional object forming device 1e, the data of the forming object 205 is acquired with the control unit 218 from an external device (not shown) such as a personal computer, and the discharging unit 212 is controlled by the control unit 218 based on such data, whereby the forming object 205 is formed on the forming table 216. The data to use for the forming of the forming object 205 is data in which the target forming object 205 is divided into great numbers in the Z direction to be handled as a great number of layers, and the position where the ink droplet is to be discharged is defined for every type of ink droplet in the main scanning direction and the sub scanning direction for each layer. When carrying out the forming of the forming object 205 by the discharging unit 212, the forming is carried out while repeating the leveling of each layer with the leveling roller unit 250 before curing the ink droplet discharged to each layer while discharging the ink droplet from each ink jet head based on the data and forming the layers in the Z direction.

Specifically, when discharging the ink droplet from each ink jet head of the discharging unit 212, the control unit 218 controls the main scanning driving unit 214 to move the carriage 222 in the main scanning direction (Y direction) along the guide rail 224, thus causing the discharging unit 212 to discharge while moving in the main scanning direction. Each ink jet head includes the nozzle row in which the plurality of nozzles are arranged in the sub scanning direction, so that the ink droplet is discharged to the position where the ink droplet is to be discharged in the main scanning direction and the sub scanning direction by discharging the ink droplet from the nozzle located at the position in the sub scanning direction defined in the data at the position in the main scanning direction defined in the data for forming while moving the discharging unit 212.

The colored ink heads 232y to k, the white ink head 236, the clear ink head 238, the forming material head 234, and the support material head 240 are arranged as the ink jet heads of the discharging unit 212, but the colored ink heads 232y to k discharge the colored ink droplets to use for the coloring of the forming object 205. The data for forming includes data related to the coloring of the forming object 205, and the colored ink heads 232y to k discharge the colored ink droplets based on such data.

The white ink head 236 discharges the white ink droplet to the inner side of the portion where the colored inks discharged from the colored ink heads 232y to k are used in the forming object 205. A visible recognition is thus possible with high light emitting property by the subtractive color mixing method similar to the two-dimensional printing on a white paper.

The clear ink head 238 discharges a transparent ink droplet to an outer side portion of the colored inks to become a surface portion in the forming object 205 after the forming to, for example, give a luster to the outermost surface of the forming object 205 and ensure aesthetic appearance.

The forming material head 234 discharges the ink droplet to use for the forming material that becomes the basis for forming the forming object 205. The forming material head 234 discharges the ink droplet to use for the forming material based on the data for forming to form a shape of the forming object 205 in the respective layers for each layer. In this case, the ink droplets of each color are discharged from the colored ink heads 232y to k, the white ink head 236, and the clear ink head 238, so that each layer formed by the forming material is formed with a color based on the data for forming.

The support material head 240 discharges the ink droplet to become the material of the support 6 to a portion other than the portion for forming the forming object 205 in each layer to form the forming object 205 at high precision irrespective of the shape of the forming object 205. The forming object 205 thus has the shape maintained by the ink droplet to become the material of the support 6 even before the ink is cured in each layer.

The control unit 218 discharges the ink droplet in the above manner for each layer based on the data for forming while moving the discharging unit 212 in the main scanning direction, and cures the ink by irradiating the ultraviolet light from the ultraviolet light source 244. Accordingly, after forming one layer, the forming table 216 is moved in the Z direction by the thickness of one layer in a direction the forming table 216 separates from the discharging unit 212, and then a next layer is formed with respect to the cured layer so as to overlap the cured layer in the Z direction. The three-dimensional object forming device 1e forms the three-dimensional forming object 205 by repeating the above.

In the discharging unit 212, each layer is formed by the discharged ink while discharging the ink droplet for every ink jet head in the above manner, but the amount of ink droplet discharged from each nozzle of the ink jet head has a variation of about 10%. Thus, in the discharging unit 212, the ink droplet is discharged from each nozzle with the amount of ink droplet increased by greater than or equal to 10%, and the ink before being cured is scraped off with the leveling roller unit 250, so that the thickness of one layer is leveled to the desired thickness.

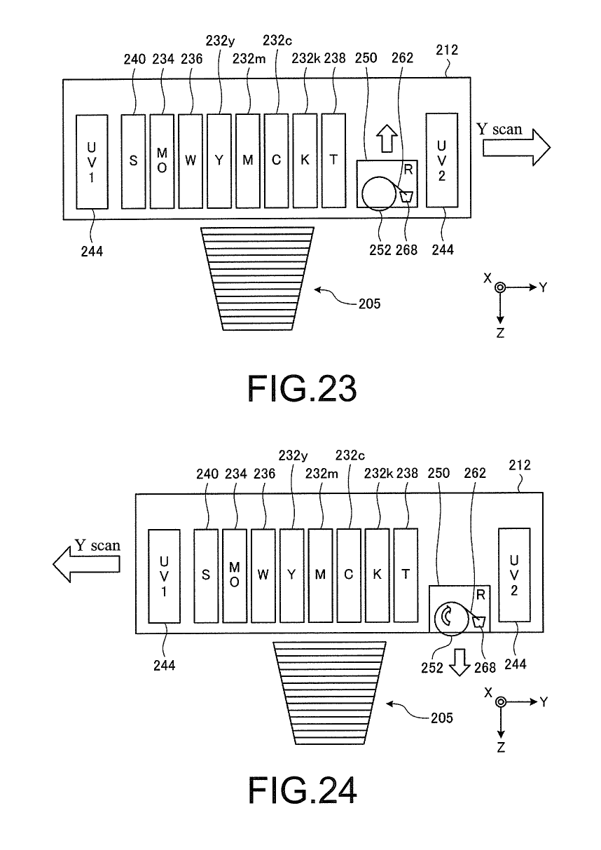

FIG. 23 is an explanatory view showing an operation of the discharging unit in a step of discharging the ink droplet and forming the layers of the forming object. The discharging unit 212 discharges the ink droplet from each ink jet head when being moved in one direction in the main scanning direction (Y direction). In this case, the control unit 218 is evacuated by moving the leveling roller unit 250 to the upper side, so that the leveling roller unit 250 does not make contact with the forming object 205 being formed.

FIG. 24 is an explanatory view showing an operation of the discharging unit in a step of leveling a layer with the leveling roller unit. The discharging unit 212 discharges the ink droplet while being moved in one direction of the main scanning direction, and the control unit 218 carries out the leveling of the layer before the ink is cured. The control unit 218 moves the leveling roller unit 250 toward the lower side (Z direction) to carry out the leveling.

After the leveling roller unit 250 is moved toward the lower side, the vicinity of the lower end portion of the roller portion 252 rotates the roller portion 252 in a rotating direction of a direction of moving toward a side the colored ink heads 232y to k, and the like are arranged. The control unit 218 moves the discharging unit 212 in the opposite direction in FIG. 23 while rotating the roller portion 252 of the leveling roller unit 250 in the above manner.

When the roller portion 252 of the leveling roller unit 250 is brought into contact with the layer before the ink is cured by moving the discharging unit 212 in the main scanning direction, the leveling roller unit 250 scrapes off the ink before the curing with the rotating roller portion 252 (see FIG. 21). In place of a method of moving the leveling roller unit 250 up and down as in FIGS. 23 and 24, a lower end of the periphery of the roller portion 252 may be fixed to a lowermost end in the discharging unit 212, and the forming table 216 may be moved (Z scanned) up and down.

Specifically, the roller portion 252 scrapes the excess forming material 302 corresponding to (T−t₂) of the forming material 300 in the flowable state such that a thickness t₂ of the flowable forming material 300 becomes the same thickness as a thickness t₁ of the cured forming material 306, which is the forming material 300 in which the curing is completed by the ultraviolet irradiation (see FIG. 21). The roller portion 252 is thus moved in the main scanning direction while rotating with the rotating shaft 56 as the center at a height the lower end portion is at the position of the upper surface of the thickness t₂ of the target forming material 300. The excess forming material 302 thereby attaches to the surface 254 of the roller portion 252, and is scraped off one after the other. The control unit 218 cures the forming material 300, in which the excess forming material 302 is scraped off with the roller portion 252 and a desired thickness is obtained, with the ultraviolet light irradiated from the ultraviolet light source 244 to cure the forming material 300. Accordingly, in the first scanning, the ink droplet is discharged from each ink jet head but the leveling is not carried out (see FIG. 23), and in the next scanning, the ink droplet is discharged from each ink jet head and the leveling is carried out (see FIG. 24). The two scanning may be carried out while forming one layer, or may be carried out while forming two layers.

The attached forming material 304, which is the excess forming material 302 attached to the surface 254 of the roller portion 252, is moved in the rotating direction of the roller portion 252 accompanying the rotation of the roller portion 252, and scraped off with the scrape-off part 263 of the blade 252, and hence is removed from the roller portion 252 with the blade 62.

The rotating direction of the roller portion 252 is the rotating direction in a direction the surface 254 of the roller portion 252 is rotated from the upper side toward the lower side at a portion where the scrape-off part 263 of the blade 262 is located, so that the attached forming material 304 removed by the blade 262 is placed on the upper surface of the blade 262. The attached forming material 304 is thereby placed on the upper surface of the blade 262 located on the back side in the rotating direction of the roller portion 252.

The blade 262 has the flow-down part 266 inclined in the downward direction as it separates away from the roller portion 252. Thus, the excess forming material 302 on the upper surface of the blade 262 removed from the surface 254 of the roller portion 252 flows in the downward direction along the inclined plane 67 of the flow-down part 266 by its own weight. The excess forming material 302 flowing toward the lower side at the upper surface of the blade 262 flows to the lower end of the blade 262, drops off from the blade 262, and flows into the storing part 268 disposed on the lower end side of the blade 262. The storing part 268 stores the excess forming material 302 flowing along the blade 262 in the above manner.

The attached forming material 304 attached to the surface 254 of the roller portion 252 is moved one after the other in the direction the scrape-off part 263 of the blade 262 is located accompanying the rotation of the roller portion 252. If the scraping thickness or area is large, the flow speed at which the excess forming material 302 flows on the blade 262 from the surface 254 of the roller portion 252 sometimes becomes faster than the flow speed at which the excess forming material 302 flows toward the lower end of the blade 262 by its own weight. In this case, the flow of the excess forming material 302 on the blade 262 toward the lower end side of the blade 262 becomes difficult, thus forming a rise along the scrape-off part 263, and flowing in the horizontal direction. The flowed excess forming material 302 is suctioned from the opening 274 of the suction nozzle 272 disposed near both ends 264 of the blade 262 (see FIG. 22).

The operation of the suction device 270 including the suction nozzle 272 will now be described. When the power of the device is turned ON, the pump 290 is driven with the electromagnetic valve 84 closed. When the pump 290 is driven, the waste bottle 288 connected to the pump 290 is depressurized. After the pressure is lowered to a predetermined pressure, the pump 290 is stopped based on a detection signal of a pressure sensor (not shown) to be in a standby state. Thereafter, the atmosphere pressure in the waste bottle 288 is maintained at a constant pressure on a constant basis by turning ON/OFF the pump 290 based on the detection signal of the pressure sensor (not shown) described above. When activating the leveling roller unit 250, the suction force is applied on the fluid flow path 280 by opening the electromagnetic valve 84. The suction force is applied via the waste bottle 288 on the fluid flow path 280 on the side on which the suction nozzle 272 is connected. The suction nozzle 272 has the opening 274 facing the blade 262, so that the excess forming material 302 flowing on the blade 262 in a direction of the end 264 of the blade 262 is suctioned. In other words, since an airflow in which the air at the periphery of the suction nozzle 272 enters the suction nozzle 272 from the opening 274 is generated by the suction force supplied from the pump 290 near the opening 274 of the suction nozzle 272, the excess forming material 302 enters the suction nozzle 272 from the opening 274 along with the air by the airflow.

The excess forming material 302 suctioned from the opening 274 of the suction nozzle 272 flows in the direction of the waste bottle 288 through the fluid flow path 280, and enters the waste bottle 288. In the waste bottle 288, the fluid that flowed into the waste bottle 288 by the suction force generated in the pump 290 is separated into the excess forming material 302 and the air, and the excess forming material 302 is accumulated in the waste bottle 288. After a predetermined amount of waste is accumulated, the waste bottle 288 is detached to discard the waste inside, and then set again to be used.

The air separated from the excess forming material 302 in the waste bottle 288 flows to the fluid flow path 280 on the pump 290 side of the fluid flow paths 280 connected to the waste bottle 288. The air that flowed to the fluid flow path 280 on the pump 290 side is flowed into the pump 290 after the impurities such as ink are filtered by the air filter 86 arranged on the fluid flow path 280, and then discharged toward the discharging side of the pump 290. The excess forming material 302 moving on the blade 262 in the direction of the end 264 of the blade 262 along the scrape-off part 263 is suctioned by the suction device 270 in the above manner so as to be removed from the blade 262 and accumulated in the waste bottle 288.

The waste nozzle 276 arranged in the storing part 268 is connected to the fluid flow path 280 of the suction device 270, so that the suction force generated in the pump 290 is also applied on the waste nozzle 276. The waste nozzle 276 suctions the excess forming material 302 stored in the storing part 268 by such suction force. The excess forming material 302 suctioned with the waste nozzle 276 is flowed into the waste bottle 288 through the fluid flow path 280 and accumulated in the waste bottle 288, similar to the excess forming material 302 suctioned with the suction nozzle 272. The excess forming material 302 stored in the storing part 268 is thereby removed from the storing part 268.

Thus, the suction device 270 that removes the excess forming material 302 from the blade 262 and the storing part 268 with the suction force generated in the pump 290 includes the speed controller 82 on each of the flow path on the suction nozzle 272 side and the flow path on the waste nozzle 276 side of the fluid flow path 280. Since the speed controller 82 can adjust the pressure in the fluid flow path 280, the suction force can be independently adjusted for the suction nozzle 272 side and the waste nozzle 276 side by adjusting the speed controller 82 when suctioning the excess forming material 302 from the suction nozzle 272 and the waste nozzle 276.

The pump 290 of the suction device 270 is ON/OF controlled on a constant basis to generate a constant suction force when forming the forming object 205 with the three-dimensional forming device 1e. The electromagnetic valve 84 is closed when the excess forming material 302 does not need to be suctioned with the suction nozzle 272 and the waste nozzle 276 such as immediately after the start of forming of the forming object 205. The suction force generated in the pump 290 is thus not applied to the suction nozzle 272 side and the waste nozzle 276 side, whereby the nozzles do not suction the excess forming material 302.

The three-dimensional object forming device 1e according to the sixth embodiment described above generates the airflow that can suppress the excess forming material 302 on the flow-down part 266 scraped off with the scrape-off part 263 of the blade 262 from moving toward both ends 264 in the extending direction of the blade 262 with the suction device 270, so that the excess forming material 302 on the blade 262 removed from the roller portion 252 can be suppressed from flowing to both ends 264 of the blade 262. Consequently, the excess forming material 302 can be suppressed from dropping onto the forming object 205 being stacked.

Since the suction device 270 is not brought into contact with respect to the blade 262 and the roller portion 252, the excess forming material 302 can be prevented from being cured at a contacted portion as in a case where a member for controlling the movement of the excess forming material 302 is disposed in contact with the blade 262 and the roller portion 252. The replacement of parts caused by the curing of the excess forming material 302 thus becomes unnecessary. The suction device 270 can also alleviate the rotation load of the roller portion 252 as the suction device is not brought into contact with respect to the rotating roller portion 252. As a result, the maintenance property can be enhanced.

The opening 274 of the suction nozzle 272 is disposed to face the blade 262 at the positions of both ends 264 of the blade 262, so that the flow of the excess forming material 302 moving toward both ends 264 in the extending direction of the blade 262 can be effectively suppressed. As a result, the excess forming material 302 can be more reliably suppressed from dropping onto the forming object 205 being stacked, and the sealing member and the pad for stopping the flow become unnecessary.

The excess forming material 302 can be more reliably suctioned from the suction nozzle 272 by arranging the pump 290 for suctioning the fluid so as to suction the excess forming material 302 from the opening 274 of the suction nozzle 272. Consequently, the excess forming material 302 can be more reliably suppressed from dropping onto the forming object 205 being stacked.

Furthermore, since the waste nozzle 276 suctions the excess forming material 302 stored in the storing part 268 with the suction force generated in the pump 290 that applies the suction force on the suction nozzle 272, both the excess forming material 302 on the blade 262 and the excess forming material 302 in the storing part 268 can be suctioned with one pump 290. Therefore, even if two systems for suctioning the excess forming material 302 are provided, the excess forming material can be suctioned with one pump 290 without arranging the pump 290 in each system. As a result, the number of components can be suppressed and the manufacturing cost can be reduced.

The three-dimensional object forming method according to the sixth embodiment described above generates the airflow that can suppress the excess forming material 302 on the flow-down part 266 scraped off with the scrape-off part 263 of the blade 262 from moving toward both ends 264 in the extending direction of the blade 262 with the suction device 270, so that the excess forming material 302 on the blade 262 removed from the roller portion 252 can be suppressed from flowing to both ends 264 of the blade 262. Consequently, the excess forming material 302 can be suppressed from dropping onto the forming object 205 being stacked.

### Seventh Embodiment

The three-dimensional object forming device 1e according to the seventh embodiment has a configuration substantially similar to the three-dimensional object forming device 1e according to the sixth embodiment, but has a characteristic in that the excess forming material 302 on the blade 262 is removed by blowing air. Other configurations are similar to the sixth embodiment, and hence the description thereof will be omitted and the same reference numerals are denoted thereon.

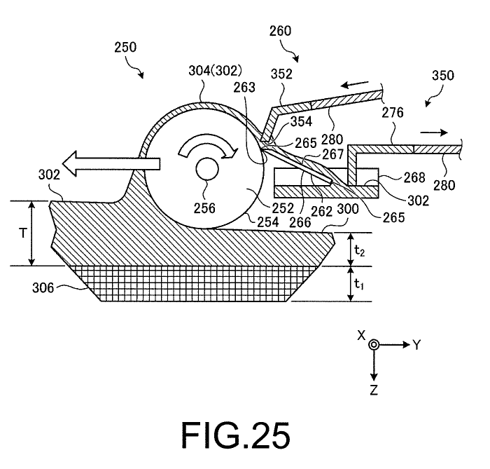

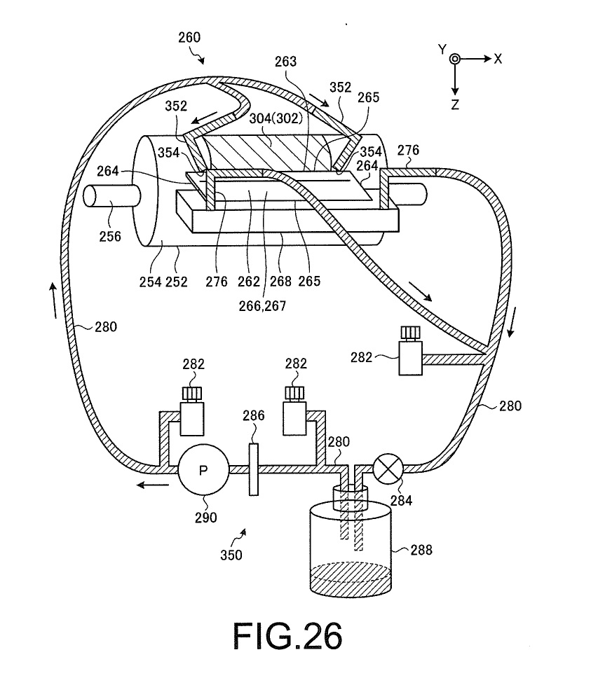

FIG. 25 is a detailed view of the leveling roller unit in the three-dimensional object forming device according to the seventh embodiment. FIG. 26 is an explanatory view showing a configuration of the leveling roller unit and the excess forming material collecting mechanism shown in FIG. 25. In the three-dimensional object forming device 1e according to the seventh embodiment, the leveling roller unit 250 includes the roller portion 252, the rotating shaft 56, and the excess forming material collecting mechanism 260, similar to the leveling roller unit 250 in the three-dimensional object forming device 1e according to the sixth embodiment. The excess forming material collecting mechanism 260 includes a suction/blow-out device 350 as a fluid mover, as opposed to the three-dimensional object forming device 1e according to the sixth embodiment.

The suction/blow-out device 350 includes a blow-out nozzle 352, which is a flow tube for flowing gas or liquid, in the vicinity of the scrape-off part 263 of the blade 262. The blow-out nozzle 352 is formed to a tubular shape, so that gas and liquid can pass therethrough. Two blow-out nozzles 352 formed in such manner are arranged near both ends 264 of the blade 262 in the sub scanning direction (X direction), which two blow-out nozzles 352 are both arranged in a non-contacting state with respect to the blade 262 and the roller portion 252 on the upper surface side of the blade 262. The two blow-out nozzles 352 arranged in such manner are both arranged such that an opening 354 located on one end side faces the blade 262 at the positions of the ends 264 of the blade 262.

Specifically, the two blow-out nozzles 352 are arranged with the opening 354 facing the blade 262 at a position near the scrape-off part 263. The two blow-out nozzles 352 both include the opening 354 so that a separating distance between the opening 354 and the blade 262 is such that the distance on the end 264 side of the blade 262 becomes shorter than the distance on the central side. That is, the blow-out nozzle 352 is arranged inclined with respect to the blade 262 in a direction the opening 354 is directed toward the central side of the blade 262 in the sub scanning direction (X direction).

The suction/blow-out device 350 also includes the pump 290, and such pump 290 is also arranged as an airflow generating source for generating an airflow so that the gas is blown toward the excess forming material 302 on the blade 262 from the opening 354 of the blow-out nozzle 352. Specifically, the fluid flow path 280 connected to the suction side of the pump 290 is connected to two waste nozzles 276 by way of the waste bottle 288.

The discharging side of the pump 290 is connected to two blow-out nozzles 352 by way of the fluid flow path 280. The fluid flow path 280 connected to the blow-out nozzle 352 is such that one fluid flow path 280 connected to the pump 290 is branched into two, and connected to the two blow-out nozzles 352. The speed controller 82 is arranged at one portion closer to the pump 290 in the fluid flow path 280 connected to the blow-out nozzle 352. The speed controller 82 is also arranged on the fluid flow path 280 connected to the suction side of the pump 290 and located between the pump 290 and the waste bottle 288.

The three-dimensional object forming device 1e according to the seventh embodiment has the configuration described above, and now, the operations thereof will be described below. In activating the three-dimensional object forming device 1e to form the forming object 205, the attached forming material 304 attached to the surface 254 of the roller portion 252 is removed by the blade 262 when the excess forming material 302 is scraped off with the leveling roller unit 250. The excess forming material 302 removed by the blade 262 is flowed on the blade 262 and stored in the storing part 268. The excess forming material 302 stored in the storing part 268 is suctioned by the waste nozzle 276 with the suction force generated in the pump 290, and accumulated in the waste bottle 288. Some excess forming material 302 on the flow-down part 266 of the blade 262 moves in the direction of both ends 264 in the extending direction of the blade 262 along the scrape-off part 263.

In the three-dimensional object forming device 1e according to the seventh embodiment, the discharging side of the pump 290 is connected to the blow-out nozzle 352 by way of the fluid flow path 280. Thus, the air discharged from the pump 290 at the time of the activation of the pump 290 is flowed to the blow-out nozzle 352 through the fluid flow path 280, and blown out from the opening 354 of the blow-out nozzle 352. The blow-out nozzle 352 is arranged inclined in a direction the opening 354 is directed toward the central side of the blade 262 in the sub scanning direction (X direction), so that the air blown out from the opening 354 is blown out toward the central direction of the blade 262 in the sub scanning direction. A blow-out angle may be in a direction the excess forming material 302 lowers along the inclination of the inclined plane 267 of the flow-down part 266 of the blade 262 as described above.

Thus, the air blown out toward the middle of the blade 262 in the sub scanning direction is also blown against the excess forming material 302 moving in the direction of both ends 264 in the extending direction of the blade 262 on the flow-down part 266 of the blade 262. The excess forming material 302, against which the air is blown, is thereby pushed by the air and moved toward the central side of the blade 262 in the extending direction of the blade 262. In other words, the excess forming material 302 attempting to flow in the direction of both ends 264 of the blade 262 in the sub scanning direction is turned back by the air blown out from the opening 354 of the blow-out nozzle 352, thus moving in the central direction of the blade 262 in the sub scanning direction. The excess forming material 302 moved to the middle of the blade 262 is moved in the lower end direction of the blade 262 along the inclined plane 67 of the flow-down part 266 by its own weight and stored in the storing part 268, and then suctioned by the waste nozzle 276 and accumulated in the waste bottle 288.

The three-dimensional object forming device 1e according to the seventh embodiment described above has the opening arranged so that the separating distance of the opening 354 of the blow-out nozzle 352 and the blade 262 is such that the distance on the end 264 side is shorter than that on the central side of the blade 262, and blows the air toward the excess forming material 302 from the opening 354, so that the excess forming material 302 can be pushed back in the direction opposite to the direction the excess forming material 302 attempts to move. As a result, the excess forming material 302 on the flow-down part 266 of the blade 262 removed from the roller portion 252 can be suppressed from flowing to the ends 264 in the extending direction of the blade 262, and the excess forming material 302 can be suppressed from dropping on the forming object 205 being stacked.

In the two embodiments described above, two suction nozzles 272 and two waste nozzles 276 have been shown, but the number of nozzles may be respectively increased so as to supplement the two. A cross-sectional shape of the nozzle may be a circle, an oval, a rectangle, and the like, and the distal end portion may be cut at a right angle or may be cut diagonally with respect to the length direction. Furthermore, a filter for preventing external dust from entering may be attached to the distal end of the respective suction nozzle.

[Variant]

In the first embodiment, the leveling roller 61 is moved in the Z axis direction and in the second embodiment, the forming table 8 is moved in the Z axis direction to carry out the inclination adjustment, but these are not the sole cases.

For example, the three-dimensional object forming device according to one aspect of the disclosure may include the micrometer 62, the shaft portion 65, the screw portion 162 and the shaft portion 165 for an adjustment unit. In other words, a configuration in which the leveling roller 61 and the forming table 8 are movable in the Z axis direction may be adopted for the inclination adjustment.

In the third to fifth embodiments, the control of adjusting the relative movement amount in the Z axis direction and relatively moving the forming table 8 and the leveling roller 61 in the Z axis direction so as to adjust the inclination of the leveling roller 61 with respect to the trajectory of the forming table 8 with the relative movement of the leveling roller 61 and the forming table 8 in the X axis direction is carried out with the scanning/driving control section 153, 53a, or 53b. However, such control may not be automatically carried out by the relevant control section, and may be manually carried out.

[Implementation Example by Software]

A control block (particularly discharging control section 51, curing control section 52, and scanning/driving control section 53 of control unit 50) of the three-dimensional object forming device 1, 1a may be realized with a logic circuit (hardware) formed on an integrated circuit (IC chip), and the like, or may be realized by software using a CPU (Central Processing Unit).

A control block (particularly discharging control section 51, curing control section 52, scanning/driving control section 153, 53a, 53b, correction value calculator 154, and data acquiring section 55) of the three-dimensional object forming device 1b, 1d, 1d may be realized with a logic circuit (hardware) formed on an integrated circuit (IC chip), and the like, or may be implemented by software using a CPU (Central Processing Unit).

In the latter case, the three-dimensional object forming device 1, 1a, 1b, 1c, and 1d includes the CPU that executes commands of a program, which is software for realizing each function, a ROM (Read Only Memory) or a storage device (which are referred to as “recording medium”) in which the program and various types of data are recorded in a computer (or CPU) readable manner, a RAM (Random Access Memory) for developing the program, and the like. The object of the disclosure is achieved when the computer (or CPU) reads the program from the recording medium and executes the same. A “non-temporary tangible medium”, for example, tape, disc, card, semiconductor memory, programmable logic circuit, and the like can be used for the recording medium. The program may be provided to the computer through an arbitrary transmission medium (communication network, broadcast wave, etc.) that can transmit the program. The disclosure is also realized in a mode of data signal in which the program is embedded in a carrier wave embodied by an electronic transmission.

[Appendant Matter]

As described above, a three-dimensional object forming device 1, 1a includes a forming table 8 on which a forming object 100 is formed by discharging ink, a leveling roller 61 that includes a contacting surface 61a, extending in an X axis direction and being brought into contact with a surface of the ink, and that levels the surface of the ink, and an adjustment unit that adjusts an inclination of the contacting surface 61a of the leveling roller 61 with respect to a trajectory of the forming table 8 seen from the leveling roller 61 when the forming table 8 and the leveling roller 61 are relatively moved in the X axis direction. The adjustment unit includes (i) a micrometer 62 and a shaft portion 65, and/or (ii) a screw portion 162 and a shaft portion 165.

According to the configuration described above, the adjustment unit adjusts the inclination of the contacting surface 61a of the leveling roller 61 with respect to the trajectory of the forming table 8 seen from the leveling roller 61 when the leveling roller 61 and the forming table 8 are relatively moved in the X axis direction.

When forming the three-dimensional object 100 by scanning the leveling roller 61 not only in a Y axis direction (main scanning direction) but also in the X axis direction (sub scanning direction) (i.e., scanning a mechanism for discharging the ink also in the X axis direction), the step differences D1, D2 may form in the X axis direction on the surface of the ink discharged to the forming table 8. Specifically, the step differences D1, D2 tend to form when the trajectory of the forming table 8 is not substantially parallel to the leveling roller 61 but has a predetermined inclination in the X axis direction. The step differences D1, D2 appear in the three-dimensional object 100 as a contour pattern not intended by the manufacturer.

In the three-dimensional object forming device 1, 1a, one of either the forming table 8 or the leveling roller 61 can be moved in the X axis direction so that the step differences D1, D2 do not form to adjust the inclination of the contacting surface 61a of the leveling roller 61.

Thus, the three-dimensional object forming device 1, 1a can prevent unnecessary patterns formed by the step differences D1, D2 from being formed in the three-dimensional object 100, and hence can form the three-dimensional object 100 at a satisfactory precision.

Furthermore, in the three-dimensional object forming device 1, the leveling roller 61 has a rotating shaft extending in the X axis direction, and the adjustment unit adjusts the inclination of the contacting surface 61a of the leveling roller 61 by adjusting the inclination of the leveling roller 61 with respect to a horizontal direction.

According to the configuration described above, the inclination of the contacting surface 61a of the leveling roller 61 can be adjusted by adjusting the inclination of the leveling roller 61 with respect to the horizontal direction.

Furthermore, in the three-dimensional object forming device 1a, the adjustment unit adjusts the inclination of the contacting surface 61a of the leveling roller 61 by adjusting the inclination with respect to the horizontal plane of the trajectory of the scanning of the forming table 8 in the X axis direction with respect to the leveling roller 61.

According to the configuration described above, the inclination of the contacting surface 61a of the leveling roller 61 can be adjusted by adjusting the inclination with respect to the trajectory of the movement of the forming table 8 in the horizontal direction.

Furthermore, in the three-dimensional object forming device 1, the adjustment unit adjusts the inclination of the contacting surface 61a of the leveling roller 61 by having one end side of the rotating shaft of the leveling roller 61 as a supporting point, and moving the other end side in a Z axis direction perpendicular to the X axis direction and the Y axis direction, which is a direction perpendicular to the X axis direction and in which the ink jet head 3 for discharging the ink is scanned.

According to the configuration described above, the leveling roller 61 can be moved so that the inclination of the contacting surface 61a of the leveling roller 61 can be adjusted. Thus, the inclination of the contacting surface 61a of the leveling roller 61 can be easily adjusted while ensuring the forming precision of the three-dimensional object 100.

Furthermore, in the three-dimensional object forming device 1a, the forming table moving mechanism 9 adjusts the inclination of the contacting surface 61a of the leveling roller 61 by having one perpendicular moving mechanism 9a as a supporting point, and moving the other perpendicular moving mechanism 9a in a Z axis direction perpendicular to the X axis direction and the Y axis direction, which is a direction perpendicular to the X axis direction and in which the ink jet head 3 for discharging the ink is scanned.

According to the configuration described above, the forming table 8 can be moved so that the inclination of the contacting surface 61a of the leveling roller 61 can be adjusted. Thus, the inclination of the contacting surface 61a of the leveling roller 61 can be easily adjusted while ensuring the forming precision of the three-dimensional object 100.

Moreover, the three-dimensional object forming device 1, 1a includes a plurality of nozzles 31 for discharging ink, which plurality of nozzles 31 are arranged to extend in the X axis direction.

According to the configuration described above, the ink is discharged from the plurality of nozzles 31 arranged to extend in the X axis direction to form a plurality of layers.

Furthermore, one aspect of an adjustment method according to the disclosure relates to an adjustment method used in a three-dimensional object forming device 1, 1a including a forming table 8 on which a forming object 100 is formed by discharging ink, a leveling roller 61 that includes a contacting surface 61a, extending in an X axis direction and being brought into contact with a surface of the ink, and that levels the surface of the ink, the adjustment method including an adjusting step of adjusting an inclination of the contacting surface 61a of the leveling roller 61 with respect to a trajectory of the forming table 8 seen from the leveling roller 61 when the forming table 8 and the leveling roller 61 are relatively move in the X axis direction.

Thus, similar to the three-dimensional object forming device 1, 1a described above, the one aspect of the adjustment method according to the disclosure can prevent unnecessary patterns formed by the step differences D1, D2 from being formed in the three-dimensional object 100, and hence can form the three-dimensional object 100 at a satisfactory precision.

Furthermore, another aspect of the adjustment method according to the disclosure includes a measuring step of measuring a distance between the forming table 8 and the leveling roller 61, where in the adjusting step, the inclination of the contacting surface 61a of the leveling roller 61 is adjusted based on a measurement result measured in the measuring step.

According to the configuration described above, the inclination of the contacting surface 61a of the leveling roller 61 is adjusted based on the measurement result measured in the measuring step, so that the inclination can be adjusted at a satisfactory precision.

The three-dimensional object forming device 1b, 1c, 1d is a three-dimensional object forming device 1b, 1c, 1d including a forming table 8 on which a three-dimensional object 100 is formed by discharging ink, and a leveled roller 61 that includes a contacting surface 61a, extending in an X axis direction and being brought into contact with a surface of the ink, and that levels the surface of the ink, where the forming table 8 and the leveling roller 61 are relatively movable in a Z axis direction perpendicular to the X axis direction and a Y axis direction, which is a direction perpendicular to the X axis direction and in which an ink jet head 3 for discharging the ink is scanned; the forming table 8 and the leveling roller 61 are relatively moved in the X axis direction after the forming table 8 and the leveling roller 61 are relatively moved in the Y axis direction; and a relative movement amount in the Z axis direction is adjusted so as to adjust an inclination of the contacting surface 61a of the leveling roller 61 with respect to a trajectory of the forming table 8 seen from the leveling roller 61 at the time of the relative movement with the relative movement of the forming table 8 and the leveling roller 61 in the X axis direction.

Furthermore, a control method of the three-dimensional object forming device 1b, 1c, 1d is a control method of the three-dimensional object forming device 1b, 1c, 1d including a forming table 8 on which a three-dimensional object 100 is formed by discharging ink, and a leveled roller 61 that includes a contacting surface 61a, extending in an X axis direction and being brought into contact with a surface of the ink, and that levels the surface of the ink, where the forming table 8 and the leveling roller 61 are relatively movable in a Z axis direction perpendicular to an X axis direction and a Y axis direction, which is a direction perpendicular to the X axis direction and in which an ink jet head 3 for discharging the ink is scanned; the forming table 8 and the leveling roller 61 are relatively moved in the X axis direction after the forming table 8 and the leveling roller 61 are relatively moved in the Y axis direction, and the method includes a movement control step of adjusting a relative movement amount in the Z axis direction so as to adjust an inclination of the contacting surface 61a of the leveling roller 61 with respect to a trajectory of the forming table 8 seen from the leveling roller 61 at the time of the relative movement with the relative movement of the forming table 8 and the leveling roller 61 in the X axis direction.

According to the configuration described above, the forming table 8 and the leveling roller 61 have the relative movement amount in the Z axis direction adjusted, and are relatively moved in the Z axis direction so that the inclination of the contacting surface 61a of the leveling roller 61 with respect to the trajectory of the forming table 8 is adjusted with the relative movement of the forming table 8 and the leveling roller 61 in the X axis direction.

Generally, when forming the three-dimensional object 100 by scanning the leveling roller 61 not only in the Y axis direction (main scanning direction) but also in the X axis direction (sub scanning direction) (i.e., scanning a mechanism for discharging the ink also in the X axis direction), the step differences D1, D2 may form in the X axis direction on the surface of the ink discharged to the forming table 8. Specifically, the step differences D1, D2 tend to form when the trajectory of the forming table 8 is not substantially parallel to the leveling roller 61 but has a predetermined inclination in the X axis direction. The step differences D1, D2 appear in the three-dimensional object 100 as a contour pattern not intended by the manufacturer.

In the three-dimensional object forming device 1b, 1c, 1d, the forming table 8 and the leveling roller 61 can be relatively moved in the Z axis direction so as to adjust the inclination of the contacting surface 61a of the leveling roller 61 in cooperation with the relative movement of the forming table 8 and the leveling roller 61 in the X axis direction. Thus, the three-dimensional object forming device 1b, 1c, 1d can move one of either the forming table 8 or the leveling roller 61 in the X axis direction in a manner the step differences D1, D2 are not formed.

Thus, the three-dimensional object forming device 1b, 1c, 1d can prevent unnecessary patterns formed by the step differences D1, D2 from being formed in the three-dimensional object 100, and hence can form the three-dimensional object 100 at a satisfactory precision. Therefore, the three-dimensional object forming device 1b, 1c, 1d can form the three-dimensional object 100 at a satisfactory precision through a simple method. The control method of the three-dimensional object forming device 1b, 1c, 1d has effects similar to the above.

Furthermore, the three-dimensional object forming device 1b, 1c, 1d includes a scanning/driving control section 153, 53a, 53b that adjusts the relative movement amount in the Z axis direction.

According to the configuration described above, the three-dimensional object forming device 1b, 1c, 1d can automatically carry out the relative movement of the forming table 8 and the leveling roller 61 in the Z axis direction for inclination adjustment. Therefore, the three-dimensional object forming device 1b, 1c, 1d does not need to manually carry out the adjustment of the inclination of the contacting surface 61a of the leveling roller 61, thus enabling the adjustment to be more easily carried out.

Furthermore, in the three-dimensional object forming device 1b, 1c, 1d, the scanning/driving control section 153, 153a, 153b relatively moves the forming table 8 and the leveling roller 61 in the Z axis direction by a distance corrected with a correction value for adjusting the inclination of the contacting surface 61a of the leveling roller 61.

According to the configuration described above, the forming table 8 and the leveling roller 61 can be relatively moved in the Z axis direction using the obtained correction value, so that the inclination of the contacting surface 61a of the leveling roller 61 can be adjusted through a simple method.

Furthermore, in the three-dimensional object forming device 1b, 1c, 1d, the correction value is obtained using the feeding amount in the X axis direction of the forming table 8 or the leveling roller 61, and the inclination of the contacting surface 61a of the leveling roller 61.

The step differences D1, D2 that form when the trajectory of the forming table 8 has the predetermined inclination with respect to the leveling roller 61 can be obtained using the feeding amount and an angle of the contacting surface 61a with respect to the trajectory of the forming table 8. The angle of the contacting surface 61a with respect to the trajectory of the forming table 8 is a value corresponding to the inclination of the contacting surface 61a of the leveling roller 61. Thus, according to the configuration described above, the forming table 8 and the leveling roller 61 can be relatively moved in the Z axis direction accurately by the formed step difference by obtaining the correction value using the feeding amount and the inclination of the contacting surface 61a of the leveling roller 61.

The three-dimensional object forming device 1b, 1c includes a correction value calculator 154 that calculates the correction value.

According to the configuration described above, the correction value can be interiorly calculated in the three-dimensional object forming device 1b, 1c without externally acquiring the correction value.

Furthermore, the three-dimensional object forming device 1d includes a data acquiring section 55 that acquires correction value data indicating the correction value and stores the correction value data in the storage unit 45, where the scanning/driving control section 153b relatively moves the forming table 8 and the leveling roller 61 in the Z axis direction using the correction value data stored in the storage unit 45.

According to the configuration described above, the three-dimensional object forming device 1d does not need to calculate the correction value. Therefore, the processing load of the three-dimensional object forming device 1d can be alleviated.

Furthermore, in the three-dimensional object forming device 1b, 1c, 1d, the three-dimensional object 100 is formed by depositing a plurality of layers formed by ink on a mounting surface 8a of the forming table 8, where each of the plurality of layers is formed when a plurality of discharging regions, which are extended in the Y axis direction and formed by the ink discharged onto the mounting surface 8a of the forming table 8, are arranged adjacent to each other, and a width W1 in the X axis direction of the contacting surface 61a of the leveling roller 61 is longer than a width W2 in the X axis direction of each of the discharging regions.

According to the configuration described above, the contacting surface 61a of the leveling roller 61 can be brought into contact with the surface of the ink discharged to the mounting surface 8a of the forming table 8 across the adjacent discharging regions. Thus, even if a slight step difference is formed between the adjacent discharging regions, such step difference can be leveled.

Furthermore, the three-dimensional object forming device 1b, 1c, 1d may be realized with a computer, in which case, a three-dimensional forming program of the three-dimensional object forming device for realizing the three-dimensional object forming device 1b, 1c, 1d with a computer by operating the computer as each unit (software element) arranged in the three-dimensional object forming device 1b, 1c, 1d, and a computer readable recording medium in which the three-dimensional forming program is recorded are also encompassed within the scope of the disclosure.

The disclosure is not limited to the embodiments described above, and various changes can be made within a scope defined in the Claims, where embodiments obtained by appropriately combining the technical means disclosed in each of the different embodiments are also encompassed within the technical scope of the disclosure.

### INDUSTRIAL APPLICABILITY

The disclosure can be used in a general three-dimensional object forming device for forming a three-dimensional object. In particular, the disclosure can be suitably used in a 3D printer using the ink jet method.

What is claimed is:

1. A three-dimensional object forming device comprising:
a forming table on which a three-dimensional object is formed by discharging a forming material;
a leveling member that includes a contacting surface extending in a first direction and being brought into contact with a surface of the forming material, and levels the surface of the forming material; and
an adjustment unit that adjusts an inclination of the contacting surface of the leveling member with respect to a trajectory of the forming table seen from the leveling member when the forming table and the leveling member are relatively moved in the first direction.

2. The three-dimensional object forming device according to claim 1, wherein
the leveling member is a leveling roller having a rotating shaft extending in the first direction; and
the adjustment unit adjusts the inclination of the contacting surface of the leveling member by adjusting the inclination of the leveling roller with respect to a horizontal direction.

3. The three-dimensional object forming device according to claim 1, wherein the adjustment unit adjusts the inclination of the contacting surface of the leveling member by adjusting the inclination with respect to a horizontal plane of the trajectory of the scanning in the first direction of the forming table with respect to the leveling member.

4. The three-dimensional object forming device according to claim 2, wherein the adjustment unit adjusts the inclination of the contacting surface of the leveling member by having one end side of the rotating shaft of the leveling roller as a supporting point and moving the other end side in a third direction perpendicular with respect to the first direction and a second direction, wherein the second direction is perpendicular to the first direction and in which a discharging member that discharges the forming material is scanned.

5. The three-dimensional object forming device according to claim 3, further comprising a moving member that moves the forming table of a moving unit that relatively moves the forming table and the leveling member, the moving member holding the forming table at least at two locations, wherein the inclination of the contacting surface of the leveling member is adjusted by having one location where the moving member holds the forming table as a supporting point and moving the other location in a third direction perpendicular to the first direction and a second direction, wherein the direction is perpendicular to the first direction and in which a discharging member that discharges the forming material is scanned.

6. The three-dimensional object forming device according to claim 1, wherein
the forming table and the leveling member are relatively movable in a third direction perpendicular to the first direction and a second direction, wherein the direction is perpendicular to the first direction and in which a discharging member that discharges the forming material is scanned;
the forming table and the leveling member are relatively moved in the first direction after the forming table and the leveling member are relatively moved in the second direction;
the adjustment unit adjusts a relative movement amount in the third direction so as to adjust the inclination of the contacting surface of the leveling member with respect to the trajectory of the forming table seen from the leveling member in a relative movement, with a relative movement of the forming table and the leveling member in the first direction.

7. The three-dimensional object forming device according to claim 6, further comprising a movement controller that adjusts the relative movement amount in the third direction.

8. The three-dimensional object forming device according to claim 7, wherein the movement controller relatively moves the forming table and the leveling member in the third direction by a distance corrected with a correction value for adjusting the inclination of the contacting surface of the leveling member.

9. The three-dimensional object forming device according to claim 8, wherein the correction value is obtained using a feeding amount of the forming table or the leveling member in the first direction and the inclination of the contacting surface of the leveling member.

10. The three-dimensional object forming device according to claim 8, further comprising a correction value calculator that calculates the correction value.

11. The three-dimensional object forming device according to claim 8, further comprising a data acquiring section that acquires correction value data indicating the correction value and stores the correction value data in a storage unit; wherein
the movement controller relatively moves the forming table and the leveling member in the third direction using the correction value data stored in the storage unit.

12. The three-dimensional object forming device according to claim 7, wherein
the three-dimensional object is formed by depositing a plurality of layers formed by the forming material on a surface of the forming table;
each of the plurality of layers is formed when a plurality of discharging regions, formed by the forming material discharged to the surface of the forming table, extending in the second direction are arranged adjacent to each other; and
a width in the first direction of the contacting surface of the leveling member is longer than a width in the first direction of each of the plurality of discharging regions.

13. A three-dimensional object forming device comprising:
a mounting table on which a forming object is mounted;
a discharger that discharges a forming material having fluidity for forming the forming object;
a roller portion arranged in a freely rotating manner for scraping off an excess forming material in the forming material in a flowable state; and
an excess forming material collecting mechanism that collects the excess forming material; wherein
the excess forming material collecting mechanism includes:
a remover having a scrape-off part that scraps off the excess forming material on the surface of the roller portion arranged at one end, and a flow-down part that flows down the excess forming material scraped off by the scrape-off part;
wherein the scrape-off part is extended along an axial direction of the roller portion and arranged in contact with or in proximity with the surface of the roller portion;
the flow-down part has one end connected to the scrape-off part and the other end including an inclined plane configured to be on a vertically lower side than the one end; and
a fluid mover that moves the fluid so as to suppress the excess forming material at the flow-down part from flowing toward both sides in an extending direction of the remover.

14. The three-dimensional forming device according to claim 13, wherein the fluid mover is arranged in a non-contacting state with respect to at least one of the remover and the roller portion.

15. The three-dimensional object forming device according to claim 14, wherein the fluid mover includes a flow tube for flowing gas or liquid, and an opening of the flow tube is arranged to face the remover at least at both end positions of the remover.

16. The three-dimensional object forming device according to claim 15, wherein the fluid mover includes:
a suction generating source that suctions fluid so as to suction the excess forming material from the opening, and
a waste tank that is connected to the flow tube and that stores the excess forming material suctioned from the opening.

17. The three-dimensional object forming device according to claim 16, wherein the fluid mover includes:
a storing part that is arranged on a lower side than the remover in a vertical direction and that stores the excess forming material removed from the roller portion by the remover, and
a waste suction mechanism that suctions the excess forming material stored in the storing part; and
the waste suction mechanism suctions the excess forming material stored in the storing part with a suction force generated by the suction generating source.

18. An adjustment method used in a three-dimensional object forming device including a forming table on which a forming object is formed by discharging a forming material; and
a leveling member that includes a contacting surface extending in a first direction and being brought into contact with a surface of the forming material, and levels the surface of the forming material;
the adjustment method comprising:
an adjusting step of adjusting an inclination of the contacting surface of the leveling member with respect to a trajectory of the forming table seen from the leveling member when the forming table and the leveling member are relatively moved in the first direction.

19. The adjustment method according to claim 18, further comprising a measuring step of measuring a distance between the forming table and the leveling member; wherein in the adjusting step, the inclination of the contacting surface of the leveling member is adjusted based on a measurement result measured in the measuring step.

20. The adjustment method according to claim 18, wherein the forming table and the leveling member are relatively movable in a third direction perpendicular to the first direction and a second direction, wherein the second direction is perpendicular to the first direction and in which a discharging member for discharging the forming material is scanned;
the forming table and the leveling member are relatively moved in the first direction after the forming table and the leveling member are relatively moved in the second direction; and
a movement control step of adjusting a relative movement amount in the third direction so as to adjust the inclination of the contacting surface of the leveling member with respect to the trajectory of the forming table seen from the leveling member at a time of a relative movement with the relative movement of the forming table and the leveling member in the first direction.
